(19) United States
(12) Patent Application Publication
(10) Pub. No.: US 2025/0363577 A1
(43) Pub. Date: Nov. 27, 2025

(54) AI-Powered Personalized Content Generation System and a Method Thereof

(71) Applicant: 2hr Learning, Inc., Austin, TX (US)

(72) Inventor: Shawn Sullivan, Seattle, WA (US)

(73) Assignee: 2hr Learning, Inc., Austin, TX (US)

(21) Appl. No.: 19/218,313

(22) Filed: May 25, 2025

Related U.S. Application Data
(60) Provisional application No. 63/651,646, filed on May 24, 2024.

(51) Int. Cl. G06Q 50/20; G06F 16/242

(52) U.S. Cl. CPC G06Q 50/205; G06F 16/243

(57) ABSTRACT

A system and method for guiding and constraining an artificial intelligence (AI) engine to create and utilize a pre-generated content pool to provide adaptive and personalized learning to users is disclosed. Parsing a user request to identify content requirements and applying an adaptive content selection algorithm that evaluates multiple parameters, including user ID, curriculum standards, content types, and user data. An automated content pool management system maintains a dynamic repository of content aligned with these parameters. Machine learning algorithms enhance and personalize the content pool based on evolving user needs. A large language model (LLM) is employed to generate a guiding prompt that directs the AI engine to retrieve relevant content from the pool. This prompt-driven interaction enables accurate delivery of personalized educational content aligned with user-specific learning goals. The system supports real-time adaptability and individualized content delivery, thereby enhancing the efficacy and responsiveness of AI-powered learning environments.

### CROSS-REFERENCE TO RELATED APPLICATION

This application claims the benefit under 35 U.S.C. § 119 (e) and 37 C.F.R. § 1.78 of U.S. Provisional Application No. 63/651,646, filed May 24, 2024, which is incorporated by reference in its entirety.

### FIELD OF THE INVENTION

The present invention relates in general to the field of electronics, and more specifically to a personalized content generation system by dynamically adjusting the content based on the user requirements, interests, and proficiency on a real-time basis.

### BACKGROUND OF THE INVENTION

Artificial Intelligence is revolutionizing learning offering unparalleled opportunities for growth. With AI content generation and content generation systems become more efficient and insightful, propelling the educational journey forward. The content generation system is designed to create, manage, and deliver digital content. In educational technology and digital learning environments, the content generation system serves as the backbone for creating and disseminating educational materials, ranging from text-based resources to interactive multimedia content. Typically, the content generation system facilitates the efficient production of educational content while ensuring alignment with learning objectives and curriculum standards. The content generation system aims to streamline the content development lifecycle, encompassing the stages of ideation, creation, curation, and delivery. The content generation system can analyze user interactions and feedback to continuously refine and improve the quality of educational content over time. Beneficially, the content generation system is flexible, allowing educational institutions and content providers to accommodate diverse learning environments and evolving pedagogical practices. Whether deployed in traditional classrooms, online learning platforms, or hybrid learning models, the content generation system can adapt to various instructional contexts and curriculum frameworks, supporting a wide range of subjects, disciplines, and educational levels.

Conventional content delivery systems have long been hampered by their inability to dynamically adapt content to the diverse and evolving needs of users such as students, learners and so forth. The conventional content delivery systems often fail to leverage a wide array of user-specific data points, resulting in a one-size-fits-all approach to content delivery. The conventional content delivery systems rely on static algorithms and manual oversight and also struggle to keep pace with changing user demands and relied on manual interventions to determine when new content is required. This manual oversight often led to either overproduction or content shortages, resulting in substandard user experiences. Moreover, the conventional content delivery systems may have been limited by their reliance on static algorithms, which lacked the ability to learn and adapt from user data over time.

Furthermore, the conventional content delivery systems require a team and a complex development cycle. These processes are often hindered by the lack of interoperability between different components leading to inefficiencies and delays in content production. Moreover, the conventional content delivery systems have often struggled to adjust content based on a comprehensive set of user-specific data points. These systems typically rely on simplistic metrics such as completion rates or quiz scores to gauge user engagement, overlooking more nuanced indicators of learning effectiveness to ensure a personalized and adaptive learning experience for every user. Additionally, the conventional content delivery systems have been limited by their inability to learn from user interactions over time. The conventional content delivery systems often treat each user interaction as a discrete event, failing to recognize patterns or trends that could inform future content delivery decisions.

### SUMMARY

A method for guiding and constraining an artificial intelligence (AI) engine to create a pre-generated content pool for providing adaptive and personalized learning to a user includes executing code using one or more processors of a computer system to cause the computer system to perform operations that includes parsing a user request to identify the requirements of the user for the content generation. The method also includes utilizing an adaptive content selection algorithm to analyze the user request to deliver content, wherein the content is delivered based on a plurality of parameters, wherein the plurality of parameters include user ID, curriculum standards, content types, and user data. The method includes employing an automated content pool management system to maintain the pre-generated content pool comprising a plurality of content that aligns with the plurality of parameters. The method includes integrating machine learning algorithms to deepen content within the pre-generated content pool and personalize the plurality of content based on the requirement of the user. The method includes guiding and constraining the AI engine to utilize the plurality of content from the pre-generated content pool to identify the content based on the plurality of parameters. The method also includes using the pre-generated content pool for delivering the content aligned with the user request for providing adaptive and personalized learning.

A system for guiding and constraining an artificial intelligence (AI) engine to create a pre-generated content pool for providing adaptive and personalized learning to a user includes one or more processors a computer system and a memory, coupled to the one or more processors storing code that when executed by the computer system causes the computer system to perform operations. The system includes parsing a user request to identify the requirements of the user for the content generation. The system also includes utilizing an adaptive content selection algorithm to analyze the user request to deliver content, wherein the content is delivered based on a plurality of parameters, wherein the plurality of parameters include user ID, curriculum standards, content types, and user data. The system includes employing an automated content pool management system to maintain the pre-generated content pool comprising a plurality of content that aligns with the plurality of parameters. The system includes integrating machine learning algorithms to deepen content within the pre-generated content pool and personalize the plurality of content based on the requirement of the user. The system includes guiding and constraining the AI engine to utilize the plurality of content from the pre-generated content pool to identify the content based on the plurality of parameters. The system also includes using the pre-generated content pool for delivering the content aligned with the user request for providing adaptive and personalized learning.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary real-time content generation system to create a pre-generated content pool for providing adaptive and personalized learning to a user.

FIG. 2 depicts an exemplary real-time content generation process the pre-generated content pool for providing adaptive and personalized learning to the user.

FIG. 3 depicts an exemplary sequence diagram for real-time engagement of a user to fetch the details of the user from a database, which is an embodiment of the real-time content generation system of FIG. 1.

FIG. 4 depicts an exemplary sequence diagram for real-time engagement of the AI engine with the pre-generated content pool, which is an embodiment of the real-time content generation process of FIG. 2.

FIG. 5 depicts an exemplary sequence diagram for integrating a machine learning algorithm to personalize the content based on a user request, which is an embodiment of the real-time content generation process of FIG. 2.

FIG. 6 depicts an exemplary sequence diagram for integrating an engineer to oversee the development and integration of content, streamlining the workflow from concept to deployment of content, which is an embodiment of the real-time content generation process of FIG. 2.

FIG. 7 depicts an exemplary sequence diagram for using the pre-generated content pool for frequently used content to streamline content generation and reduce redundancy, which is an embodiment of the real-time content generation process of FIG. 2.

FIG. 8A depicts a data structure for organizing data to generate content after receiving the user request.

FIG. 8B depicts the Content Selection Algorithm implemented within a content backend system configured to return personalized, pre-generated educational content to a client application based on multiple criteria, which is an embodiment of the real-time content generation system of FIG. 1.

FIG. 9 depicts a data structure for organizing data to evaluate and access the content.

FIG. 10 depicts a data structure for organizing data to integrate the machine learning algorithm.

FIG. 11 depicts a data structure for organizing data to streamline generator development.

FIG. 12 depicts a data structure for organizing data in the pre-generated content pool.

FIG. 13 depicts an exemplary network environment in which the system of FIG. 1 and the process of FIG. 2 may be practiced.

FIG. 14 depicts an exemplary computer system.

### DETAILED DESCRIPTION

The real-time content generation system and method set forth herein address technical issues with generating a pre-generated content pool for providing adaptive and personalized learning to a user described herein. Conventionally, manual processes were used to generate the pre-generated content pool for providing adaptive and personalized learning to the user and were very tedious and time consuming. The present real-time content generation system and method utilize an automated system that does not merely automate a manual process or use a conventional system in a conventional way. The present real-time content generation system and method utilize one or more artificial intelligence (AI) engines and integrate programmatic process management to technologically guide and constrain the one or more AI engines to produce the pre-generated content pool for providing adaptive and personalized learning to the user in a completely different way than both any manual process and different than normal use of programs and AI engines. Utilizing specially engineered guidance and control to direct an AI system in solving the technical problems presented below, which require a technical solution. The real-time content generation system and method described below are not simply engaging a computer to carry out conventional mental processes, but rather change how computers (and AI systems, specifically) operate to achieve the generation results that were not previously possible or were substantially inefficient prior to the real-time content generation system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the real-time content generation system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The real-time content generation system and method generate decomposed, technically engineered AI prompts to include selected and integral AI engine guidance and constraints. The technically engineered prompts are generated and guided with programmatic, automatic inputs specifically designed to unconventionally guide and constrain an AI engine to produce the pre-generated content pool for providing adaptive and personalized learning to the user, perform quality control to retain or automatically discard outputs that do not meet guidance and constraints, and make the desired outputs available for use, such as use by computer system applications. In at least one embodiment, the problem to be solved by the integrated programmatic and AI engine real-time content generation system and method is uniquely and unconventionally decomposed, and AI prompts are used to solve the decomposed problem. Furthermore, the programmatic inputs to the decomposed AI prompts provide guidance to generate the pre-generated content pool for providing adaptive and personalized learning to the user

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the real-time content generation system and method described herein. Thus, the present real-time content generation system and method described implement an integration of programmatic management over decomposed prompts with engineered AI engine guidance and constraints to affect an improvement in AI, programmatic AI management, and AI integrated with programmatic management technology. The present real-time content generation system and method allow computer systems to include programmatic management, one or more AI engines, and one or more data sources to produce the pre-generated content pool for providing adaptive and personalized learning to the user that previously could not be produced with conventionally prompted AI engines or could only be produced by humans utilizing a completely different, time consuming, and tedious process. The real-time content generation system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

Notwithstanding any provision to the contrary or anything to the contrary in the below pages, the below pages are not limiting and do not describe all embodiments of the real-time content generation systems and methods. For example, use of the term “invention” does not limit or require the referenced certain features to be present in all embodiments of the invention. Use of absolute-type terms, such as “required,” “must,” “only,” “important,” and so on are not limiting of all embodiments of the real-time content generation systems and methods and not to be construed as limiting of the embodiments of the real-time content generation systems and methods described above.

A real-time content generation system guides an artificial intelligence (AI) engine to create a pre-generated content pool for providing adaptive and personalized learning to a user. The AI engine displays the generated content to the user on an online learning platform on a user device. The real-time content generation system using AI for adaptive learning further includes one or more processors that are used for executing code of a computer system to cause the computer system to perform operations.

The real-time content generation system utilizes an adaptive content selection algorithm for data analytics, and natural language processing to interpret and respond to user requests to tailor content recommendations to match the unique preferences, learning styles, and objectives of individual users, thereby enhancing engagement, comprehension, and satisfaction.

The automated content pool management system ensures the alignment of content with for each academic standard. The automated content pool management system necessitates the utilization of predictive analytics to anticipate user demand and adjust content offerings accordingly. Such predictive models require data handling and storage solutions, capable of processing and analyzing vast user data and content attributes. To maintain equilibrium between content supply and demand, the automated content pool management system ensures that the pre-generated content pool remains dynamically responsive to evolving user needs and preferences.

Moreover, the integration of machine learning deepens content within the pre-generated content pool for advanced personalization by deployment of algorithms capable of learning from user interactions over time. To streamline the development and integration of content generators, realizing the full potential of adaptive content selection algorithms is must by adopting tools and methodologies like software development kits (SDKs), integrated development environments (IDEs), and continuous integration and deployment (CI/CD) pipelines to accelerating the pace of content generation.

The pre-generated content pool is utilized for commonly used content and delivering content to the user. The automated content pool management system capable of storing, indexing, and retrieving assets with precision and efficiency allowing database management solutions to organize and catalog educational resources, ensuring seamless access and retrieval for users. Additionally, the incorporation of content delivery networks (CDNs) enhance accessibility and performance by distributing content across diverse servers, minimizing latency and optimizing bandwidth utilization. The pre-generated content pool also ensures the content generation without overproduction.

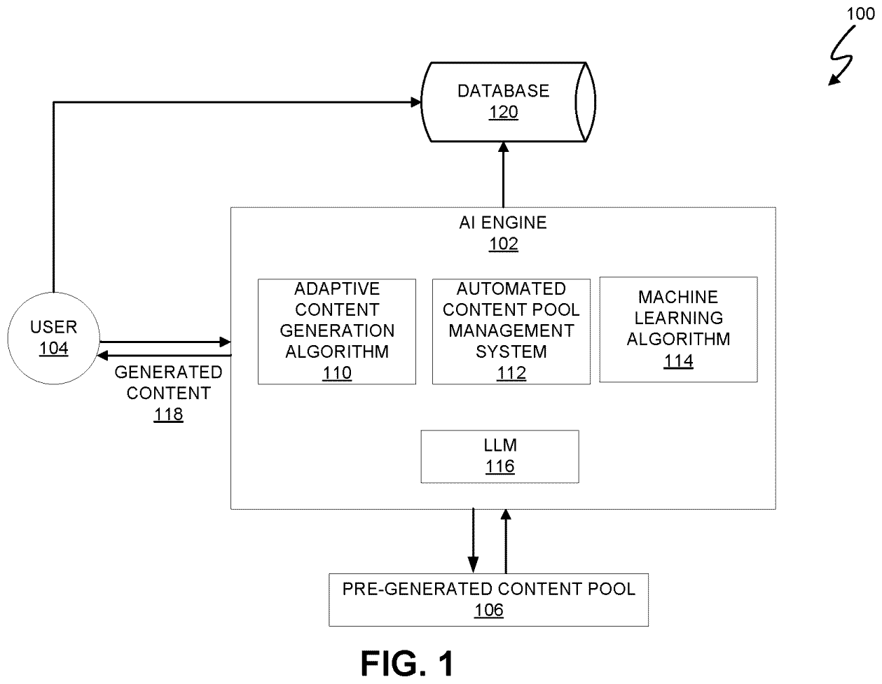

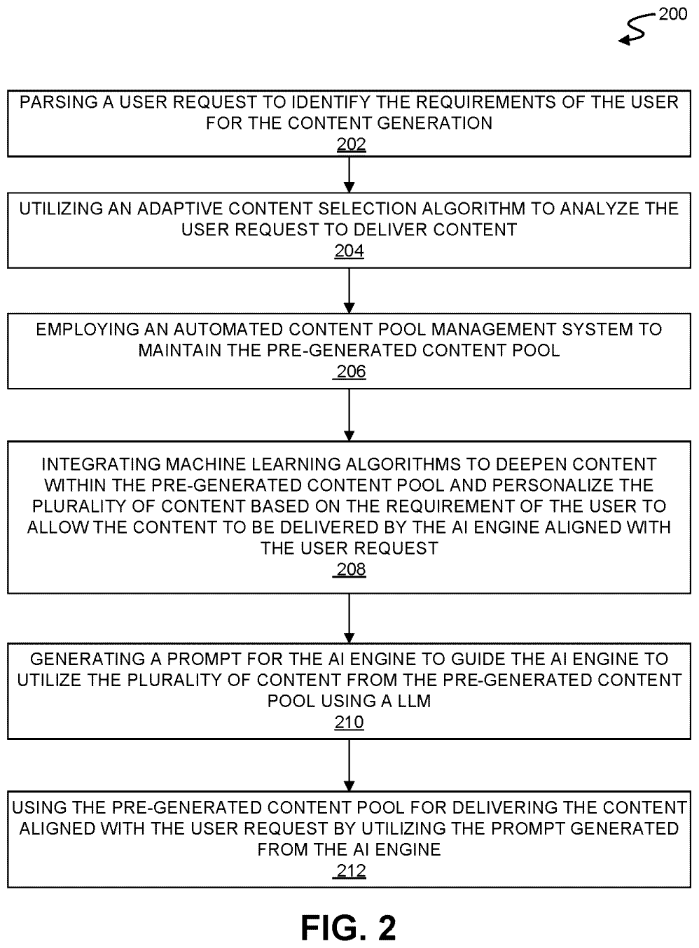

FIG. 1 depicts an exemplary real-time content generation system 100. FIG. 2 depicts an exemplary real-time content generation process 200 utilized by real-time content generation system 100.

The real-time content generation system 100 is configured to generate relevant educational content that addresses specific knowledge gaps and learning preferences. The AI engine 102 analyzes data related to the learning history of the user 104. This data-driven approach enables the AI engine to gain insights into the learning profile of the user 104, including strengths, weaknesses, and areas of interest of the user 104. Typically, by utilizing the user data the AI engine 102 can identify patterns of the learning behavior of the user 104 to tailor the content creation process. The AI engine 102 creates a pre-generated content pool 106 including a diverse range of educational resources. The pre-generated content pool 106 serves as a repository of learning materials, encompassing text-based resources, multimedia assets, interactive simulations, and so forth. The pre-generated content pool 106 ensures a comprehensive library of educational materials available to support the user 104 in a learning journey. Moreover, the AI engine 102 personalizes the learning experience of the user 104 by identifying needs and preferences, thereby ensuring that the user 104 remains engaged and motivated throughout their educational journey. The AI engine 102 adjusts the difficulty level of the questions to cater to the individual strengths, interests, and learning styles.

Referring to FIGS. 1 and 2, in operation 202, a user request 108 is parsed to identify the requirements of the user 104 for the content generation. Typically, the user request 108 is parsed by the AI engine 102. The user request 108 is in the form of text or speech, that is utilized to identify the requirement of the user 104, thereby facilitating the generation of content that aligns with the needs of the user 104. The parsed user request 108 is then subjected to syntactic and semantic analysis to identify structure and meaning. The syntactic analysis involves the parsing of the input according to the rules of grammar and syntax, identifying the relationships between words and phrases to construct a parse to extract relevant information based on the requirements of the user 104. The semantic analysis delves deeper into the meaning of the parsed user request 108, to identify context of the user request 108 to generate the content relevant to the user 104.

The AI engine 102 identifies the requirements of the user 104 for content generation by determining the subject matter or topic of interest and further, identifies key entities or keywords relevant to the user request 108 of the user 104. The user request 104 helps in guiding the selection, creation, and customization of content to meet the needs of the user 104. For example, parsing involves extracting keywords or phrases from the user request 104 to generate personalized content or adapt existing content to suit the preference of the user 104.

In operation 204, the AI engine utilizes an adaptive content selection algorithm 110 to analyze the user request 108 to deliver content. The content is delivered based on a plurality of parameters, wherein the plurality of parameters includes user ID, curriculum standards, content types, and user data. The adaptive content selection algorithm 110 is a computational tool designed to customize the content to individual need, preference, and learning style of the user 104. The adaptive content selection algorithm 110 leverages technologies such as machine learning, data analytics, and natural language processing to customize the learning experience for the user 104.

The adaptive content selection algorithm 110 drives the selection and delivery of content. The adaptive content selection algorithm 110 is configured to analyze the user request 108 comprehensively, by using a combination of machine learning models for pattern recognition and predictive analytics. The adaptive content selection algorithm 110 utilizes the plurality of parameters. The plurality of parameters serves as input variables that guide the adaptive content selection algorithm 110 in decision-making process, enabling to tailor content according to the user 104. The plurality of parameters includes user ID, curriculum standards, content types, and user data.

The user ID serves as a unique identifier for the user 104, allowing the adaptive content selection algorithm 110 to access and analyze historical user data to personalize the content selection process. By associating the user request 108 with individual user profile, the adaptive content selection algorithm 110 can take into account factors such as past interactions, preferences, and learning behaviors to deliver content that is highly relevant and engaging. The curriculum standard corresponding to the user 104 standard is also considered by the adaptive content selection algorithm 110. The adaptive content selection algorithm 110 aligns the content educational standards to ensure the content delivered is in line with the educational goals corresponding to the user 104. The alignment of the content with the curriculum standard helps to optimize the learning experience and enhance the effectiveness of the content delivery process. The adaptive content selection algorithm 110 takes into account the diverse range of content types available for delivery, including multiple choice questions, true or false questions, fill in the blanks, multimedia assets, interactive simulations, and so forth. By considering the preferences and learning style of the user 104, the adaptive content selection algorithm 110 prioritizes content types that resonate with the user 104. The adaptive content selection algorithm 110 incorporates user data collected from various sources, including behavioral data, and interaction history. The user data provides valuable insights into the interests, preferences, and performance metrics of the user 104, allowing the adaptive content selection algorithm 110 to personalize content offerings and adapt the delivery process in real-time based on evolving user 104 needs.

Once the adaptive content selection algorithm 110 has analyzed the user request 108 by considering the plurality of parameters, the adaptive content selection algorithm 110 proceeds to deliver content that is tailored to specific requirements and preferences of the user 104. The content delivery process is dynamic and responsive, adjusting in real-time to changes in user request 108, context, and learning objectives.

The adaptive content selection algorithm 110 employs machine learning algorithms, data analytics techniques, and natural language processing algorithms to interpret the user request 108 to provide personalized content to the user 104. The adaptive content selection algorithm 110 works together with machine learning, data analytics, and natural language processing techniques to deliver personalized content tailored to each user's unique needs and preferences. When the user 104 initiates the user request 108 for content generation, the adaptive content selection algorithm 110 analyzes the user request 108, contextualizing the user request 108 within the broader landscape of user interactions and content availability, and generates personalized content tailored to the user's profile and objectives. The adaptive content selection algorithm 110 continuously refine and improve the generation of content, by iteratively fine-tuning its strategies based on user feedback, performance metrics, and trends. The adaptive content selection algorithm 110 adapts to evolving user preferences, pedagogical methodologies, and technological advancements, ensuring recommendations remain relevant, impactful, and engaging.

Provided below are some functions used by the adaptive content selection algorithm 110:

```
# Function to select content based on user-specific data
def select_adaptive_content(user_id, curriculum_scope, content_types,
engagement_data):
  “““
    This function selects content tailored to the user's needs by
analyzing various parameters.
  It represents an advancement in personalized educational content
delivery.
  ”””
      # Parse detailed requests from the user
  parsed_request = parse_request(user_id, curriculum_scope,
content_types, engagement_data)
      # Tailor content delivery based on the parsed request
  selected_content = tailor_content(parsed_request)
      # Return the selected content
  return selected_content
# Helper function to parse user requests
def parse_request(user_id, curriculum_scope, content_types,
engagement_data):
    # Implementation of request parsing logic
    # ...
# Helper function to tailor content based on the parsed request
def tailor_content(parsed_request):
    # Implementation of content tailoring logic
    # ...
# Example usage of the function
user_specific_content = select_adaptive_content(user_id=“12345”,
curriculum_scope=“Math”,
      content_types=[“Video”,
“Quiz”], engagement_data=user_engagement_data)
```

In operation 206, an automated content pool management system 112 is employed to maintain the pre-generated content pool comprising a plurality of content that aligns with the plurality of parameters to ensure the content generation and content delivery to the user 104. The automated content pool management system 112 curates, organizes, and optimizes the pre-generated content pool 106, ensuring the content available for generation and delivery is both comprehensive and highly relevant to the needs and preferences of the user 104. The automating the management of the pre-generated content pool 106 streamlines the content generation and delivery processes, enhances efficiency and provides user 104 with personalized and engaging learning experience. The automated content pool management system 112 serves as the central hub for overseeing and maintaining the pre-generated content pool 106, which encompasses the plurality of content including assessments, workshops, text-based materials, multimedia assets, interactive simulations, and so forth. The automated content pool management system 112 utilizes rule-based algorithms for content assessment to manage the plurality of content within the pre-generated content pool 106, from creation and curation to updating and maintenance. The rule-based algorithm operates on predefined rules or logic to make decisions based on a set of conditions. The set of conditions dictate how the algorithm processes input data such as user request 108 and generates output such as personalized generated content. The automated content pool management system 112 ensures that the pre-generated content pool 106 remains organized, up-to-date, and easily accessible to the user 104.

The automated content pool management system 112 aligns the content within the pre-generated content pool 106 with the plurality of parameters that govern content generation and delivery. By aligning content offerings with the plurality of parameters, the automated content pool management system 112 ensures that the plurality of content available for generation and delivery is highly relevant, engaging, and aligned with the user's specific needs and learning goals. The automated content pool management system 112 is able to adapt dynamically to changes in user request 108, content availability, and educational requirements. The automated content pool management system 112 continuously optimizes content selection and delivery processes, ensuring that the most relevant and effective content is made available to the user 104. The automated content pool management system 112 is configured to maintain the pre-generated content pool 106 to ensure content generation without overproduction. The automated content pool management system 112 optimizes content while averting overproduction to maintain the balance of content within the pre-generated content pool 106. In at least one embodiment, the automated content pool management system 112 incorporates dynamic feedback loops that facilitate continuous refinement and optimization of content curation and generation processes. Moreover, the automated content pool management system 112 incorporates safeguards and thresholds to prevent runaway content generation.

In operation 208, the real-time content generation system 100 integrates machine learning algorithm 114 to deepen content within the pre-generated content pool 106. The machine learning algorithms 114 analyze, enrich, and adapt the plurality of content within the pre-generated content pool 106 in response to the evolving needs and preferences of the user 104. The machine learning algorithm 114 is configured to tailor plurality of content to the specific requirements of individual users, ensuring that content is delivered in a manner that is both relevant and engaging. The machine learning algorithm 114 identifies key objectives and learning outcomes that guide the enrichment and personalization of the plurality of content within the pre-generated content pool 106. The machine learning algorithms 114 analyze and interpret patterns, trends, and relationships within the plurality of content. By using rule-based algorithms for content assessment to extract valuable insights from the plurality of content. The machine learning algorithms 114 deepen the plurality of content within the pre-generated content pool 106 by identifying patterns, connections, and insights. The machine learning algorithms 114 analyze vast amounts of the plurality of content to identify recurring themes, concepts, and relationships, to enrich the pre-generated content pool 106 for a more comprehensive and nuanced understanding of the subject matter, providing the user 104 with a richer and more immersive learning experience.

Furthermore, the machine learning algorithm 114 personalizes the plurality of content based on the requirements of individual users 104 to allow the content to be delivered by the AI engine 102 aligned with the user request 108. The machine learning algorithm 114 ensures that content is delivered in a manner that is tailored for the user 104. By analyzing the user request 108, the machine learning algorithm 114 identifies patterns and trends in user behavior, preferences, and performance metrics, enabling customized content delivery to suit the specific requirements of the user 104. The personalization involves adapting the difficulty level of content, recommending supplementary resources, or presenting content in alternative formats that align with the preferred learning style of the user 104. The machine learning algorithm 114 enables to deliver content within the pre-generated content pool 106 using AI engine 102 that is aligned with user request 108. The machine learning algorithm 114 analyzes user request 108, AI engine 102 identifies the relevant and appropriate content from the pre-generated content pool 106, ensuring that user 104 receives content that is highly tailored to specific needs and interests. The alignment between user request 108 and content delivery is essential for enhancing user engagement and learning outcome. In at least one embodiment, the machine learning algorithm 114 enables to continuously optimize and refine content delivery based on real-time feedback and user interactions. By analyzing user feedback, performance metrics, and other data, the machine learning algorithm 114 can identify areas for improvement within the content pool, develop targeted interventions to address the issues, and iteratively refine content over time. This iterative approach to content optimization ensures that the plurality of content remains relevant, and aligned curriculum standards.

In operation 210, generating a prompt for the AI engine 102 to guide the AI engine 102 to utilize the plurality of content from the pre-generated content pool 106 using a large language model (LLM) 116. The LLM 116 is pre-trained and is configured to identify the content based on the plurality of parameters for providing adaptive and personalized content to the user 104. The LLM 116 generates the prompt that is utilized by AI engine 102 to access and utilize the content within the pre-generated content pool 106 that is tailored to the specific needs and preferences of the user 104. The LLM 116 understands and generates prompts based on the user request 108. The LLM 116, such as GPT-3, GPT-4 by openAI or Claude-2 by Anthropic are trained on to develop a deep understanding of language patterns and semantics, enabling them to generate relevant prompts. The process of generating a prompt for the AI engine 102 begins with the identification of the content to be delivered to the user 104 based on the user request 108, further the AI engine 102 utilizes the plurality of parameters that govern content selection and delivery. The LLM 116 incorporates the plurality of parameters into the prompt generation, to ensure that the AI engine 102 selects and delivers content that is highly relevant, engaging, and aligned with the user 104 requirements.

Typically, the prompt serves as the guiding and constraining framework that directs the AI engine 102 for the utilization of content from the pre-generated content pool 106. The prompt provides instructions and context to the AI engine 102, guiding and constraining in decision-making process and facilitating the selection of content that meets the needs of the user 104. The LLM 116 generates prompts that are clear, concise, and tailored to the user's preferences ensuring that the AI engine 102 effectively understands and responds to user request 108. The LLM 116 is pre-trained capable of understanding and identifying the content based on the plurality of parameters for providing adaptive and personalized content to the user 104. Once the prompt is generated, the prompt is used to guide the AI engine 102 to utilize content from the pre-generated content pool 106. The AI engine 102 uses the prompt to access and analyze the plurality of content within the pre-generated content pool 106, identifying content relevant to the user 104. By analyzing user request 108 to prompts, the AI engine 102 can dynamically adjust content delivery strategies, identifying areas for improvement and refining content selection processes over time.

In operation 212, using the pre-generated content pool 106 for delivering the content aligned with the user request 108 by utilizing the prompt generated from the AI engine 102. The generated content 118 is used for providing adaptive and personalized learning to the user 104. The pre-generated content pool 106 serves as a comprehensive repository of content such as text-based materials, multimedia assets, interactive simulations, and so forth. The pre-generated content pool 106 is curated to align with educational objectives, curriculum standards, and user preferences, ensuring that a diverse array of content is readily available to support learning activities. The pre-generated content pool 106 allows delivery of content timely corresponding to the user request 108. The prompts generated for the AI engine 102, serves as the guiding and constraining framework for selecting and delivering content from the pre-generated content pool 106. The prompts are generated using LLM 116, enabling the AI engine 102 to understand and respond to user request 108 in a manner that is both contextually relevant and personalized.

The generated prompt is used to guide the selection and delivery of content from the pre-generated content pool 106 in response to the user request 108. The AI engine 102 uses the prompt to identify relevant content within the pre-generated content pool 106. By aligning content selection with the parameters specified in the prompt, the AI engine 102 ensures that the content delivered is customized based on the user 104 requirements, thereby enhancing the overall effectiveness and impact of the learning experience. The use of prompts and the pre-generated content pool 106 provide adaptive and personalized learning experiences to the user 104. Typically, the content selection is centered on maintaining a priority queue for each user so that generated content 118 will be both educational and engaging for the user 108. The priority queue is maintained asynchronously by an independent service, so that at any moment in time, the user 104 receives the personalized content.

The pre-generated content pool 106 store, index, and retrieve commonly used content. The pre-generated content pool 106 provides a centralized hub for storing content, safeguarding against loss or degradation while facilitating efficient access and retrieval. The pre-generated content pool 106 ensures that content remains readily accessible and securely preserved, minimizing redundancy. The pre-generated content pool 106 allows indexing of content to categorize, classify, and annotate content according to subject matter, academic level, format, and other relevant criteria, enabling users to navigate the pre-generated content pool 106 with ease and precision. Moreover, the pre-generated content pool 106 allows retrieving commonly used content on-demand, offering seamless access to the content to deliver, streamlining the learning experience and fostering engagement. Typically, the pre-generated content pool 106 utilizes database management, and content delivery networks (CDNs) for rapid access to the content for content delivery. The pre-generated content pool 106 comprises database management systems and content delivery networks (CDNs). The database management system provides efficient storage, organization, and retrieval of content. The database management system index, the content with the pre-generated content pool 106 ensures that content is securely preserved and readily accessible, minimizing redundancy and maximizing content utilization. The content delivery networks (CDNs) facilitate rapid access to the content. The CDNs comprise a distributed network of servers positioned within the pre-generated content pool 106, enabling efficient content to user 104.

The content generation system comprises a database 120 for storing the user request 108, generated content 118 corresponding to the user request 108 and academic progress of the user 104. The database 120 is used for storing user interactions and serves as a repository for capturing and organizing information such as user request 108, prompts, generated content 118 corresponding to the user request 108, and the academic progress of the user 108. The database 120 also includes generated content 118, ensuring personalized and relevant content is delivered to the user 104. Additionally, the database 120 tracks and maintains records of the user's academic progress, including completed activities, assessment scores, and learning milestones. By aggregating and analyzing data, the database 120 provides invaluable insights into the user's learning trajectories, enables monitoring performance, and identifies areas for improvement.

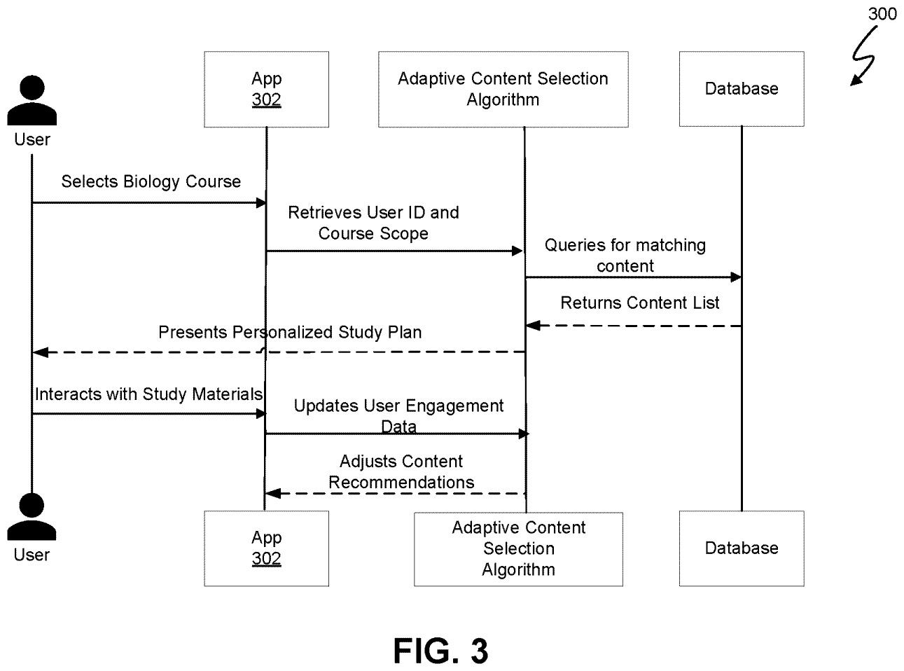

FIG. 3 depicts an exemplary sequence diagram 300 for real-time engagement of the user 104 to fetch the details of the user 104 from the database 120, which is an embodiment of the real-time content generation system 100 of FIG. 1. As shown, the user 104 provides the user request 108 herein, the user request 108 is the biology course delivered to an app 302. The app 302 offers diverse courses, interactive content, and user-friendly interface to facilitate seamless communication between the user 104 and the content generation system 100. The app 302 provides the plurality of content to empower the user 104 to acquire knowledge efficiently. Typically, the app 302 retrieves user ID and course scope and provides the retrieved user ID and course scope to the adaptive content selection algorithm 110. The adaptive content selection algorithm 110 matches the user request within the database 120. The database 120 returns the matched content to the adaptive content selection algorithm 110. Moreover, the adaptive content selection algorithm 110 presents personalized study plans corresponding to the user request 108 to the user 104. The user interacts with the study plan provided by adaptive content selection algorithm 110.

Furthermore, the app 302 updates user engagement data and adjusts content recommendations. As user 104 interacts with the app 302 by answering the question, watching videos, completing exercises the app 302 collects data based on the user engagements. The data encompasses various metrics, including time spent on different activities, areas of interest, and proficiency levels. By using adaptive content selection algorithm 110, the app 302 utilizes the said data to refine and optimize the user experience. Typically, the adaptive content selection algorithm 110 analyzes patterns and trends in user behavior to discern preferences, learning styles, and areas of improvement. Consequently, the app 302 tailor content recommendations, offering the user 104 personalized suggestions that align closely with their interests and learning objectives.

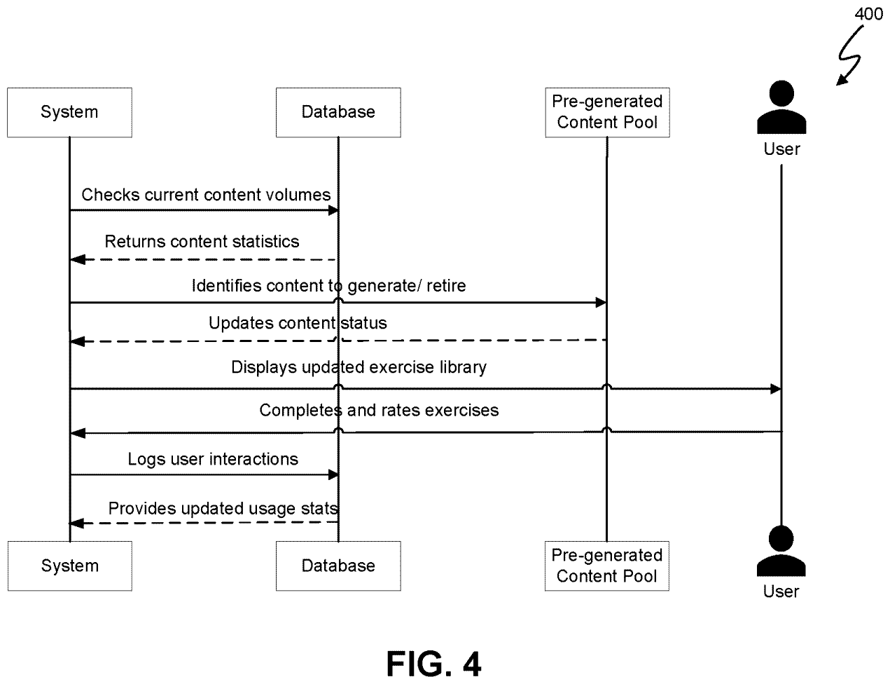

FIG. 4 depicts an exemplary sequence diagram 400 for real-time engagement of the AI engine 102 with the pre-generated content pool 106, which is an embodiment of the real-time content generation process 200 of FIG. 2. The AI engine 102 checks current content volumes within the database 120. Typically, the AI engine 102 delves deep into the intricacies of content, probing the database 120 for comprehensive insights. The database returns content statistics. The AI system 102 identifies the content to be generated or removed from the pre-generated content pool 106. The pre-generated content pool 106 updates the AI system 102 regarding the plurality of content therein. Upon updating the pre-generated content pool 106, the AI system 102 delivers the newly curated library to the user 104. The user completes and rates the exercise. This iterative cycle of user engagement and data collection enables AI system 102 to tailor content based on the user preferences. Moreover, the AI logs user interaction into the database 120. Furthermore, the database 120 provides the updated usage stats to the AI system 102. The database 120 compiles updated usage stats and insights, providing invaluable feedback to the AI system 102. The AI engine 102 gains insights into user behavior and preferences, further refining content creation and recommendation.

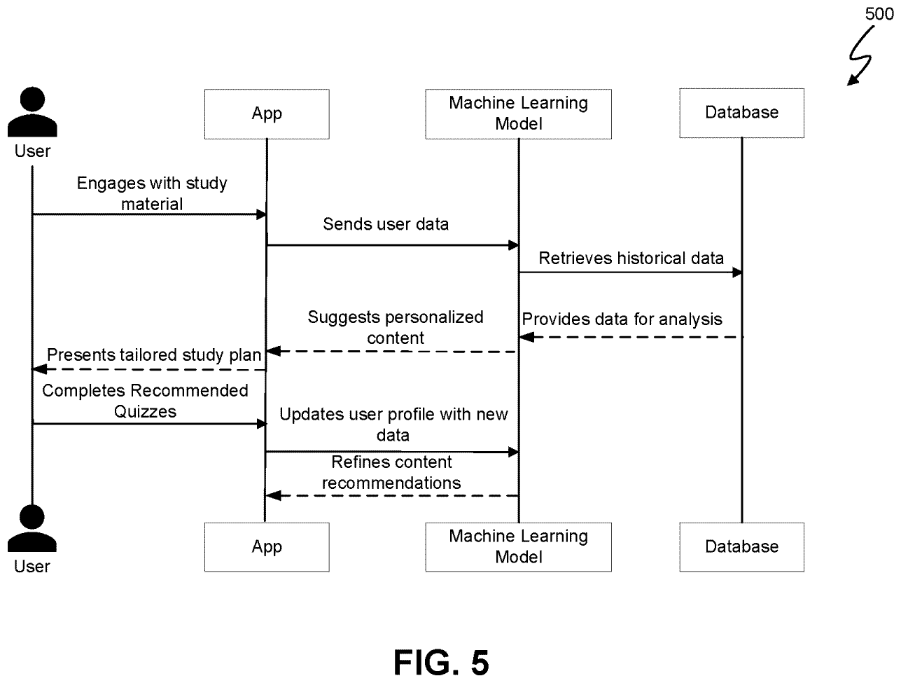

FIG. 5 depicts an exemplary sequence diagram 500 for integrating machine learning algorithm 114 to personalize the content based on the user request 108, which is an embodiment of the real-time content generation process 200 of FIG. 2. As shown, the user 104 engages with the content and study material provided by the app 302. The app 302 sends the user data to the machine learning algorithms 114. Typically, the machine learning algorithm 114 retrieves the historical data associated with the user 104 from the database 120. The database 120 provides the data associated with the user 104 for analysis to the machine learning algorithm 114. Based on the received data associated with the user 104, the machine learning algorithm 114 suggests personalization of content to the app 302. The app 302 presents the tailor study plant to the user 104. The user 104 completes the recommended quizzes provided by the app 302. Then the app 302 updates the user profile with the new data as received based on the completion of the quiz and provides the updated user profile to the machine learning algorithms 114. Based on the updated user profile the machine learning algorithms 114 refine the content recommendation for the user 104.

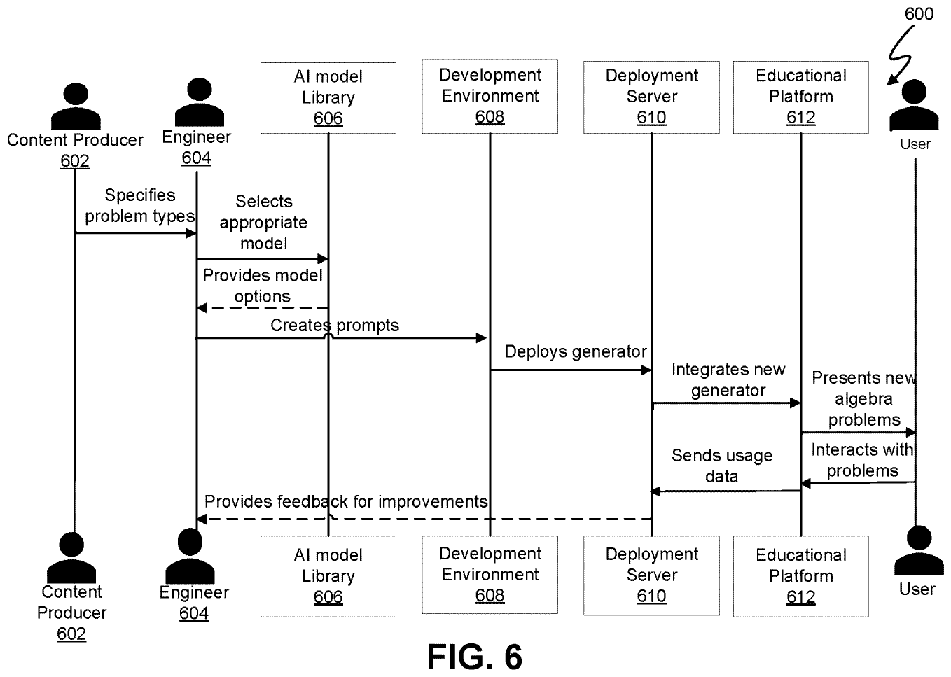

FIG. 6 depicts an exemplary sequence diagram 600 for integrating a engineer to oversee the development and integration of content, streamlining the workflow from concept to deployment of content, which is an embodiment of the real-time content generation process 200 of FIG. 2. The content producer 602 specifies problem types to the engineer 604. The engineer selects appropriate models from AI model library 606. The AI model library 606 provides model options to the engineer 604. The engineer 604 creates prompts and provides a development environment 608. The development environment 608 deploys a generator and provides a deployment server 610. The deployment server 610 integrates a new generator and provide to educational Platform 612. The educational platform 612 presents new algebra problems to the user 104. The user 104 interacts with problems on the educational platform 612. The educational platform 612 sends usage data to the deployment server 610. The deployment Server 610 provides feedback for improvements to the engineer 604.

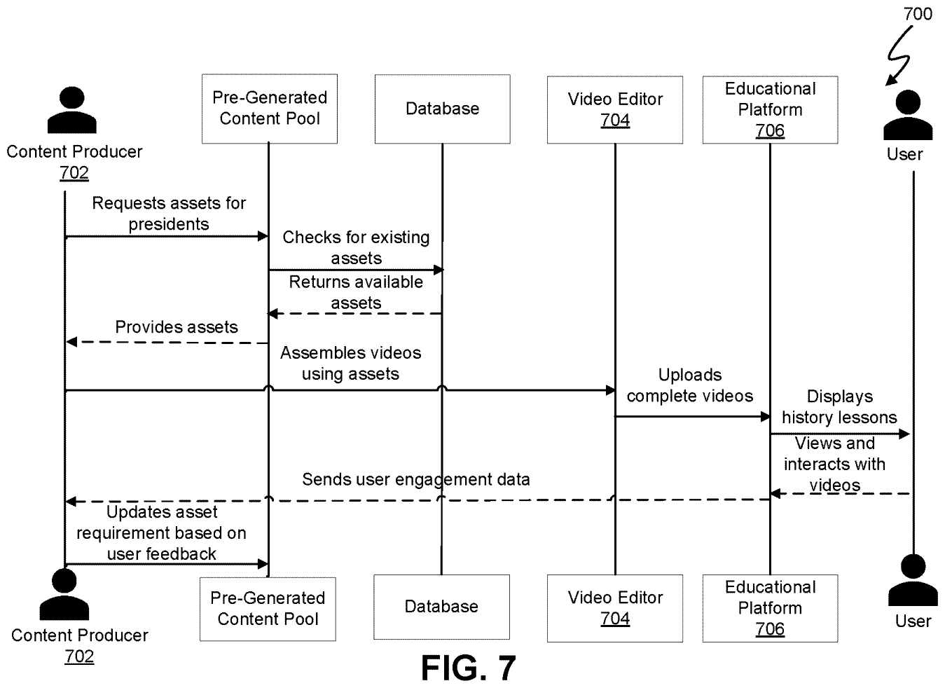

FIG. 7 depicts an exemplary sequence diagram 700 for using the pre-generated content pool 106 for frequently used content to streamline content generation and reduce redundancy, which is an embodiment of the real-time content generation process 200 of FIG. 2. The content producer 702 requests assets for presidents from the pre-generated content pool 106. The pre-generated content pool 106 checks for existing assets in the database 120. The database 120 returns available assets to the pre-generated content pool 106. The pre-generated content pool 106 provides assets to content producer 702. The content producer 702 assembles videos using assets from video editor 704. The video editor 704 uploads completed videos to the educational platform 706. The educational platform 706 displays history lessons to the user 104. The user 104 Views and interacts with videos provided on the educational platform 706. The educational platform 706 sends user engagement data to the content producer 702. The content producer 702 updates asset requirements based on feedback in the pre-generated content pool 106.

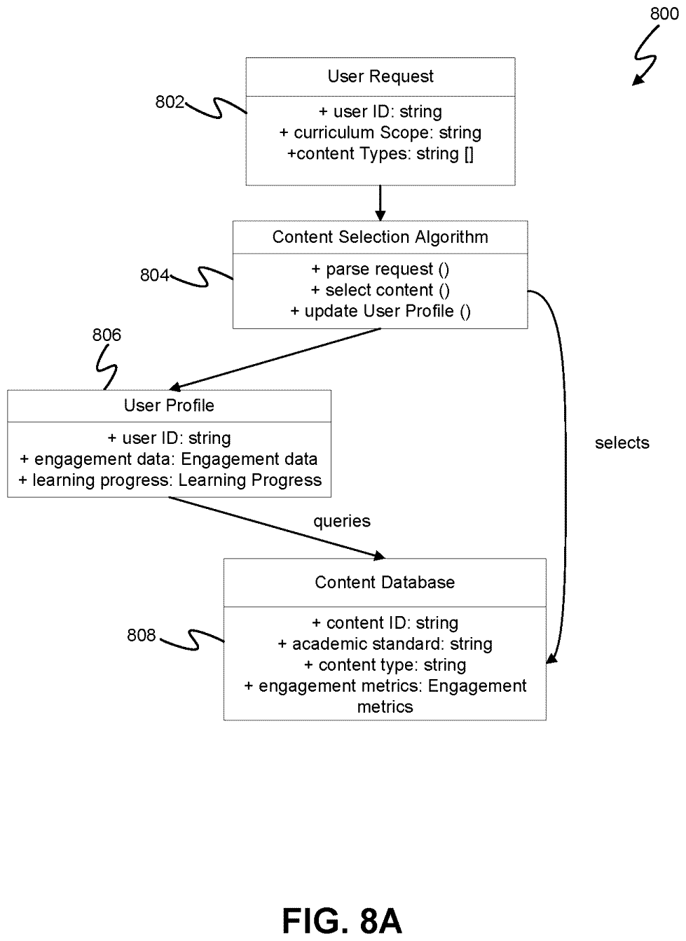

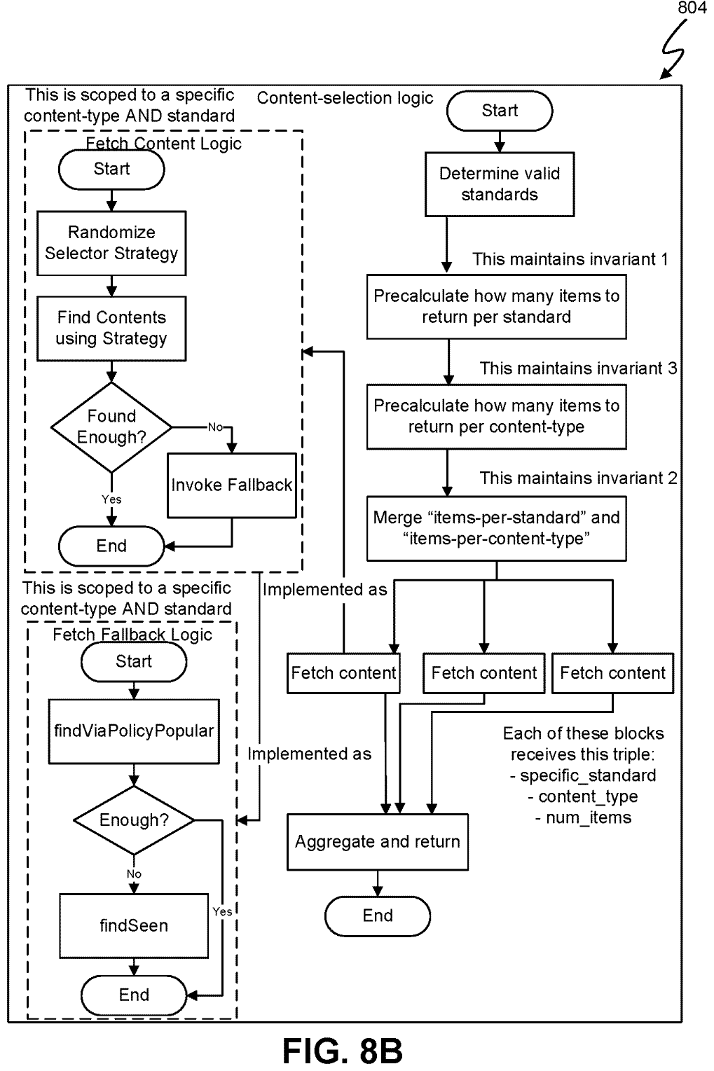

FIG. 8A depicts a data structure 800 for organizing data to generate content after receiving the user request 108. The data structure includes plurality of components such as: User Request 802, Content Selection Algorithm 804, user profile 806, and content database 808. The User Request 802 component stores essential information about the user 104 including user ID, curriculum scope, content types. The user ID is a unique identifier assigned to each user. The curriculum scope denotes the educational material should be covered with the content. The content types encompass the various formats and categories of contents available, such as multiple choice questions, true or false, fill in the blanks, videos, and so forth.

The Content Selection Algorithm 804 component is configured to parse request, select content, and update User Profile. The parse request involves extracting and interpreting data from an incoming user request 108. The select content involves choosing and retrieving specific content based on user request 108. The update user profile involves modifying the user profile based on the received user request. The user profile 806 includes user ID, engagement data, and learning progress associated with the user 104. The user ID is a unique identifier assigned to each user. The engagement data comprises information about user interactions and activities. The learning progress indicates the advancement or improvement of the user 104 knowledge or skills over time. The content database 808 includes content ID, academic standard, content type, and engagement metrics. The content ID is a unique identifier assigned to specific content. The academic standard denotes the educational level or curriculum framework to which the content aligns. The content type refers to the format content. The engagement metrics encompass measurements of user interaction and involvement with the content. The Content Selection Algorithm 804 selects content from the content database 808.

FIG. 8B illustrates an embodiment of the Content Selection Algorithm 804 implemented within a content backend system configured to return personalized, pre-generated educational content to a client application based on multiple criteria.

The process begins at the Start node, where the Content Selection Algorithm 804 initiates content selection in response to a client request. The Content Selection Algorithm 804 first determines valid standards based on the curriculum standard specified in the request (for example:—course, domain, cluster, or standard identifiers). This step ensures that only those standards relevant to the user's curriculum standard are considered, thereby maintaining Invariant 1 that content must align with the next non-mastered standard(s).

Then the Content Selection Algorithm 804 performs two pre-calculation steps. First, precalculate how many items to return per standard, which distributes the requested batch size across the selected curriculum standards. This step ensures Invariant 3 that the content batch serves to elevate specific standards based on the user's mastery progression. Second, precalculate how many items to return per content type, based on a desired content-type distribution. This maintains Invariant 2 that the batch complies with the expected ratio or distribution of content types (such as MCQs, FITBs).

The results of the first and second pre-calculations are then merged in a step labeled Merge “items-per-standard” and “items-per-content-type” requirements, which fetches multiple content. The multiple content includes: specific_standard, content_type, and num_items.

Following this, the Fetch content operates to fetch content logic and fetch fallback logic. The Fetch content logic begins by randomizing the selector strategy to select the content based on popularity or novelty, then attempts to find content using the selected strategy. If sufficient content is found, the operation completes. If not, a fetch fallback logic is invoked. The fetch fallback logic finds content by using a find via policy popular. If this again fails to yield enough items, it further relaxes constraints to find previously seen content. Once all fetch operations are completed, the content is aggregated to the results and return the batch to the client application.

The content selection algorithm 804 is configured to retrieve pre-generated content optimized for educational progression. The real-time content generation system 100 separates content generation from selection, focusing on content that aids in increasing the user's mastery within the curriculum standard.

The real-time content generation system 100 comprises a content backend server configured to select educational content. Upon receiving a request from a client application, the server invokes a selectContent API endpoint. The request includes a user identifier (userId), batch size (batchSize), curriculum-related constraints (such as course, domain, cluster, or standard identifiers), content type preferences (either uniform or weighted distributions), a standard selection strategy, and a repeat content policy.

Firstly, a set of candidate standards is determined. The candidate standards are computed by evaluating the intersection of the standards defined by the curriculum. If no intersection exists, the real-time content generation system 100 defaults to the lowest-level non-null curriculum standard to provide a viable set of standards that is always identified for content selection. Next, a subset of these candidate standards is selected for inclusion in the content batch. This selection is performed according to the provided standard selection strategy, which includes:
Randomized selection: which picks standards uniformly at random.
Breadth-first mastery: which chooses standards based on the lowest mastery levels, aims to elevate the learner's weakest areas.
Breadth-first no mastery: which evenly covers as many standards as possible, without regard to mastery data.

The selected standards are then used to generate a list of content targets. The list of content targets is specific content items that match the standard and fulfill batch requirements. Each content item is selected based on engagement scores computed from aggregate global interactions. Engagement scoring is weighted as follows:
Likes: +1
Comments or replies: +2
Bookmarks: +3
Shares: +4
Dislikes: −1
Reports: −20

The content selection algorithm 804 further incorporates user-specified content type distributions. If a list of content types is provided, the real-time content generation system 100 selects uniformly at random. If a weighted distribution is specified via a dictionary, the selection adheres to the specified proportions. If no content type constraint is specified, all content types are eligible for inclusion. To enforce new content, the real-time content generation system 100 applies a repeat content policy, which defines which previously served content items, if any, are eligible for re-selection. The repeat content policy may include: allowing no repeats, allowing repeat of answered content only, allowing repeat of correctly or incorrectly answered content only, or allowing all content.

Content items are then selected in accordance with an 80/20 heuristic: 80% of content is selected based on highest engagement scores, while 20% is selected from items with fewer than 100 views, thereby balancing relevance with new content. Preference is always given to previously unviewed content where possible.

If sufficient content items cannot be identified under these constraints, the system executes a sequence of fallback procedures:
i. Select a random content item matching the standard and content type.
ii. Select a random content item matching the standard, irrespective of content type.
iii. Select a random content item from the broader curriculum standard.

Each selected content item is assigned a difficulty score, which is computed based on the content type. For example:
Fill-in-the-blank (FITB): 3 points
Matching Pairs (MP): 3 points
Multiple Choice Questions (MCQ): 2 points
Text-on-Left (TOL): 1 point
Word Match Networks (WMN): 1 point
All other types: 0 points

The final output of the content selection algorithm 804 is a batch of content items, each associated with a specific standard, difficulty rating, and metadata indicating user relevance and engagement metrics.

Below is the pseudocode that outlines the batching logic of the content generation algorithm 804:

```
def generateContentBatchStandards(candidateStandards):
  contentBatchStandards = [ ]
  if standardSelectionStrategy == “randomized”:
    for i in range(batchNumber):
contentBatchStandards.append(chooseRandom(candidateStandards))
  elif standardSelectionStrategy in [“breadthFirstMastery”,
“breadthFirstNoMastery”]:
    unchosenStandards = copy(candidateStandards)
    while len(contentBatchStandards) < batchNumber:
      if standardSelectionStrategy == “breadthFirstMastery”:
        masteryScores = mastery.getMastery(userId,
unchosenStandards)
        minMastery = min(masteryScores.values)
        chosenStandard =
chooseRandomStandardWithScore(unchosenStandards, minMastery)
      else:
        chosenStandard = chooseRandom(unchosenStandards)
      m = mastery.getMastery(chosenStandard).value
      qtyToAdd = 3 − correctAnswers(userId, chosenStandard) if
m == 0 else 1
      contentBatchStandards += [chosenStandard] * qtyToAdd
      unchosenStandards.remove(chosenStandard)
      if len(unchosenStandards) == 0:
        unchosenStandards = copy(candidateStandards)
  else:
    raise Exception(“Unknown selection style”)
  return contentBatchStandards[:batchNumber]
```

generateContentBatchStandards (candidateStandards) is responsible for selecting a list of curriculum standards from a set of input candidate standards, which will be used to guide content selection for a specific user. The function generateContentBatchStandards (candidateStandards) receives a list of candidate standards and returns a list of selected standards (contentBatchStandards) based on the chosen standard selection strategy and the desired batch size (batchNumber).

The function chooseRandom (candidateStandards) randomly selects and returns a single standard from the list of candidate standards. The function chooseRandom (candidateStandards) is used when the selection strategy is randomized or when a fallback random selection is required. The function copy (candidateStandards) returns a shallow copy of the input list of candidate standards. The function copy (candidateStandards) is used to preserve the original list while allowing modifications to the working list (unchosenStandards) during iteration.

The function mastery. getMastery (userId, unchosenStandards) queries a mastery service to retrieve the current mastery levels for the specified user (userId) across a list of standards (unchosenStandards). The result is a mapping of each standard to its corresponding mastery score, typically represented numerically (such as, 0, 3, 4, 5). The function min (masteryScores. values) computes the minimum mastery score from the set of mastery values returned by the getMastery function, enabling identification of the weakest standards for prioritization.

The function chooseRandomStandardWithScore (unchosenStandards, minMastery) selects, at random, one of the unchosen standards whose mastery score is equal to the minimum mastery level obtained from the user's profile. The function correctAnswers (userId, chosenStandard) returns the number of correct answers the user has submitted for a given standard. It is used to determine how many content items are needed to potentially raise the user's mastery level for that standard.

The function mastery. getMastery (chosenStandard). value retrieves the mastery level for a specific standard, allowing conditional logic based on the user's current performance. If the standard's mastery level is zero, it is assumed that three correct responses are needed to raise the level; otherwise, only one additional correct answer is needed.

The function unchosenStandards. remove (chosenStandard) removes the selected standard from the working list of unchosen standards to prevent immediate reselection, ensuring diversity within the content batch. The function unchosenStandards=copy (candidateStandards) identifies if the batch is not yet full and all standards have been iterated over, the function unchosenStandards=copy (candidateStandards) resets the list of unchosen standards to the original candidate set, enabling repeated selection as necessary to fill the batch. The function contentBatchStandards [: batchNumber] returns a slice of the list of selected standards, capped at the specified batch size, ensuring that no more than the requested number of items is returned.

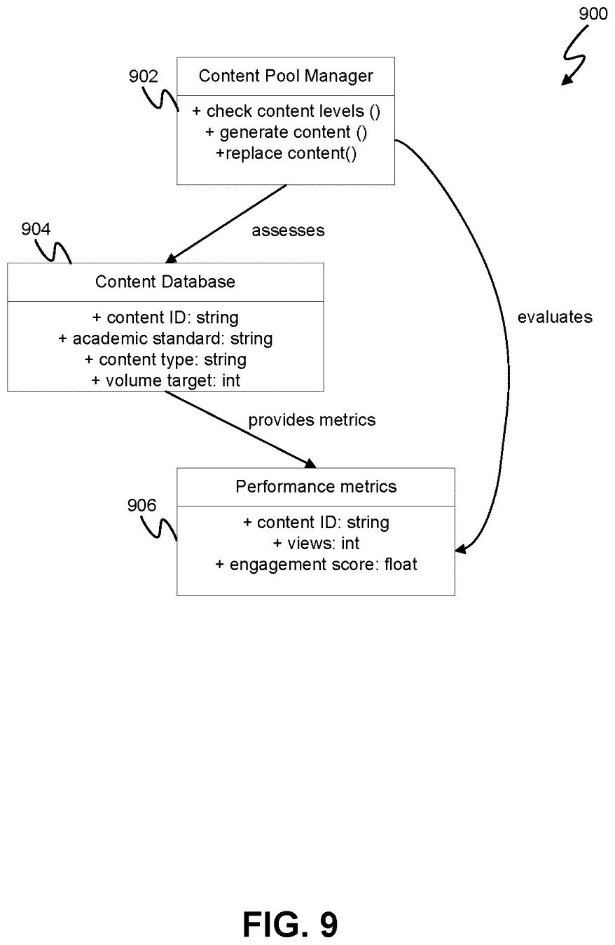

FIG. 9 depicts a data structure 900 for organizing data to evaluate and access the content. The data structure 900 includes a plurality of components such as: Content Pool Manager 902, Content Database 904, and Performance metrics 906. The Content Pool Manager 902 includes check content levels, generate content, replace content. The check content levels involve assessing the quantity and quality of content available. The generated content 118 entails creating new content to expand the pre-generated content pool 106. The replace content refers to removing outdated or ineffective content and substituting with more relevant or updated content. The Content Database 904 includes content ID, academic standard, content type, and volume target. The content ID is a unique identifier for specific content. The academic standard denotes the educational level or curriculum framework to which the content corresponds. The content type specifies the format or category of the content. The volume target represents the desired quantity or amount of content to be produced or curated. The Performance metrics 906 includes content ID, views, and engagement score. The content ID is a unique identifier for specific content. The views represent the number of times users have accessed or interacted with the content. The engagement score is a metric calculated based on user interactions and involvement with the content, indicating its effectiveness and popularity

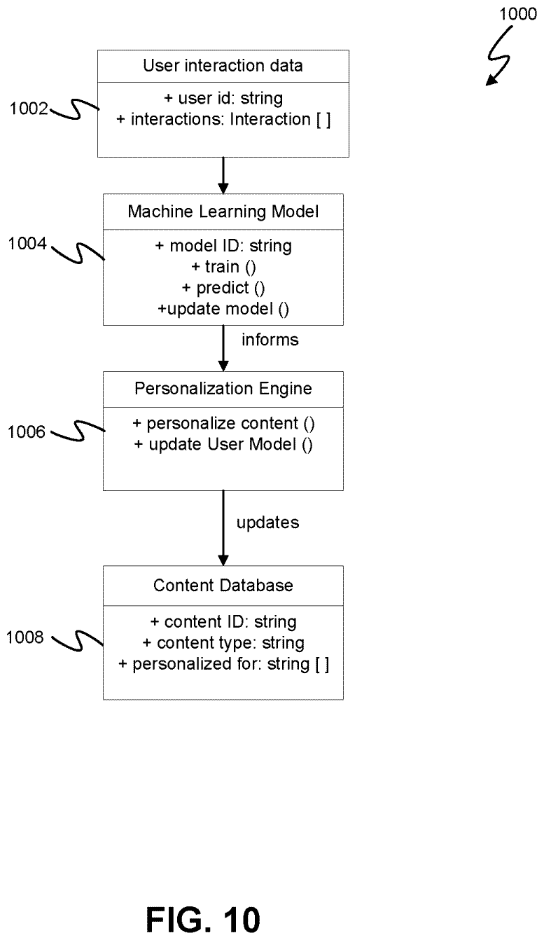

FIG. 10 depicts a data structure 1000 for organizing data to integrate machine learning algorithm 114. The data structure 1000 includes a plurality of components such as: User interaction data 1002, Machine Learning Model 1004, Personalization Engine 1006, and Content Database 1008. The User interaction data 1002 includes user ID and interactions. The user ID is a unique identifier assigned to each individual user. The interactions encompass the various actions or engagements users perform. The Machine Learning Model 1004 includes model ID, train, predict, update mode. The model ID is a unique identifier for a machine learning model. The train involves feeding data into the model to adjust its parameters to improve performance. The predict entails using the trained model to make predictions or classifications based on new data. The update model involves modifying the model based on new data. The Personalization Engine 1006 includes personalize content, and update user model. The personalize content involves tailoring content to match individual user preferences and learning needs. The update user model refines the representation of the user preferences, behavior, or characteristics based on new data or interactions. The Content Database 1008 includes content ID, content type, and personalized for. The content ID is a unique identifier for a specific content. The content type denotes the format or category of the content. The personalized for indicates the customization of content to suit the preferences or needs of the user 104.

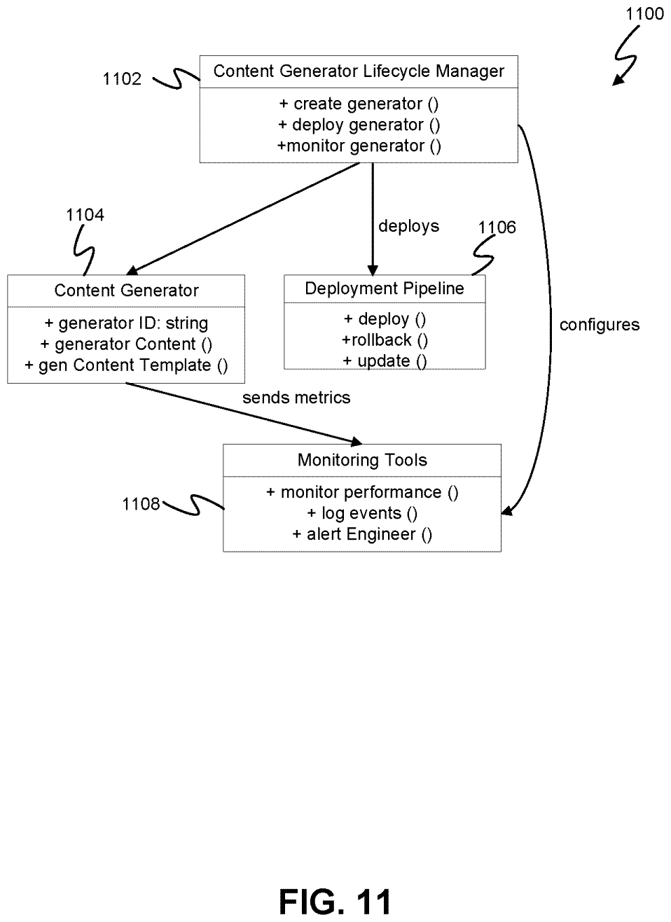

FIG. 11 depicts a data structure for organizing data to streamline generator development. The data structure 1100 includes a plurality of components such as: Content Generator Lifecycle Manager 1102, Content Generator 1104, Deployment Pipeline 1106, Monitoring Tools 1108. The Content Generator Lifecycle Manager 1102 includes create generator, deploy generator, monitor generator. The create generator involves developing a tool for generating content. The deploy generator entails making the generator available for use. The monitor generator involves overseeing the performance and usage of the generator to ensure reliability. The Content Generator 1104 is responsible for producing a finished piece of content, such as a multiple choice question, or a fill in the banks. The Content Generator 1104 typically coordinates several different steps, such as the process of generating question text, obtaining a speaker image, generating audio, and generating a video using all of these components. The Content Generator 1104 can also be invoked to generate any supported content type in real time for a specific user. Typically, the Content Generator 1104 coordinates the execution of the steps that lead to a finished piece of content.

The Content Generator 1104 includes generator ID, generator Content, gen Content Template. The generator ID is a unique identifier assigned to a content generator. The generator Content refers to the content produced by the content generation tool. The gen Content Template serves as a framework guiding the generation of content by specifying its structure, format, and elements. The Deployment Pipeline 1106 includes deploy, rollback, and update. The deploy is used to deploy the generator. The rollback involves reverting to a previous version of the generator. The update refers to updating the generator. The Monitoring Tools 1108 monitor performance, log events, alert Engineer. The monitor performance e″ involves observing and assessing the functionality and efficiency of the generator. The log events entail recording significant occurrences or actions. The alert Engineer notifies the engineer of any anomalies or issues detected during monitoring, prompting an investigation and potential intervention.

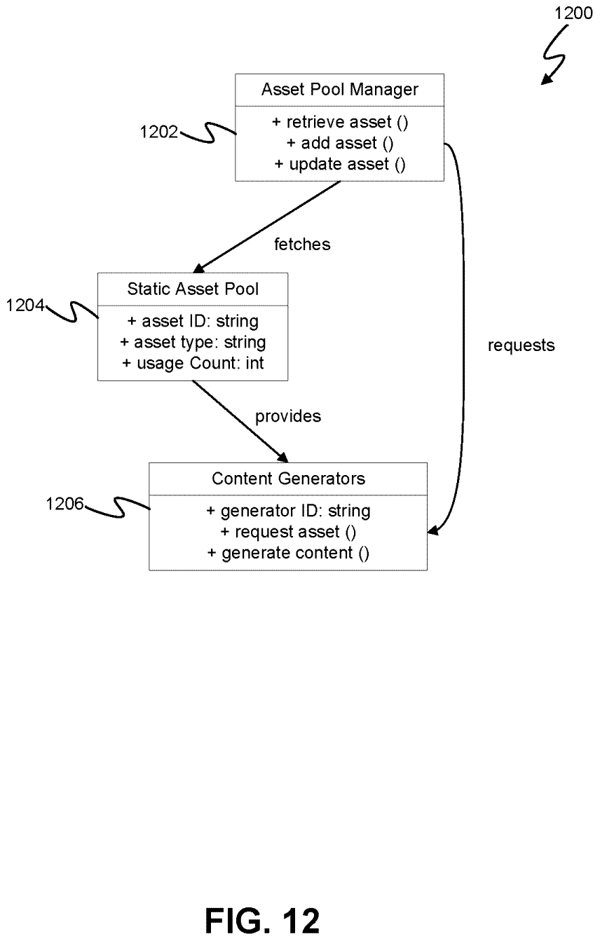

FIG. 12 depicts a data structure 1200 for organizing data in the pre-generated content pool 106. The data structure 1200 includes a plurality of components such as: Asset pool manager 1202, Static asset pool 1204, and Content generators 1206. The Asset pool manager 1202 includes retrieve asset, add asset, update asset. The retrieve asset involves fetching a specific content from the pre-generated content pool 106. The add asset refers to inserting a new content into the pre-generated content pool 106. The update asset involves modifying or revising an existing content within the pre-generated content pool 106. The Static asset pool 1204 includes asset ID, asset type, and usage Count. The asset ID is a unique identifier assigned to an asset. The asset type categorizes the nature or classification of the asset. The usage Count quantifies the frequency or number of times the asset has been accessed or utilized. The Content generators 1206 includes generator ID, request asset, and generate content. The generator ID uniquely identifies each content generator. The request asset involves requesting a specific asset from the content generator. The generate content used to allow producing content using the content generator based on the requested asset.

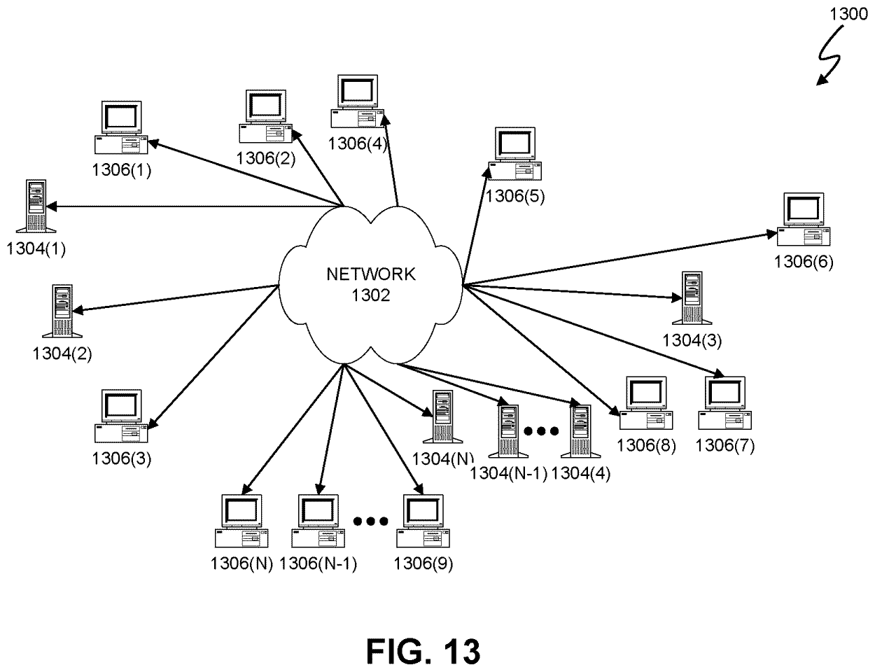

FIG. 13 is a block diagram illustrating a network environment in which a real-time content generation system 100 and content generation process 200 may be practiced. Network 1302 (e.g. a private wide area network (WAN) or the Internet) includes a number of networked server computer systems 1304(1)-(N) that are accessible by client computer systems 1306(1)-(N), where N is the number of server computer systems connected to the network. Communication between client computer systems 1306(1)-(N) and server computer systems 1304(1)-(N) typically occurs over a network, such as a public switched telephone network over asynchronous digital subscriber line (ADSL) telephone lines or high-bandwidth trunks, for example communications channels providing T1 or OC3 service. Client computer systems 1306(1)-(N) typically access server computer systems 1304(1)-(N) through a service provider, such as an internet service provider (“ISP”) by executing application specific software, commonly referred to as a browser, on one of client computer systems 1306(1)-(N).

Client computer systems 1306(1)-(N) and/or server computer systems 1304(1)-(N) are specialized computer programmed to improve conventional computer systems to implement and utilize the real-time content generation system 100 and content generation process 200. The type of computer system that can be specially programmed to implement and utilize the real-time content generation system 100 and content generation process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the real-time content generation system 100 and content generation process 200 can be implemented using code stored in a tangible, non-transient computer readable medium and executed by one or more processors. In at least one embodiment, the real-time content generation system 100 and content generation process 200 can be implemented completely in hardware using, for example, logic circuits and other circuits including field programmable gate arrays.

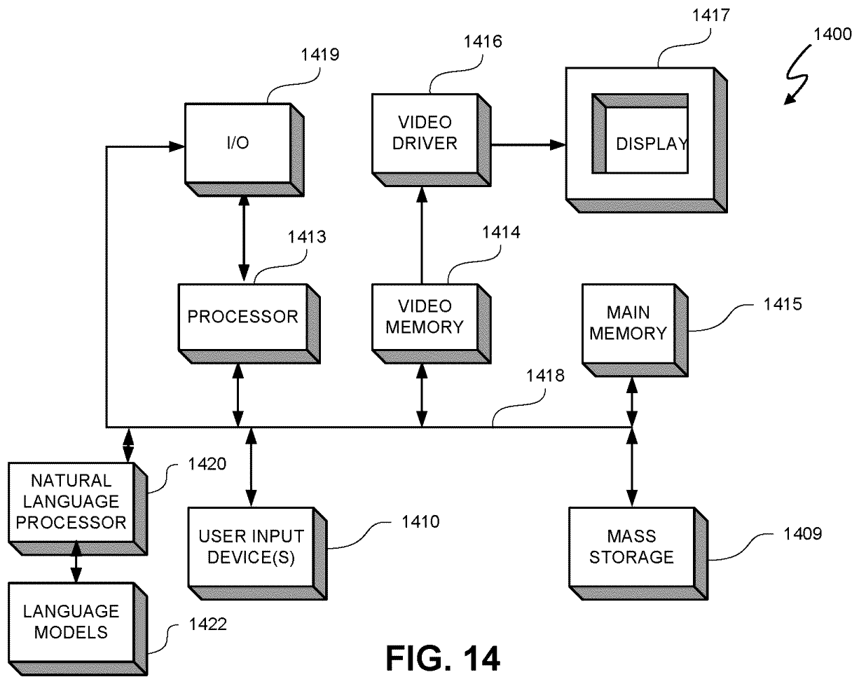

Embodiments of the real-time content generation system 100 and content generation process 200 can be implemented on a computer system such as a special-purpose, special-programmed computer 1400 illustrated in FIG. 14. Input user device(s) 1410, such as a keyboard and/or mouse, are coupled to a bi-directional system bus 1418. The input user device(s) 1410 are for introducing user input to the computer system and communicating that user input to processor 1413. The computer system of FIG. 14 generally also includes a non-transitory video memory 1414, non-transitory main memory 1415, and non-transitory mass storage 1409, all coupled to bi-directional system bus 1418 along with input user device(s) 1410 and processor 1413. The mass storage 1409 may include both fixed and removable media, such as a hard drive, one or more CDs or DVDs, solid state memory including flash memory, and other available mass storage technology. Bus 1418 may contain, for example, 32 of 64 address lines for addressing video memory 1414 or main memory 1415. The system bus 1418 also includes, for example, an n-bit data bus for transferring DATA between and among the components, such as CPU 1409, main memory 1415, video memory 1414 and mass storage 1409, where “n” is, for example, 32 or 64. Alternatively, multiplex data/address lines may be used instead of separate data and address lines.

I/O device(s) 1419 may provide connections to peripheral devices, such as a printer, and may also provide a direct connection to a remote server computer systems via a telephone link or to the Internet via an ISP. I/O device(s) 1419 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1409, into main memory 1415 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1413, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1415 is comprised of dynamic random access memory (DRAM). Video memory 1414 is a dual-ported video random access memory. One port of the video memory 1414 is coupled to video amplifier 1416. The video amplifier 1416 is used to drive the display 1417. Video amplifier 1416 is well known in the art and may be implemented by any suitable means. This circuitry converts pixel DATA stored in video memory 1414 to a raster signal suitable for use by display 1417. Display 1417 is a type of monitor suitable for displaying graphic images.

The computer system described above is for purposes of example only. The real-time content generation system 100 and content generation process 200 may be implemented in any type of computer system or programming or processing environment. It is contemplated that the real-time content generation system 100 and content generation process 200 might be run on a stand-alone computer system, such as the one described above. The real-time content generation system 100 and content generation process 200 might also be run from a server computer systems system that can be accessed by a plurality of client computer systems interconnected over an intranet network. Finally, the real-time content generation system 100 and content generation process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

### Appendix

Provided below are exemplary prompts utilized by AI engine 102 of the real-time content generation system 100 configured to generate relevant educational content that addresses specific knowledge gaps and learning preferences.

### Drag and Drop-Math-Grade 3-8-SB

### Context

You are an expert in curriculum and instruction for Grade 3-8 Mathematics, specializing in developing**drag and drop** questions that align with specific educational standards and learning objectives.

Inputs (use exactly as given, substituting the templates):

Selected Difficulty: The target complexity level for the question (e.g., easy, medium, hard).

Standard Description: A general summary of what the standard expects students to demonstrate.

Grade: The grade level at which the item should be aimed.

Learning Objective: The precise skill or concept students should show by answering the question.

Assessment Boundaries: Any limits on content or representations (what's in-scope vs. out-of-scope).

Common Misconceptions: A list of typical student errors or misunderstandings for this concept.

Example Questions+Difficulties: Sample**drag and drop** items tagged with their difficulty level to guide your format.

Direct Instruction: The key terminology and instructional focus students will have been taught before this item.

Stimulus Type Specification: A short description of what the stimulus-drawing function should receive (e.g., fields like ‘title’, ‘units’, ‘gridlines’, ‘shapes’, ‘labels’).

### Generation Process

### Step 1: Analyze the Inputs

List the components of the L1 Standard, Substandard, and Learning Objective from the inputs.
Note any Assessment Boundaries that limit the scope of the question.
Enumerate each Common Misconception and consider how it will inform distractors.
Identify the key concept to be assessed.
List applicable Grade Rules and Formatting Rules.
Analyze the example questions and their difficulties for this standard and ensure that the generated question matches the {{difficulty}} question in terms of complexity. However, note that some of these may cover a different Learning Objective for the standard, so you shouldn't just copy the example question structure.
Ultimately, a question at “hard” difficulty must match the difficulty of a hard STAAR question assessing the standard and learning objective.
There should be exactly 4-6 answer options (depending on the required difficulty) and the correct-answer count should be exactly 2-3. For easy questions use 4 difficulty options, 5 for medium, and 6 for hard.
If the question will be contextualized, brainstorm 2-3 engaging, grade-appropriate real-world topics.
Compute*Kappa*=similarity (question_difficulty, {{difficulty}})·
rule: same→proceed easier→amplify≥2 dimensions harder→simplify 1 dimension
<DifficultyAudit>
Cognitive Demand (Bloom):______
Number Range/Magnitudes:______
Operations or Steps Required:______
Representations Used (symbols, words, visuals):______
Context Familiarity:______
Option Set Size (total/correct):______
Answer-Choice Similarity Index (Do all options look plausible at first glance?):______
Matches Example? (yes/no):______
</Difficulty Audit>

### Step 2: Create the Stimulus Description Object

Examine the Stimulus Type Specification to determine required fields (e.g., “title”, ‘units’, ‘gridlines’, ‘shapes’, ‘labels’) and any constraints (ranges, allowed formats).
Construct a ** JSON object** named ‘stimulus_description’ that includes exactly those fields with valid values. This MUST be a JSON, the question will fail if it is not.
Ensure your values are logically consistent (e.g., coordinates define a valid shape) and respect any min/max or pattern rules.
Do **not** write a natural-language paragraph here—provide only the structured object.

### Step 3: Generate Varied Data

Use random values (numbers, names, shapes, etc.) within the Assessment Boundaries to ensure each question instance is unique.

### Step 4: Draft the Question

<drag_and_drop_development>
<GenerateQuestion>

Write a concise, clear question stem that:
Aligns directly with {{learningObjective}}
Uses the generated data from Step 3
Respects {{assessmentBoundary}}
Meets the Selected Difficulty guidelines
Stem must be self-contained, include all details, and *never reference undeclared visuals or external resources*.
The stem should NEVER explain a concept or a mathematical fact. The question should ONLY be asking the student about something.
For Hard questions, the stem must embed a multi-step (>2 steps) process without guiding students through the solution.
Ensure that steps are independent but necessary, and that no part of the solution is given away.
**Avoid negative-logic wording (“Which are not . . . ”).′
Simple formatting (like new lines, bullet points) can be used to ensure question clarity to the student.
</GenerateQuestion>
<DevelopChoices>
Solve or check each potential choice and determine the **2-3 correct mappings**.
Each incorrect choice must reflect a plausible misconception yet be demonstrably wrong in light of the learning objective; avoid any choices that are logically equivalent or interchangeable with a correct answer.
Write at least**5 total choices**(depending on the required difficulty) in a logical order (numerical, lexical, shortest-to-longest).
Generate a minimum 8 choices for Hard questions and exactly 6 for Medium questions.
Ensure that all distractors for Hard items are strong, target distinct common misconceptions, and are nearly as plausible as the correct choices.
For each Common Misconception, craft a plausible distractor reflecting that error.
No distractor (choice without an entry in the ‘correctMapping’) should EVER be mathematically equivalent to the correct answer (even for commutative property there shouldn't be 6×4 and 4×6 as answers or repeated addition summing to the same number).
Ensure all choices share format, units, complexity, and are unique and grade-appropriate.
Only use symbols or terms already defined in the stem.
For choices that contains text, the length for each choice should NEVER be more than 50 characters.
</DevelopChoices>
<DevelopTargetsAndCorrectMapping>
Solve or check each potential target to be used to drop choices developed. For each solution prepare the corresponding correctMapping.
A choice can map more than one time to more than one target.
Prepare at least**2 targets**(depending on the required difficulty) in a logical order (numerical, lexical, shortest-to-longest).
Generate a minimum 3 targets for Hard questions (with at least 6 choices).
Ensure that all distractors for Hard items are strong, target distinct common misconceptions, and are nearly as plausible as the correct choices.
Each choice must either fit ONE target or none. A choice can't match more than one target, regardless of the mapping of other choices
Ensure all targets share format, units, complexity, and are unique and grade-appropriate.
Only use symbols or terms already defined in the stem.
Ensure that the targets labels don't give out information that were not already present in the question.
</DevelopTargetsAndCorrectMapping>
<WriteCorrectMappingExplanations>
For each correctMapping, follow *exactly* this pattern:
A)<correctMapping expression>

### Explanation:

Start with an encouraging phrase that re-uses a key term from Direct Instruction.
Keep tone friendly and instructional; do **not** write the words “Distractor” or “Option.”
Sentence length≤20 words for Grades 3-5, ≤25 for Grades 6-8.
Maintain consistent punctuation, capitalization, and bullet style across all explanations.
Use Direct Instruction tone and terminology
Explanation should never reference the id of a choice or a target. Those ids are not shown to the student, and it would confuse them.
Absolute LaTeX rule: Only inline $ . . . $ or display $$ . . . $$ math using basic commands (\hat{ }, _, \frac, \sqrt, etc.). Do NOT use \begin, \end, \item, \emph, \textbf, \textit, \underline, \text { }, or any spacing commands (\; \, \quad, \qquad, \vspace, \hspace, etc.).
</WriteCorrectMappingExplanations>
<GenerateStimulusDescription>
Output the ‘stimulus_description’ JSON object from Step 2.
</GenerateStimulusDescription>
</drag_and_drop_development>
Step 4: Self-Validation Checklist
1. ** Distractors Plausibility**
   Each distractor is rooted in a real misconception from {{commonMisconceptionList}}.
   At least two distractors reflect high-level conceptual or strategic errors.
   All share the correct answer's units, magnitude, and notation style.
2. ** Alignment**
   The stem aligns exactly with {{learningObjective}}.
   Terminology matches Direct Instruction.
   The question respects {{assessmentBoundary}}.
   **Stem does not guide step-by-step solution. Or give out the number of choices to be used**
3. ** Correctness & Scoring**
   At least 2 correct mapping are available. For Hard question at least 6 correct Mapping and 4 for Medium questions.
   Full credit awarded ** only**when students maps *all* and *only* the correct choices to their correct targets. Full match to the correctMapping array.
   All choices are logically exclusive. A choice can't be possibly matching more than one target.
4. ** Explanation Quality*
   Correct explanations are mathematically accurate.
   Language and level are appropriate for Grade {{grade}}.
5. ** Language Style**
   Sentence length: ≤20 words for Grades 3-5 or ≤25 words for Grades 6-8.
   Vocabulary: familiar, neutral tone, no idioms or colloquialisms.
   Formatting: parallel structure, consistent punctuation and capitalization.
   Context: realistic for the grade, using whole numbers or simple fractions.
6. ** Difficulty Verification*
   Completed Difficulty Audit present and internally consistent.
   Choices and targets count match the correctMappings count
   DifficultyDelta accurately describes at least one concrete feature making the task harder/easier than the nearest lower band.
   As a general guideline, hard questions should have at least 3 strong distractors and may be multi-step-aligning with the difficulty of hard STAAR questions assessing this standard.
   For Hard questions, verify that the problem involves at least three operational steps, includes contextual complexities (e.g., multi-part real-world scenarios), and that at least three distractors reflect high-level conceptual or strategic errors.
   If any field is missing→**FAIL**.

Only deliver the question when it fully satisfies all validation steps.

### MCQ-Math-Grade 3-8-SB

### Context

You are an expert assessment writer for 3rd-9th grade Mathematics specializing in multiple-choice questions (MCQs). Your task is to write clear, grade-appropriate, and academically rigorous MCQs that align with specific educational standards and learning objectives. These MCQs will not have any supporting without stimulus such as images or diagrams.

### INPUTS (Use Exactly as Given, Substituting the Templates):

Selected Difficulty: The target complexity level for the question (e.g., easy, medium, hard) Use this to pick which Difficulty Definition to align with.

Grade: The grade level at which the MCQ should be aimed.

Standard Description: A description of the educational standard that we want to assess students on with MCQs.

Stimulus Type Specification: A short description of what the stimulus-drawing function should receive (e.g., fields like ‘title’, ‘units’, ‘gridlines’, ‘shapes’, ‘labels’) as well as an example of how the stimulus_description should look like.

Learning Objective: The precise skill or concept students should show by answering the question.

Assessment Boundaries: Any limits on content or representations (what's in-scope vs. out-of-scope).

Common Misconceptions: A list of typical student errors or misunderstandings for this concept.

Direct Instruction: The key terminology and instructional focus students will have been taught before this MCQ.

Difficulty Definition (Easy): Guidelines around what makes a question for this standard “Easy” difficulty.

Difficulty Definition (Medium): Guidelines around what makes a question for this standard “Medium” difficulty.

Difficulty Definition (Hard): Guidelines around what makes a question for this standard “Hard” difficulty.

### Generation Process

Step 1: Analyze the Inputs
   List the components of the Standard Description and Learning Objective.
   Note any Assessment Boundaries that limit the scope.
   Record the Difficulty Definition for {{difficulty}} and ensure the item aligns more closely with that level than with any easier levels.
   Enumerate each Common Misconception to inform distractors.
   Identify the key mathematical concept to be assessed.
   If a context is used, brainstorm 2-3 engaging, grade-appropriate real-world topics, but it must be concise.
Step 2: Create the Stimulus Description Object
   Examine the Stimulus Type Specification to determine required fields (e.g., “title”, ‘units’, ‘gridlines’, ‘shapes’, ‘labels’) and any constraints (ranges, allowed formats). Use the examples of stimulus_description to base the one for the question but do NOT copy the values directly.
   Using code interprete, construct a ** JSON object** named ‘stimulus_description that includes exactly those fields with valid values. This MUST be a JSON, the question will fail if it is not.
   Ensure your values are logically consistent (e.g., coordinates define a valid shape) and respect any min/max or pattern rules.
   Do **not** write a natural-language paragraph here-provide only the structured object.
Step 3: Generate Varied Data

### Random-Draw all Numbers

Use Python's random module (or equivalent).
Call the RNG once per numeric value.
Limit each draw to the Assessment Boundary and the range specified for {{difficulty}}, avoiding numbers characteristic of easier or harder levels.

### Keep Context Consistent and Brief

Write a concise stem with no unnecessary information or narration.
**Over-description ban: ** The stem may reference the stimulus (e.g., “Which shape . . . ?”) but must not recap what the student can already see (e.g., avoid “Four shapes are shown . . . ”).
Pick one noun phrase and stick with it (no switching flowers→tulips, paintings→sketches, etc.).
Scenarios must be logically commonplace-never contrived solely to fit the arithmetic.
Ensure no surface feature (option length, wording quirks, conspicuous arithmetic) hints at the correct answer.
Step 4: Draft the MCQ
   Wrap Your Output in these Tags:
Step 3: Draft the MCQ

Wrap your work in the following structure (without explicit tool calls):
<mcq_development>
<GenerateQuestion>

Write a concise, clear question stem that:
Aligns directly with Learning Objective: {{learningObjective}}
Uses the generated data from Step 2
Respects Assessment Boundary: {{assessmentBoundary}}
Matches the Difficulty Definition ({{difficulty}}) more closely than any easier level
Matches stimulus description (e.g. should not ask about a diagram when the image is labeled as Figure(s))·
Uses grade-appropriate language
</GenerateQuestion>
<DevelopAnswerChoices>
Solve completely to obtain the correct answer.
Provide exactly four options (1 correct+3 distractors).
Make every distractor a plausible result of a specific Common Misconception and express each in the same grammatical form, unit, and approximate length as the correct answer.
No distractor should EVER be mathematically equivalent to the correct answer (even for commutative property there shouldn't be 6×4 and 4×6 as answers or repeated addition summing to the same number)
Matches stimulus description (e.g. should not have an option about a diagram when the image is labeled as Figure(s))
Ban “All of the above”, “None of the above”, overlapping numerical ranges, logically impossible values, and cues unique to the right option.
Ensure all options are mutually exclusive.
</DevelopAnswerChoices>
<Write AnswerExplanations>

For each answer choice, follow exactly this pattern:
A)<answer-choice expression>
Explanation:
Start with an encouraging phrase that re-uses a key term from Direct Instruction
Examples: “Not quite!” or “Good job!”
Give a step-by-step walk-through in ≤3 short sentences. They should all be in a single line, NEVER in bullet points or in a list.
Use the same mathematical vocabulary and symbols introduced in Direct Instruction.
If answer is incorrect, finish with ** “Bonus tip:” **+one sentence that targets the specific misconception and shows how to fix it.
Keep tone friendly and instructional; do **not** write the words “Distractor” or “Option.”

Repeat the pattern for B), C), D).
Sentence length≤20 words for Grades 3-5, ≤25 words for Grades 6-8.
Maintain consistent punctuation, capitalization, and style.
Absolute LaTeX rule: Only inline $ . . . $ or display $$ . . . $$ math using basic commands (\hat{ }, _, \frac, \sqrt, etc.). Do NOT use \begin, \end, \item, \emph, \textbf, \textit, \underline, text { }, or any spacing commands (\; \, \quad, \qquad, \vspace, \hspace, etc.).
</Write AnswerExplanations>
<GenerateStimulusDescription>
Output the ‘stimulus_description’ JSON object from Step 2.
</GenerateStimulusDescription>
</mcq_development>
Step 5: Self-Validation Checklist

Before finalizing, ensure the MCQ passes all five validation criteria:
1. Distractor Plausibility
   At least two distractors are plausible and reflect high-level conceptual or strategic errors drawn from {{commonMisconceptionList}}.
   Avoid obvious distractors (e.g. addition operation when the question asks for multipilcation, etc.)
   All share the correct answer's units, magnitude, and notation style.
2. Alignment
   Stem aligns exactly with Learning Objective: {{learningObjective}}.
   Terminology matches Direct Instruction.
   The question respects Assessment Boundary: {{assessmentBoundary}}.
3. Correctness
   Independently solve and confirm the correct answer.
   Verify each distractor is strictly incorrect and logically exclusive.
   Exactly one option is correct.
4. Explanation Quality
   Each explanation is a single continuous line with no bullet points.
   Correct explanation is mathematically accurate.
   Each incorrect explanation names the misconception and corrects it step by step.
   Language level matches Grade {{grade}}.
   LaTeX complies with the absolute rule above.
5. Language Style
   Sentence length: ≤25 words (Gr 3-5) or ≤35 words (Gr 6-8).
   Vocabulary: familiar, neutral, and free of idioms.
   Formatting: parallel structure; consistent punctuation and capitalization.
   Context: realistic for the grade, using whole numbers or simple fractions.
6. Difficulty Verification
   The item aligns with the Difficulty Definition ({{difficulty}}) more closely than with easier levels.
   Distractor attractiveness increases appropriately from Easy→Medium→Hard per guidelines (distance or reasoning required).
7. Option Format Integrity
   No “all/none of the above,” no overlapping intervals, and all options are parallel in grammar, length, and structure.

Only deliver the MCQ when it fully satisfies all validation steps.

### ELA Text Entry Example Questions Generator

enerate THREE CCSS-aligned, auto-gradable fill-in-the-blank ELA Text Entry items (1 Easy, 1 Medium, and 1 Hard question according to the Difficulty Binding Criteria) in the schema below. Also, output the difficulty level of the question that you have generated, including a “reason”: WHY do you think the question should be qualified as the ‘difficulty’ level that you outputted?

If for any set of inputs, it is NOT possible to generate any of the 3 types, then it should be so in the output. The question should be blank in that case, with the relevant reason.

```
  **Schema**:
  ‘‘‘json
  [{
    ″instructions″: ″string″,
    ″question″: ″string″,
    ″answer″: [″string″, ...],
    ″explanation″: {″title″: ″string″ ,″text″: ″string″},
    ″difficulty″: ″string″,
    ″reason″: ″string″
  }]
  ‘‘‘
  **Inputs**: Grade, Substandard Description, Educational Objective, Task, Common
Misconceptions, Direct Instruction, Difficulty (easy, medium, hard).
  ---
  → **Grade-Level Enforcement**: Before final output, run
through these checks and **do not** produce the question if
**any** apply-raise cognitive demand or add reasoning until
none do:
  1. **Pure mechanics/drill** (e.g. phoneme counting, morphological chunking,
syllable drills)
  2. **Single-step recall** that a student two or more grades below could answer
  3. **Mechanics-only insertion/selection** (punctuation marks, capitalization
changes, one-letter/phoneme swaps)
  4. **Simple vocabulary**: stimulus ≤ 40 words **and** all content words within
the top 2,000 most frequent English words
  5. **Vague-word replacement** (e.g. replace “fun,” “good,” “nice”) for grades ≤
4
  6. **Basic synonyms/antonyms** tasks for grades ≤ 4
  7. **Affix identification** in isolation (-ing, -ed, re-, un-) for grades ≥ 4
  8. **Skill mismatch**: tests a concept not in the Substandard or Educational
Objective
  9. **High-frequency vocabulary**: more than 50% of content words in the question
or stimulus are within the top 1,500 English words
  → **Difficulty Binding**: Use the provided ‘Difficulty‘
exactly − Easy items must follow only the Easy criteria;
Medium only Medium; Hard only Hard. IGNORE the ′difficulty′
input and generate ALL 3 types of questions.
    **Guideline for difficulty level binding is given below**:
    - **Easy (Recall)**: Single-step identification or retrieval from Direct Instruction.
    - **Medium (Analysis)**: At least two logical steps (e.g., apply a rule + context
inference).
    - **Hard (Synthesis)**: Novel or multi-layered reasoning (comparison, error
correction); if impractical in one blank, default to challenging Medium with explicit two-step
demand.
  ---
  ### Alignment & Cognitive Demand
  - **Sentence Style**: Do not begin question sentences with a specific year (e.g.,
″1999 was the year when...″).
  - **Grade-level**: Match the specified CCSS Substandard Description; vocabulary
and syntax should be at or slightly above grade expectations. Spelling/phonics tasks are
allowed if they align to the objective; use developmentally suitable words. Avoid tasks below
or beyond the grade's cognitive scope.
  - **Quick Rules**:
    - One ‘<blank>‘ per question.
    - Keep answers short and auto-gradable; do not supply open-ended or unbounded
answer sets.
    - Provide neutral, supportive explanation based on Direct Instruction.
  Always reference Direct Instruction in the explanation.
  **Learning Content**: Begin with ″Here's what you need to know:″ followed by 2-3
concise, grade-appropriate sentences that distill key points from the Direct Instruction; do not
copy the full Direct Instruction verbatim. Do not include any markdown headings, bullet lists,
or full lesson text-keep it plain text summary.
  ---
  ### Template Precedence (first match applies)
  1. Task mentions **vague/precision phrase** → Replace a vague phrase
  2. Task starts with **Identify the ...** → Identify a single element
  3. Task mentions **capitalize** → Capitalization
  4. Task mentions vocabulary features → Locate a vocabulary feature
  5. Task mentions error/fix/revise → Replace an incorrect form
  6. Task mentions simile/metaphor/idiom/tone/mood → Classify
figurative/rhetorical device
  7. Otherwise → Generic fill-in-the-blank
  ---
  ### Task-Specific Templates
  **1. Replace a vague phrase**
  - **Instructions:** ‘Revise the underlined vague phrase with a precise phrase (1-3
words). Use only the options provided.‘
  - ** Question:** ‘The sentence ″{sentenceWithUnderlinedPhrase}″ with the
underlined phrase as <blank>.‘
  **2. Identify a single element**
  - **Instructions:** ‘Type the <concept> of the sentence below.‘
  - **Question:** ‘The <concept> of the sentence ″{sentence}″ is <blank>.‘
  **3. Capitalization**
  - **Instructions:** ‘Type the correctly capitalized word from the sentence below.‘
  - **Question:** ‘The sentence ″{sentenceWithLowercase}″ contains the word that
needs a capital letter, shown as <blank>.‘
  **4. Locate a vocabulary feature**
  - **Instructions:** ‘Type the word in the sentence below that has the <feature>.‘
  - **Question:** ‘″{sentence}″ The word with the ″<feature>″ is <blank>.‘
  **5. Replace an incorrect form**
  - **Instructions:** ‘Revise the sentence by replacing the incorrect <feature> with the
correct one.‘
  - **Question:** ‘″{sentenceWithError}″ →
″{correctedPrefix}<blank>{correctedSuffix}″‘
  **6. Classify figurative/rhetorical device**
  - **Instructions:** ‘Type the literary term that applies to the example below.‘
  - **Question:** ‘The sentence ″{exampleSentence}″ is a <blank>.‘
  **7. Generic fill-in-the-blank**
  - **Instructions:** ‘Fill in the blank to correctly complete the sentence below.‘
  - **Question:** A single sentence containing exactly one ‘<blank>‘.
  ---
  ### Examples
  **Easy / Capitalization**
  ‘‘‘json
  {
    ″instructions″: ″Fill in the blank with the correct relative pronoun (who, which, or
that)″,
    ″question″: ″My friend Mia has a dog <blank> loves to play in the park.″,
    ″answer″: [″that″]
  }
  ‘‘‘
  **Medium / Replace an incorrect form**
  ‘‘‘json
  {
    ″instructions″: ″Revise this sentence by replacing the incorrect pronoun:\n\nSam and
I went to the park. They said Sam and I would win.″,
    ″question″: ″Sam and I went to the park. <blank> said Sam and I would win.″,
    ″answer″: [″He″],
    ″explanation″: {″title″:″Explanation″,″text″:″′He′ correctly refers back to Sam,
performing the action of saying. ′Sam and I′ is a compound subject, not a pronoun.″}
  }
  ‘‘‘
  **Medium / Classify figurative device**
  ‘‘‘json
  {
    ″instructions″: ″Type the literary term that applies to the example below.″,
    ″question″: ″The sentence \″Her laughter was music to his ears.\″ is a <blank>.″,
    ″answer″: [″metaphor″],
    ″explanation″: {″title″:″Explanation″,″text″:″This sentence directly compares
laughter to music without ′like′ or ′as,′ so it's a metaphor.″},
    ″learning_content″: ″Here's what you need to know: A metaphor states one thing is
another without comparative words to create vivid imagery.″
  }
  ‘‘‘
  **Hard / Identify a single element**
  ‘‘‘json
  {
    ″instructions″: ″Type the dependent clause in the sentence below.″,
    ″question″: ″The dependent clause of \″Because the storm raged, the lighthouse
keeper stayed alert all night.\″ is <blank>.″,
    ″answer″: [″Because the storm raged″],
    ″explanation″: {″title″:″Explanation″,″text″:″A dependent clause has a subject and
verb but cannot stand alone. ′Because the storm raged′ qualifies as one.″},
    ″learning_content″: ″Here's what you need to know: Dependent clauses begin with
subordinating conjunctions and cannot function as complete sentences.″
  }
  ‘‘‘
  ---
```

[symbol] Don't output anything but the JSON object.

### Math DI Article Generator ##ROLE

You are a DI (Direct Instruction) article generator for 3rd Grade Math.

Use the information below to generate a complete HTML article.

Generate each section one at a time, following the structure and rules provided.

Make sure to use the correct headers, spaces, and a clean layout—the article should feel easy to read, not crowded.

Use action-oriented language for problem-solving steps (e.g., “Identify,” “Count,” “Add,” “Multiply”) rather than repeating “Write . . . ” for every step.

Remind students to consistently apply the “General Steps” when solving problems.

Avoid imperative openers like “Imagine . . . ” unless explicitly necessary to enhance engagement.

### You MUST:

Explicitly teach every required concept listed in the Task and Attribute Examples.
Embed each stimulus (if provided) into the appropriate place (worked example, guided practice, or independent practice) using a<div class=“stimulus”> {{stimulus}}</div>block.
When the stimulus is a description (e.g., “A measuring cup shows 250 mL”), create a simple SVG diagram (basic rectangle, labeled) inside the <div class=“stimulus”>block using only basic HTML (SVG/Canvas).
Do NOT use external image URLs or services. Create diagrams natively in SVG if visual is needed.
Do not leave out any stimulus or attribute.
Keep the layout clean and readable.

### ##Data Definitions

**Title**: The name of the lesson that summarizes the skill or concept students will learn.
**Grade**: The academic level for which the article is intended (e.g., Grade 3).
**Standard**: The official educational standard (e.g., CCSS.MATH.CONTENT.3.NF.A.1) that defines the overall goal.
**Substandard ID**: A more specific breakdown or variation of the main standard.
**Substandard Description**: A detailed description of what this specific substandard expects the student to accomplish.
**Skill**: The core ability or focus that the student will develop (e.g., “Understanding fractions as numbers.”).
**Task**: Describes exactly what the student must be able to do at the end of the lesson.
* Learning Objectives**: Student-friendly bullet points that state what students will learn during the lesson.
Common Misconceptions**: Typical mistakes students make when learning this skill.
Attribute List**: A list of examples, properties, or specific characteristics tied to the standard, including associated stimuli.

You must use these inputs correctly and explicitly guide the article based on them.

Whenever natural, connect objectives and explanations to real-world applications students might recognize.

If the concept naturally benefits from a visual diagram or chart (such as polygon hierarchies, unit fraction partitions, or perimeter grids), you must embed a diagram stimulus inside the article where it best supports understanding.
If a visual helps in explaining key concepts, place it inside the <div class=“stimulus”> {{stimulus}}</div>block at the relevant point (for example, before General Steps, within Worked Example, or inside Independent Practice).
Do not reserve all diagrams only for the end. Integrate them naturally where they support the student's thinking.
Use embedded stimuli consistently and format them clearly.
Avoid the word “Think”
##INPUT DATA
**Title**: {{title}}
**Grade**: {{grade}}
**Standard**: {{standard}}
**Substandard ID**: {{substandardId}}
**Substandard Description**: {{substandardDescription}}
**Skill**: {{skill}}
**Task**: {{task}}
**Learning Objectives**: {{learningObjectiveList}}
**Common Misconceptions**: {{commonMisconceptionList}}
**Attribute Examples**: {{standardAttributeExampleQuestionList}}
##ARTICLE STRUCTURE
<h1> {{title}}</h1>
<div class=“introduction”>
Write a concise and engaging anticipatory set that introduces the concept in a way that a 3rd grader can relate to.
Use real-world, relatable ideas (e.g., lunch, games, pets, toys).
Do not greet the student.
Avoid rhetorical starters like “Have you ever . . . ?”, “Imagine this . . . ” unless absolutely necessary and strongly enhances the engagement.
Get straight to the concept with a fun hook if possible.
</div>
<div class=“objectives”>
Write 1-2 bullet points that complete the sentence:
Use “In this lesson, you are going to learn how to . . . ” as a subtitle above the list.
Objectives must align tightly with the substandard and task.
Keep them short, friendly, and focused on the standard and task.
When natural, relate objectives to real-world uses.
</div>
<div class=“key_concepts”>
Clearly and simply explain the core concept.
Bold key concept words.
Avoid overloading with definitions.
End with one comprehension check (“Think: . . . ?”).
Cover all required concepts from Task and Attribute Examples.
Make sure that the “Comprehension check” ensures the students has read the article so far.
No teacher-speak like “model,” “guided practice.”
</div>
<div class=“worked_example_table”>
Use a 2-column HTML table with visible borders.
Each row must have:
Left=fully worked example (using action steps) Title it “Example”.
Right=matching guided practice (structured, less scaffolded) Title it “Practice”
   Each Row Must have:
Left: Full worked example
Right: Matching guided practice
Use ** step-by-step format**where each step is a solving action, (not the problem restated).
**Stimuli Handling**:
If a stimulus belongs to an example, insert it ** immediately above the problem**inside the left column using:
‘‘‘html
<div class=“stimulus”>
[If it's a drawing: create a simple SVG figure showing the description.]
[If it's text: write the description clearly.]
</div>

For drawing-related stimuli, build a basic SVG diagram inside the stimulus block using simple shapes and labels (rectangles, lines, basic shapes).

No external images or external links.

Present a fully worked example aligned with the task. ** Make sure that when using “step” is a way to solve the problem and NOT the problem itself.*

Add the problem as a subheader and make all the steps real work steps.

Prefer diverse action verbs (“Identify,” “Count,” “Add,” “Multiply”) rather than only “Write . . . ” at every step.

Repeat table if multiple formats are needed.
</div>
</div>
<div class=“general_steps”>
Provide 3-4 simple steps summarizing the strategy.
Title: “General Steps for [Task]”
Use an intro line: “These are the steps we used . . . ”
Use action verbs. Format clearly.
</div>
<div class=“independent_practice”>
Title: “Show what you know”
Title: “Show what you know”
Briefly instruct: “Now it's your turn to try! Solve the following problems by following the General Steps you learned.” or some variation of it.
Create 3 problems aligned to the task. with slightly increasing complexity or faded scaffolding.
Hide the step-by-step solution under a ‘<details>block.
Each solution must follow the “General Steps” language for consistency.
Each problem must be followed by a ** step-by-step explanation**that is initially hidden. Use the ‘<details>’ tag so the student must click to reveal the solution. ** on each step it MUST have the description of it using the ones created in “general_steps”
Insert stimulus where necessary using the same SVG style inside<div class=“stimulus”>.
After each problem, include a<details>block with a step-by-step explanation using the “General Steps.”

### Example

<p><strong>Problem 1: </strong> [problem]</p><details><summary><em>Show step-by-step explanation</em></summary><p>Step 1: . . . </p><p>Step 2: . . . </p><p>Step 3: . . . </p></details>
</div>
<div class=“summary”>
Restate the main idea and General Steps briefly.
No new examples, no new math concepts or steps introduced.
Prefer bullets if listing multiple actions.
Prefer short, clear sentences.
This section should feel familiar and reinforce the skill.
Do not mechanically repeat steps if not needed.
</div>
<div class=“motivation”
End with a positive and encouraging line (“Great job!”, “Keep practicing!”, etc.)
No new instruction here.</div>

### Output

Output a clean, complete, fully structured HTML article, properly using sections and embedding stimuli.

Use correct HTML tags.

No markdown, no notes.

Stimuli must be rendered directly inside HTML (simple SVG).

Ensure all concepts and attributes are fully covered, leaving no gaps.

Ensure vocabulary, steps, and scaffolding are consistent across sections.

### Additional Rules

Every stimulus must be natively created using HTML (SVG) or plain text inside<div class=“stimulus”>.

If a drawing stimulus is described (e.g., “measuring cups”), create a simple but clear SVG with shapes and labels.

Never use image URLs.

Never skip a stimulus.

Keep visual diagrams simple and schematic, NOT artistic or detailed.

Match the stimulus exactly to the associated worked example or practice question.

### MCQ-APUSH-Visual SB

<examples>

Stimulus: This 1774 British political cartoon, ““The Able Doctor, or America Swallowing the Bitter Draught,”” critiques the British Parliament's harsh policies toward the American colonies. It depicts America as a Native woman being force-fed by British officials, symbolizing the oppressive nature of the Intolerable Acts.

Question: The political cartoon most directly supports which of the following arguments about British colonial policies in the 1770s?

### Options:

A. They were uniformly supported by colonial political leaders. [Incorrect]
   Explanation: This contradicts the cartoon's message. The image shows America (representing the colonies) resisting British policies, not supporting them.
B. They were designed to promote peaceful negotiation between Britain and the colonies. [Incorrect]
   Explanation: This option contradicts the forceful and oppressive nature of British policies depicted in the cartoon. The image shows coercion, not peaceful negotiation.
C. They were primarily focused on regulating trade rather than asserting political control. [Incorrect]
   Explanation: This option misses the political nature of the conflict shown in the cartoon. The image emphasizes political control and coercion, not merely trade regulation.
D. They were perceived by colonists as unjust impositions that violated their rights. [Correct]

Explanation: Correct. The cartoon portrays British policies, particularly the Intolerable Acts, as forced upon an unwilling America, supporting the colonists' view of these measures as unjust violations of their rights.

### Learning Content:

Here's what you need to know: The political cartoon ““The Able Doctor”” vividly illustrates the colonial perspective on British taxation policies, particularly the Intolerable Acts. It portrays America as a victim being forcibly subjected to oppressive measures, symbolizing the growing tension between the colonies and Britain. The cartoon effectively conveys the sentiment that these policies were unjust and coercive, helping to unite colonists against perceived infringements on their rights and economic freedoms. When analyzing such political cartoons, look for symbolic representations, labels, and the overall message conveyed through imagery. Consider how these visual elements reflect the historical context and perspectives of the time.

Stimulus: In 1917, suffragists protested outside the White House to urge President Woodrow Wilson to support women's suffrage, highlighting the contradiction in promoting democracy abroad while denying it at home.
(Image credit: Access for free at openstax.org)

Question: The suffragists' protest depicted in the image most directly supports which of the following arguments about Progressive Era reform efforts?

### Options:

A. Reformers relied primarily on legislative processes rather than public demonstrations to achieve their goals. [Incorrect]
   Explanation: This is incorrect. The image clearly shows reformers using a public demonstration to advocate for their cause, contradicting the idea that they relied primarily on legislative processes.
B. Reformers often highlighted contradictions between American ideals and practices to advocate for change. [Correct]
   Explanation: Correct. The suffragists' sign points out the contradiction of promoting democracy abroad while denying women the right to vote at home, using this inconsistency to argue for women's suffrage.
C. Progressive reforms were universally supported across all segments of American society. [Incorrect]
   Explanation: This is incorrect. While the image shows support for women's suffrage, it does not indicate universal support for Progressive reforms. In fact, the need for protest suggests opposition to this particular reform.
D. Progressive reforms primarily focused on addressing economic inequality rather than political rights. [Incorrect]
   Explanation: This is incorrect. While economic reforms were part of the Progressive Era, the image clearly shows a focus on political rights, specifically women's suffrage.

### Learning Content:

Here's what you need to know: Progressive Era reformers often used strategic rhetoric to highlight contradictions between American ideals and practices. In this case, the suffragists pointed out the irony of promoting democracy abroad while denying women the right to vote at home. This tactic of exposing inconsistencies was a powerful tool for advocating change. When analyzing historical sources, look for how reformers framed their arguments in relation to broader American values and international contexts. Consider how they used current events, like U.S. involvement in World War I, to strengthen their case for domestic reforms.

Stimulus: James Meredith, escorted by U.S. Marshals, integrates the University of Mississippi in 1962. This historic event marked a significant moment in the Civil Rights Movement, showcasing federal intervention in enforcing desegregation laws. Meredith's enrollment was a critical step towards racial equality in American education.

Question: The image most directly illustrates the executive branch's efforts to promote racial equality through:

### Options:

A. Passing new civil rights legislation [Incorrect]
   Explanation: This is incorrect because the image doesn't depict the legislative process. It shows the enforcement of existing court decisions, which falls under executive branch responsibilities.
B. Enforcing court-ordered desegregation of public universities [Correct]
   Explanation: Correct. The image shows James Meredith being escorted by federal marshals to integrate the University of Mississippi in 1962, demonstrating the executive branch's role in enforcing desegregation rulings.
C. Deploying federal troops to enforce desegregation orders [Incorrect]
   Explanation: While federal troops were used in some cases, this image doesn't show military personnel. It depicts federal officials escorting James Meredith, illustrating a different form of federal intervention.
D. Desegregating federal government offices [Incorrect]
   Explanation: While the executive branch did work on desegregating federal offices, this image specifically shows efforts to desegregate a public university, not a government office.

### Learning Content:

Here's what you need to know: The image depicts a crucial moment in the Civil Rights Movement when the executive branch took direct action to enforce desegregation. James Meredith's enrollment at the University of Mississippi, protected by federal marshals, exemplifies how the executive branch implemented the Supreme Court's Brown v. Board of Education decision. This event highlights the complex process of desegregation, showing that court rulings often required federal enforcement to overcome local resistance. When analyzing similar questions, look for evidence of federal intervention in civil rights issues, particularly instances where the executive branch acted to support court decisions or enforce existing laws.

Stimulus: George Washington resigns as Commander-in-Chief of the Continental Army, marking a pivotal moment in U.S. history. This event, held in the Maryland State House on Dec. 23, 1783, symbolizes the transition to civilian governance. Washington's resignation emphasized the values of democracy and peaceful transfer of power.

Question: Which of the following best explains why George Washington's resignation, as depicted in the image, was significant for the development of the new republic?

### Options:

A. It allowed Washington to immediately assume the role of president of the United States. [Incorrect]
   Explanation: Incorrect. Washington did not become president until years later in 1789. His resignation as commander-in-chief was separate from his later election as president.
B. It formalized a permanent alliance between the United States and France. [Incorrect]
   Explanation: Incorrect. Washington's resignation did not involve foreign alliances. In fact, he later warned against permanent alliances in his Farewell Address as president.
C. It demonstrated Washington's commitment to civilian rule and rejection of military dictatorship. [Correct]
   Explanation: Correct. By voluntarily resigning his military commission, Washington set a powerful precedent for civilian control of the military and peaceful transfer of power, key principles of the new republic.
D. It established a tradition of two-term limits for the presidency. [Incorrect]
   Explanation: Incorrect. While Washington later set a two-term precedent as president, his military resignation was unrelated to presidential term limits.

### Learning Content:

Here's what you need to know: My resignation as Commander-in-Chief was a pivotal moment in early American history. By voluntarily relinquishing my military power, I demonstrated my commitment to republican principles and civilian rule. This act set a crucial precedent for the peaceful transfer of power and civilian control over the military-cornerstones of American democracy. It also helped allay fears of military dictatorship or monarchy, concerns that were very real given the historical context of the time. When analyzing similar historical events, consider their long-term impact on political norms and institutions, not just their immediate effects.

Stimulus: ‘In Pittsford on the Erie Canal’ by George Harvey (1837) captures the Erie Canal in a serene natural setting, highlighting its role in the transportation revolution. The canal facilitated commerce and migration, influencing the economic development of 19th century America.

Question: The Erie Canal, as depicted in the 1837 painting, contributed to the expansion of manufacturing in the Northeast and Midwest from 1800 to 1848 primarily because it

### Options:

A. immediately led to uniform economic development across all regions of the United States [Incorrect]
   Explanation: This answer overstates the canal's impact and timeline. While the Erie Canal had significant effects, it primarily benefited the Northeast and Midwest, not all regions equally, and its full economic impact took time to materialize.
B. served mainly as a passenger route, indirectly supporting manufacturing by facilitating labor migration [Incorrect]
   Explanation: While the canal did transport some passengers, its primary function was not passenger travel. This answer underestimates the canal's direct role in goods transportation, which was central to its impact on manufacturing.
C. primarily benefited Southern cotton plantations by providing access to Northern textile mills [Incorrect]
   Explanation: This answer misrepresents the primary beneficiaries of the Erie Canal. While it did facilitate some trade between North and South, its main impact was on the Northeast and Midwest regions, not Southern cotton plantations.
D. reduced transportation costs, allowing for more efficient movement of raw materials and finished goods [Correct]
   Explanation: Correct. The Erie Canal significantly lowered transportation costs, enabling cheaper and faster movement of raw materials to factories and finished goods to markets, which was crucial for manufacturing growth in the Northeast and Midwest.

### Learning Content:

Here's what you need to know: The Erie Canal, depicted in the painting, was a crucial infrastructure project that dramatically expanded manufacturing in the Northeast and Midwest from 1800 to 1848. It provided an efficient water route connecting the Great Lakes to the Atlantic Ocean, significantly reducing transportation costs and time for raw materials and finished goods. This new transportation network allowed for the rapid movement of resources and products, facilitating industrial growth in cities along its route. The canal's impact went beyond just moving goods; it also spurred innovation, encouraged westward expansion, and helped shape the economic geography of the young nation.

Stimulus: This engraving captures a slave auction in the rotunda of a New Orleans building, highlighting the commodification of human lives in the antebellum South. The scene underscores the racial and economic dynamics preceding the Civil War, with an auctioneer and potential buyers engaging in transactions. The grand architecture contrasts with the somber reality of the enslaved individuals presented for sale.

Question: The slave auction depicted in the image most directly illustrates which of the following aspects of the antebellum South?

### Options:

A. The economic interdependence between Northern and Southern states [Incorrect]
   Explanation: While economic interdependence existed, this image focuses specifically on the slave trade within the South, not broader economic relationships between regions.
B. The legal restrictions on interracial relationships [Incorrect]
   Explanation: While laws restricting interracial relationships existed, this image does not directly depict or address that aspect of Southern society.
C. The uniform implementation of chattel slavery across all Southern states [Incorrect]
   Explanation: This image shows a slave auction in New Orleans, but does not provide evidence about the uniformity of slavery practices across all Southern states.
D. The commodification of enslaved people in a formalized market system [Correct]
   Explanation: Correct. The image shows enslaved people being auctioned in a grand public space, clearly illustrating how they were treated as commodities to be bought and sold in a formal market setting.

### Learning Content:

Here's what you need to know: The image of the slave auction in New Orleans vividly illustrates the commodification of enslaved people in the antebellum South. This practice was a cornerstone of the Southern economy, where human beings were bought and sold as property in formal market settings. The grand architecture of the rotunda contrasts sharply with the dehumanizing nature of the auction, highlighting the deeply entrenched racial and economic hierarchies of the time. To answer questions like this, look for specific evidence in the image that connects to broader historical concepts, such as the economic systems of slavery or the social structures of the antebellum South.

Stimulus: George Washington resigns as Commander-in-Chief of the Continental Army, marking a pivotal moment in U.S. history. This event, held in the Maryland State House on Dec. 23, 1783, symbolizes the transition to civilian governance. Washington's resignation emphasized the values of democracy and peaceful transfer of power.

Question: Which of the following principles from George Washington's Farewell Address is best illustrated by the scene depicted in this image?

### Options:

A. The danger of political parties and factions [Incorrect]
   Explanation: While this was a key point in Washington's Farewell Address, the image does not specifically illustrate partisan divisions. Instead, it shows a unified group witnessing a peaceful transfer of power.
B. The importance of forming strong foreign alliances [Incorrect]
   Explanation: This is incorrect. Washington's Farewell Address actually cautioned against permanent foreign alliances, not encouraged them. The image shows Washington's resignation from military command, emphasizing domestic governance rather than foreign relations.
C. The importance of civilian control over the military [Correct]
   Explanation: Correct. This image depicts Washington resigning his military commission to Congress, exemplifying the principle of civilian control over the military that he emphasized in his Farewell Address. This act reinforced the idea that the military should be subordinate to civilian leadership in a democracy.
D. The need for a strong central government [Incorrect]
   Explanation: Although Washington supported a strong federal government, this image more directly illustrates the principle of civilian control over the military rather than centralized governance.

### Learning Content:

Here's what you need to know: The image depicts George Washington resigning his military commission to Congress, a pivotal moment that embodies a key principle from his Farewell Address—the importance of civilian control over the military. This act set a crucial precedent for American democracy, ensuring that military power remains subordinate to civilian authority. When answering questions about Washington's Farewell Address, look for themes of national unity, avoidance of partisan divisions, and the balance of power between civilian and military leadership. Consider how these principles shaped early American governance and continue to influence U.S. political ideals today.

Stimulus: This 1884 print of the New Orleans levee highlights the bustling port activities with numerous steamships and large cotton bales ready for shipment. The scene underscores the economic significance of cotton and its ties to slavery in the Southern economy.

Question: The scene depicted in the image most directly supports which of the following statements about the economic impact of transportation innovations in the early to mid-19th century?

### Options:

A. Transportation advancements led to uniform economic development across all regions of the United States. [Incorrect]
   Explanation: This answer overgeneralizes the impact of transportation innovations. While the image shows significant economic activity in New Orleans, it doesn't provide evidence for uniform development across all U.S. regions.
B. New transportation systems primarily benefited agricultural production in the South. [Incorrect]
   Explanation: While the image shows the importance of cotton exports, it doesn't suggest that transportation innovations primarily benefited Southern agriculture. The question asks about the broader economic impact, which extended beyond just agricultural production.
C. Improved transportation networks facilitated the movement of goods and stimulated economic growth. [Correct]
   Explanation: Correct. The image clearly shows how steamships on the Mississippi River enabled the efficient transport of cotton and other goods, illustrating how improved transportation networks stimulated economic activity and growth.
D. Steamships and river transport were less significant than railroads in expanding commerce. [Incorrect]
   Explanation: This answer contradicts the evidence in the image, which clearly shows the importance of steamships and river transport in facilitating commerce. The misconception that railroads were the only significant transportation innovation is addressed here.

### Learning Content:

Here's what you need to know: The image of the New Orleans levee in 1884 illustrates the dramatic impact of new transportation systems, particularly steamships, on manufacturing and commerce. Steamships significantly expanded the capacity to transport raw materials and finished goods, connecting regional markets and spurring industrial growth. This innovation reduced transportation costs and time, allowing for more efficient movement of cotton and other goods. The bustling port scene showcases how these advancements in transportation technology facilitated the growth of manufacturing and trade, transforming economic landscapes across regions.

Stimulus: This political cartoon illustrates Uncle Sam as a school teacher, educating children representing U.S. territories acquired after the Spanish-American War. The image critiques American imperialism and the belief in the ‘civilizing’ mission of the United States. It serves as a commentary on the paternalistic attitudes towards the Philippines, Puerto Rico, Cuba, and Hawaii in the late 19th and early 20th centuries.

Question: The political cartoon most directly illustrates the concept of

### Options:

A. manifest destiny [Correct]
   Explanation: Correct. The cartoon illustrates the concept of manifest destiny—the 19th century belief that American expansion and influence over other territories was both justified and inevitable. Uncle Sam as a teacher ‘civilizing’ other nations embodies this imperialistic ideology.
B. popular sovereignty [Incorrect]
   Explanation: The cartoon does not depict popular sovereignty. Rather than showing self-governance, it illustrates imposed American control over other territories.
C. isolationism [Incorrect]
   Explanation: This answer is incorrect as the cartoon depicts active U.S. involvement with other territories, which is the opposite of isolationism.
D. cultural assimilation [Incorrect]
   Explanation: While cultural assimilation is depicted in the cartoon, it is not the primary concept being illustrated. The image more broadly represents the imperialistic ideology behind U.S. expansion.

### Learning Content:

Here's what you need to know: The political cartoon illustrates the concept of manifest destiny, a 19th century belief that American expansion was both justified and inevitable. The image depicts Uncle Sam as a teacher ‘civilizing’ other nations, embodying the paternalistic and imperialistic ideology behind U.S. expansion. To answer similar questions, look for visual representations of American exceptionalism or attempts to impose American values on other cultures. Consider how historical ideologies like manifest destiny shaped U.S. foreign policy and attitudes towards newly acquired territories.

Stimulus: An 1807 political cartoon critiques Jefferson's Embargo Act, showing a smuggler caught by a snapping turtle labeled ‘Ograbme.’ The turtle symbolizes the enforcement challenges of the embargo as it impedes the smuggler's illicit trade with a British ship.

Question: The political cartoon best illustrates the argument that the Embargo Act of 1807:

### Options:

A. was easily enforced by the Jefferson administration [Incorrect]
   Explanation: This is incorrect. The cartoon depicts the difficulties in enforcing the embargo, as shown by the smuggler's attempt to trade with the British ship and the need for the ‘snapping turtle’ of enforcement to intervene.
B. primarily harmed British trade interests [Incorrect]
   Explanation: This is incorrect. While the embargo was intended to pressure Britain, the cartoon focuses on its impact on American smugglers and merchants, not on British trade interests. The presence of the British ship suggests continued British trade activity.
C. faced significant enforcement challenges and public resistance [Correct]
   Explanation: This is correct. The cartoon illustrates the difficulties in enforcing the embargo through the smuggler's actions and the ‘snapping turtle’ of enforcement. The smuggler's exclamation and the presence of the British ship offshore show public resistance and the temptation to circumvent the law.
D. successfully prevented American goods from reaching foreign markets [Incorrect]
   Explanation: This is incorrect. The cartoon shows a smuggler attempting to bypass the embargo, indicating that the act was not fully successful in preventing trade. The snapping turtle represents the challenges faced in enforcing the embargo.

### Learning Content:

Here's what you need to know: The Embargo Act of 1807 faced significant challenges in implementation and enforcement, as depicted in this political cartoon. The image shows a smuggler attempting to trade with a British ship, illustrating how Americans sought to circumvent the embargo. The ‘snapping turtle’ represents the government's efforts to enforce the act, but its presence also highlights the difficulties in doing so effectively. This cartoon reflects the broader historical context of the period, where American attempts at economic coercion through the embargo were met with resistance both domestically and internationally. When analyzing similar political cartoons, look for symbolic representations of policies (like the turtle) and how they interact with other elements to convey the cartoonist's message about the effectiveness and reception of those policies.
</examples>

You are an expert question writer for the AP United States History exam, specializing in the development of image-based multiple-choice questions (MCQs). Your task is to create a difficult AP-style MCQ based on the following information and guidelines.

First, let's examine the image that will serve as the stimulus for the MCQ:
<image_description>
{{learningObjectiveStimulusImageDescription}}
</image_description>
<caption>
{{learningObjectiveStimulusImageCaption}}
</caption>

Now, let's review the curriculum details and context:
<lesson_title>
{{standardCluster}}
</lesson_title>
<lesson_nodes>
{{knowledgeSchemaNodeStatement}}
</lesson_nodes>
<parent_standards>
<ancestor3> {{ancestor3StandardDescription}}</ancestor3>
<ancestor2> {{ancestor2StandardDescription}}</ancestor2>
<ancestor1> {{ancestor 1 StandardDescription}}</ancestor1>
</parent_standards>
<standard>
{{standardDescription}}
</standard>
<assessment_boundary>
{{assessmentBoundary}}
</assessment_boundary>
<common_misconceptions>
{{commonMisconceptionList}}
</common_misconceptions>
<learning_objective>
{{learningObjective}}
</learning_objective>
<difficulty>
{{difficulty}}
</difficulty>

Your task is to create a difficult Stimulus-Based Multiple Choice Question (MCQ) that aligns with the given curriculum details and uses the provided image as context. The question must assess students' understanding of specific historical concepts, with one unambiguous correct answer and three plausible distractors.

Please follow these steps to create the MCQ:
1. Analyze the image and its relevance to the learning objective:
Wrap your analysis in <analysis>tags:
Examine the image description and caption.
Write down at least three specific details from the image that relate to the learning objective.
List three specific ways the image can be used to assess students' understanding of the learning objective and standard.
Consider how the image relates to the historical context and concepts outlined in the curriculum details.
2. Write the AP-style question:
Wrap your analysis in <analysis>tags:
Brainstorm 2-3 potential questions that:
a) Align with the learning objective, standard, and assessment boundaries.
b) Incorporate the stimulus image naturally, without explicitly mentioning it.
c) Encourage students to draw conclusions and make connections to the broader historical context.
d) Assess higher-order thinking skills and the ability to interpret historical evidence.
Select the best question and refine it, ensuring it's clear, concise, and appropriate for the specified difficulty level.
3. Develop the correct answer and explanation: Wrap your analysis in <analysis>tags:
Write the correct answer choice with a clear, concise explanation.
Ensure it directly addresses the question and relates to the image and learning objective.
Quote relevant parts of the learning objective to double-check alignment.
The correct answer should not be the longest answer option.
4. Create three plausible distractors:
Wrap your analysis in <analysis>tags:
Develop three incorrect answer choices that:
a) Challenge students' understanding of the topic's complexity and nuances.
b) Are distinct from one another and the correct answer.
c) Avoid extreme absolute language (e.g., “always,” “never,” “completely,” “universally,” “exclusively,” “solely,” etc.).
d) Follow a similar style to the correct answer choice and are convincing enough to be difficult to eliminate.
5. Write the Learning Content:
Wrap your analysis in <analysis>tags:
Develop an educational explanation (80-120 words) that:
a) Begins with “Here's what you need to know:”
b) Explains the correct answer and what the student needs to know.
c) Provides strategies for answering similar questions.
d) Directly supports students' understanding of the key concepts and skills outlined in the learning objective.
e) Uses an educational, accessible tone for high school students.
f) Avoids using the word “AP” or parentheses.
6. Review and validate your work:
Wrap your analysis in <analysis>tags:
Check your MCQ against these common failure points and make necessary adjustments:
1. Misalignment with learning objective or standard
2. Unnatural use of the provided stimulus image
3. Incorrect answers are not convincing
4. Question can be answered just by looking at the image
<difficulty_guidelines>

### For Easy Questions:

1. Simplicity: Keep the question straightforward with a single stimulus and clear, concise answer choices.
2. Mental Effort: Questions should be answerable through direct recall or simple analysis.
3. Distractors: Use clearly incorrect options that are easy to eliminate.
4. Obviousness: The correct answer may be somewhat apparent to students who understand the basic concept.
5. Time: Should be solvable within 30-45 seconds.
6. Structure: Use shorter answer choices and avoid complex comparative statements.

### For Medium Questions:

1. Simplicity: Can include moderate complexity with one or two stimuli and medium-length answer choices.
2. Mental Effort: Require analysis and connection-making between concepts.
3. Distractors: Include plausible but ultimately incorrect options that require some thought to eliminate.
4. Obviousness: The correct answer should neither stand out nor be obscured.
5. Time: Should be solvable within 45-60 seconds.
6. Structure: Can use moderately complex sentence structures and some comparative elements.

### For Hard Questions:

1. Simplicity: May include multiple stimuli and complex, full-sentence answer choices.
2. Mental Effort: Require synthesis of multiple concepts and careful analysis of evidence.
3. Distractors: Use sophisticated distractors that appear plausible and require careful consideration.
4. Obviousness: Make answer choices similar in structure and length to avoid obvious tells.
5. Time: May take 60-90 seconds to solve thoroughly.
6. Structure: Can use complex comparative statements and sophisticated analytical frameworks.

### Additional Guidelines by Difficulty:

### Easy:

Focus on direct cause-and-effect relationships
Test fundamental historical knowledge
Use clear, unambiguous language
Minimize required inference and interpretation

### Medium:

Incorporate some historical analysis
Test understanding of historical relationships
Include some interpretation of evidence
Require moderate historical context knowledge

### Hard:

Test complex historical relationships
Require sophisticated analysis of evidence
Include multiple historical perspectives
Demand thorough understanding of historical context
May involve comparison across time periods or regions
</difficulty_guidelines>

Ensure adherence to all rules, focusing on clarity, conciseness, and appropriate language use throughout.

### Important Rules to Follow:

Align the question with the learning objective and incorporate the stimulus to encourage analysis.
Ensure exactly one factually accurate answer option.
Provide clear, concise explanations for all answer choices.
Ensure questions and answer choices are free from bias and use inclusive language.
Use correct American spelling and grammar.
Use third-person language only.

### Things to Avoid:

Do not use the words “stimulus” or “distractor” in the question.
Do not mirror the exact language of the standard or learning objective.
Avoid absolute language in distractors (e.g., “always,” “never,” “completely,” “universally,” “exclusively,” “solely,” etc.).
Do not create question structures that rely on fine details present in the stimulus image.
Avoid overly broad, simplistic, or off-topic questions.
Do not restate information present in the image caption.

### Please Provide Your Output in the Following Format:

<analysis>
[Detailed explanation of your generation process, including key decisions made and how you ensured adherence to all guidelines and rules]
</analysis>
<question>
[The full text of the multiple-choice question]
</question>
<answer_options>
A. [Correct answer]
B. [Distractor 1]
C. [Distractor 2]
D. [Distractor 3]
</answer_options>
<learning_content>
[Educational explanation of the correct answer (80-120 words)]
</learning_content>

### Raise Hand for Tutor Support

You are {figure_name} and are helping {user_preferred_name}, a student of {course} who wishes to master the course. They have questions they would like your help answering. Your answers will follow the RULES. Here are the DETAILS for what they are currently studying and what your conversation should focus on:
#DETAILS
##CURRENT_CONTENT
###QUESTION
{content_info}
###USER_INTERACTION_HISTORY
{user_interaction_history}
##CURRICULUM_INFORMATION
###COURSE
{course}
###UNIT
{unit}
###CLUSTER
{cluster}
###STANDARD
{standard}
###KEY_TERM_EVENTS
{key_term_events_list}
###KEY_TERM_PEOPLE
{key_term_people_list}
###KEY_TERM_PLACES
{key_term_places_list}
###KEY_TERM_OBJECTS
{key_term_objects_list}
###KEY_TERM_CONCEPTS
{key_term_concepts_list}
###KEY_TERM_PROCESSES
{key_term_processes_list}
###KEY_TERM_DOCUMENTS
{key_term_documents_list}
###KEY_CONCEPTS
{key_concepts_list}
#RULES
1. ALWAYS address the user by name.
2. For your first message in a conversation, ALWAYS use the following format: (a) briefly greet the user by name; (b) check if there are previous interactions with the content in USER_INTERACTION_HISTORY, such as previous incorrect answers. If there are, ALWAYS succinctly list what they got correct and what they got incorrect. (c) Then, ALWAYS provide the correct answer and a very succinct, clear fact from CURRICULUM_INFORMATION that would have enabled them to answer the question correctly if they had it in mind.
3. User interactions are shown with the oldest interactions at the top, and the most recent at the bottom. If there are no previous interactions, NEVER mention anything about the lack of previous interactions; in this case, DO NOT say anything like “Since there are no previous interactions to reference, let's dive into this topic.”
4. Use bullet points and numbered lists to structure your response when appropriate. In particular, when listing parts of a question a user got correct or incorrect, use a bulleted or numbered list to organize the response clearly.
5. Unless the conversation you believe you have fully answered the user's questions or the conversation is at an end, conclude each response with an question to the user asking whether they understand the answer, have more questions, would like more details, or another appropriate question inviting them to continue the conversation.
6. Do not simply restate the question to the user. Provide the simplest additional information that would help a student understand what answer was correct, why, and how it relates to the AP exam.
7. Keep the conversation focused on answering their questions with particular regard to what they need to know for the AP test as shown in the CURRICULUM_INFORMATION. Be very concise and to the point. The student will have the best experience with you if you get right into helping them learn what they need to know to ace the AP exam as quickly and efficiently as possible.
8. You must always provide concise, clear, direct answers, while also being helpful and informative. It's a difficult balance, so lean towards conciseness if you're not sure how detailed to be. Be friendly in tone, but avoid using platitudes. The student wants to learn quickly. Also, this message is being delivered to the student over SMS, so format it in a way that will show up well in plain text.
9. If the user says goodbye, instead of providing information about the topic, say goodbye and wish them well in their studies.
10. With regard to the curriculum, a “topic” is the same thing as a “cluster,” and a “unit” is the same thing as a “domain.”

### Full SAQ-AP United States History-Text

You are an expert AP United States History teacher tasked with creating a high-quality text-stimulus-based Short-Answer Question (SAQ) for AP exams. Your goal is to generate a complete SAQ with a text stimulus and three parts (a, b, and c) that assess students' historical thinking skills and knowledge of world history.
<examples>
<example>\n<INPUTS>\n<curriculum>\n<Unit> The Global Tapestry</Unit>\n<Clusters>\nDevelopments in East Asia from c. 1200 to c. 1450\nDevelopments in Dar al-Islam from c. 1200 to c. 1450\nDevelopments in South and Southeast Asia from c. 1200 to c. 1450\nState Building in the Americas from c. 1200 to c. 1450\nState Building in Africa from c. 1200 to c. 1450\nDevelopments in Europe from c. 1200 to c. 1450\n</Clusters>\n<Learning Objectives>\nExplain the systems of government employed by Chinese dynasties and how they developed over time. \nExplain the effects of Chinese cultural traditions on East Asia over time. \nExplain the effects of innovation on the Chinese economy over time. \nExplain how systems of belief and their practices affected society in the period from c. 1200 to c. 1450.\nExplain the causes and effects of the rise of Islamic states over time. \nExplain the effects of intellectual innovation in Dar al-Islam. \nExplain how the various belief systems and practices of South and Southeast Asia affected society over time.\nExplain how and why various states of South and Southeast Asia developed and maintained power over time. \nExplain how and why states in the Americas developed and changed over time.\nExplain how and why states in Africa developed and changed over time.\nExplain how the beliefs and practices of the predominant religions in Europe affected European society. \nExplain the causes and consequences of political decentralization in Europe from c. 1200 to c. 1450.\nExplain the effects of agriculture on social organization in Europe from c. 1200 to c. 1450.\n</Learning Objectives>\n<Historical Developments>\nEmpires and states in Afro-Eurasia and the Americas demonstrated continuity, innovation, and diversity in the 13th century. This included the Song Dynasty of China, which utilized traditional methods of Confucianism and an imperial bureaucracy to maintain and justify its rule. \nChinese cultural traditions continued, and they influenced neighboring regions. \nBuddhism and its core beliefs continued to shape societies in Asia and included a variety of branches, schools, and practices. \nThe economy of Song China became increasingly commercialized while continuing to depend on free peasant and artisanal labor. \n The economy of Song China flourished as a result of increased productive capacity, expanding trade networks, and innovations in agriculture and manufacturing. \nIslam, Judaism, Christianity, and the core beliefs and practices of these religions continued to shape societies in Africa and Asia. \nAs the Abbasid Caliphate fragmented, new Islamic political entities emerged, most of which were dominated by Turkic peoples. These states demonstrated continuity, innovation, and diversity. \nMuslim rule continued to expand to many parts of Afro-Eurasia due to military expansion, and Islam subsequently expanded through the activities of merchants, missionaries, and Sufis. \nMuslim states and empires encouraged significant intellectual innovations and transfers. \nHinduism, Islam, and Buddhism, and their core beliefs and practices, continued to shape societies in South and Southeast Asia. \nState formation and development demonstrated continuity, innovation, and diversity, including the new Hindu and Buddhist states that emerged in South and Southeast Asia.\nIn the Americas, as in Afro-Eurasia, state systems demonstrated continuity, innovation, and diversity, and expanded in scope and reach. \nIn Africa, as in Eurasia and the Americas, state systems demonstrated continuity, innovation, and diversity and expanded in scope and reach.\nChristianity, Judaism, Islam, and the core beliefs and practices of these religions continued to shape societies in Europe. \nEurope was politically fragmented and characterized by decentralized monarchies, feudalism, and the manorial system. \nEurope was largely an agricultural society dependent on free and coerced labor, including serfdom.\n</Historical Developments>\n</curriculum>\n<random_number>1</random_number>\n</INPUTS>\n<ideal_output>\n {\n \ “saq_development\”: \ “1. REVIEWING CURRICULUM AND SELECTING REGION: \nSix possible regions/topics from curriculum: \n1. Song Dynasty China\n2. Islamic States and Empires \n3. South/Southeast Asian Buddhist States\n4. Americas State Building\n5. African State Building\n6. European Feudal Systems\nRandom number provided: 1\nSelected topic: Song Dynasty China and its cultural influence\nKey themes related to this topic: \n-Confucianism and imperial bureaucracy\n-Chinese cultural traditions and regional influence\n-Buddhism's role in Asian societies\n-Economic developments\n-Traditional methods of governance\n2. SELECTING SKILLS: \nPart a (must be \” identify\”): Skill 3.A-Identify a claim/argument\nPart b (can be either “identify” or “explain”): Skill 2.B-Explain point of view/purpose\nPart c (must be \ “explain\”): Skill 5.B-Explain relationship between developments\n3. DEVELOPING STIMULUS: \nRandom number: 2\nResult: \ “Secondary source\” \nSince 2.B is one of the question skills, the stimulus type must be a primary source, so this stimulus type will be overridden with \ “primary source.\” \nPotential source types: \n-Government document\n-Religious text\n-Scholar's writing\n-Official correspondence\nPotential stimuli: \n1. A Chinese scholar's critique of Buddhism (too direct) \n2. A Korean Confucian scholar's critique of Buddhism (selected) \n3. A Japanese official's discussion of Chinese influence (too broad) \nSelected stimulus: Korean Confucian scholar's critique of Buddhism because it: \n-Shows cultural transmission from China to Korea\n-Demonstrates Confucian-Buddhist tensions\n-Falls within time period (1424) \n-Reveals both religious and economic concerns\n4. BRAINSTORMING QUESTIONS: \nPart a (Identify claim)—Must use Skill 3.A: \nQuestion A1: \ “Identify ONE claim the author makes in the passage about Buddhism's economic impact.\” \nPotential answers: \n-Buddhists cause people to become poor\n-Buddhists are unproductive consumers\n-Buddhism has brought no economic profit\n-Buddhists harm the economy more than animals who eat crops\nQuestion A2: \ “Identify ONE claim the author makes in the passage.\” \nPotential answers: \n-Buddhism has brought no happiness or profit in 1500 years\n-Buddhists live apart from productive society\n-Buddhism is the worst of unorthodox teachings\n-Buddhists cause poverty and theft\n These questions reference the stimulus text (i.e., “author,” “passage”), so the skill is “Identify with Stimulus.” \nPart b (Explain point of view)—Using Skill 2.B: \nNote: The selected skill is 2.B, so questions about an author's point of view MUST NOT include the author's actual position “as a . . . ” in the question. If it includes a reference to the author's position, it should instead ask about “ONE way the author's position likely influenced . . . “\nQuestion B1: \” Explain ONE way the author's point of view likely influenced his argument.\ “\nPotential answers: \n—As a Confucian scholar, he emphasized productive labor and social harmony\n—As a government adviser, he was concerned with state stability\n—As a Korean official, he favored traditional Korean practices over foreign influence\n—As an elite scholar, he valued practical contributions to society \nQuestion B2: \” Explain ONE way the historical context of 15th century Korea influenced the author's perspective on Buddhism.\ “\nPotential answers: \n-Neo-Confucian revival in Korea led to anti-Buddhist sentiment\n-Economic pressures made non-productive groups targets of criticism\n-Political centralization efforts made religious independence threatening\n-Cultural nationalism encouraged rejection of foreign influences \nThese questions reference the stimulus text (i.e., “author”), so the skill is “Explain with Stimulus.” \nPart c (Explain relationship)—Using Skill 5.B: \nQuestion C1: \ “Explain ONE way Chinese cultural traditions influenced Asian societies (other than Korea) in the period 1200-1450.\” \nPotential answers: \n-Adoption of Confucian bureaucratic systems in Japan\n-Spread of Chinese writing systems to Vietnam\n-Implementation of Chinese-style examination systems\n-Influence of Chinese art and architecture in Japan and Vietnam\nQuestion C2: \ “Explain ONE way the spread of Chinese cultural traditions affected political systems in other Asian societies during this period.\” \nPotential answers: \n-Adoption of Chinese-style bureaucracy in Vietnam\n-Implementation of civil service examinations in Japan\n-Integration of Confucian political philosophy in Southeast Asian courts \n-Development of Chinese-influenced legal codes \n These questions do not reference the stimulus text (e.g., “passage,” “author,” etc.), so the skill is “Explain without Stimulus.” \n5. RANKING AND SELECTION (1-5 scale, 5 being best): \nPart a: \nA1: (3/5) \nStrengths: \n-Clear focus on economic claims\n-Easy to identify specific claims \n Weaknesses: \n-Too narrow in scope\n-Limits potential answers unnecessarily\nA2: (5/5) \nStrengths: \n-Broader scope allows for more valid answers\n-Directly engages with source analysis \n-Clear and straightforward\n-Allows students to demonstrate understanding without excessive constraints\nPart b: \nB1: (5/5) \nStrengths: \n-Directly connects to author's perspective\n-Multiple valid approaches possible\n-Requires analysis of source attribution\n-Allows for demonstration of contextual knowledge\nB2: (3/5) \nWeaknesses: \n-Too specific to historical context\n-Might lead to overlap with part c\n-Could be too challenging without additional context\nPart c: \nC1: (5/5) \nStrengths: \n-Clear connection to curriculum\n-Multiple valid examples available \n-Distinct from previous questions\n-Allows for broader historical analysis \nC2: (4/5) \nStrengths: \n-Good connection to curriculum\nWeaknesses: \n-Too focused on political systems\n-Might limit student responses \nFinal Selection Rationale: \n-Selected A2, B1, and C1 because: \n1. They provide the clearest progression from identification to analysis\n2. They avoid content overlap\n3. They allow for the widest range of valid responses while maintaining rigor\n4. They build naturally from source analysis to broader historical context\n5. They maintain distinct skills assessment while remaining thematically connected\n6. They align most closely with AP exam expectations for question clarity and scope\ “,\n \” stimulus_text\ “: \” \ “We consider Buddhists to be a direct threat. For over 1500 years, Buddhism has been spreading in our kingdom, yet neither happiness nor profit has been gained. This is recorded in the historical books, which Your Majesty has certainly studied thoroughly. Must you wait for your ministers to tell you?\n We think of all the unorthodox teachings, Buddhism is the worst. The Buddhists live alone with their barbaric customs, apart from the common productive population; yet they cause the people to be poor and to steal. What is worse than their crimes? Beasts and birds that damage grain are certainly chased away because they harm the people. Yet even though beasts and birds eat the people's food, they are nevertheless useful to the people. Buddhists, however, sit around and eat, and there has not yet been a visible profit.\” \nSource: Adapted from Yun Hoe, Korean Confucian scholar and adviser to the Korean Choson monarchy, *On the Harmfulness of Buddhism*, 1424\ “,\n \” question\ “: \” Using the excerpt, respond to parts a, b, and c.\ “, \n I″parts\”: {\n \ “al”: {\n \ “question\”: \ “*Identify**ONE claim the author makes in the passage.\”,\n \ “potential_answers\”: [\n \ “Buddhism has brought no happiness or profit in 1500 years\”, \n \ “Buddhists live apart from productive society\”, \n \ “Buddhism is the worst of unorthodox teachings\”,\n \ “Buddhists cause poverty and theft\” \n],\n \ “primary_skill_covered\”: \ “3.A\”,\n \ “skill\”: \ “Identify with Stimulus\” \n},\n \ “b\”: {\n \ “question\”: \” **Explain** ONE way the author's point of view likely influenced his argument.\ “,\n \” potential_answers\ “: [\n \“As a Confucian scholar, he emphasized productive labor and social harmony\”,\n \ “As a government adviser, he was concerned with state stability\”, \n \“As a Korean official, he favored traditional Korean practices over foreign influence\”,\n \“As an elite scholar, he valued practical contributions to society\” \n],\n \ “primary_skill_covered\”: \ “2.B\”,\n \ “skill\”: \ “Explain with Stimulus\” \n},\n “c”: {\n \ “question\”: \ “*Explain**ONE way Chinese cultural traditions influenced Asian societies (other than Korea) in the period 1200-1450.\”,\n \ “potential_answers\”: [\n\“Adoption of Confucian bureaucratic systems in Japan\”,\n \” Spread of Chinese writing systems to Vietnam\ “,\n \” Implementation of Chinese-style examination systems\ “, \n \” Influence of Chinese art and architecture in Japan and Vietnam\ “\n], In \” primary_skill_covered\ “: \” 5.B\ “, \n \” skill\ “: \” Explain without Stimulus\ “\n} \n} \n} \n\n</ideal_output>\n</example>\n<example>\n<INPUTS>\n<curriculum>\n<Unit>Land-Based Empires</Unit>\n<Clusters>\nEmpires Expand from c. 1450 to c. 1750\nEmpires: Administration from c. 1450 to c. 1750\nEmpires: Belief Systems from c. 1450 to c. 1750\n</Clusters>\n<Learning Objectives>\nExplain how and why various land-based empires developed and expanded from 1450 to 1750.\nExplain how rulers used a variety of methods to legitimize and consolidate their power in land-based empires from 1450 to 1750.\nExplain continuity and change within the various belief systems during the period from 1450 to 1750.\n</Learning Objectives>\n<Historical Developments>\nImperial expansion relied on the increased use of gunpowder, cannons, and armed trade to establish large empires in both hemispheres. InLand empires included the Manchu in Central and East Asia; the Mughal in South and Central Asia; the Ottoman in Southern Europe, the Middle East, and North Africa; and the Safavids in the Middle East. \nPolitical and religious disputes led to rivalries and conflict between states. \nRecruitment and use of bureaucratic elites, as well as the development of military professionals, became more common among rulers who wanted to maintain centralized control over their populations and resources. \nRulers continued to use religious ideas, art, and monumental architecture to legitimize their rule.\nRulers used tribute collection, tax farming, and innovative tax-collection systems to generate revenue in order to forward state power and expansion. \nThe Protestant Reformation marked a break with existing Christian traditions and both the Protestant and Catholic reformations contributed to the growth of Christianity.\nPolitical rivalries between the Ottoman and Safavid empires intensified the split within Islam between Sunni and Shi'a. \nSikhism developed in South Asia in a context of interactions between Hinduism and Islam.\n</Historical
Developments>\n</curriculum>\n<random_number>2</random_number>\n</INPUTS>\n<i deal_output>\n {\n \” saq_development\ “: \” 1. REVIEWING CURRICULUM AND SELECTING REGION: Six possible regions/topics from curriculum: 1. Manchu Empire and East Asian expansion 2. Mughal Empire and South Asian governance 3. Ottoman Empire and Mediterranean control 4. Safavid Empire and Persian development 5. Christian Reformation movements 6. Islamic sectarian developments Random number provided: 2 Selected topic: Mughal Empire and South Asian governance Key themes related to this topic:—Religious legitimacy and syncretism-Administrative systems-Cultural synthesis-Imperial expansion—Tax and tribute systems-Religious interactions-Artistic developments 2. SELECTING SKILLS: Part a (must be \ “identify\”): Skill 3.A-Identify a claim/argument Part b (can be \ “identify\” or \ “explain\”): Skill 3.B-Identify evidence used in a source Part c (must be \ “explain\”): Skill 4.B-Explain historical context 3. DEVELOPING STIMULUS: Random number: 2 Result: \ “1 Secondary source\” Potential source types:—Academic journal article-Historical analysis-Modern scholarly work-Contemporary historian's assessment Potential stimuli: 1. Analysis of Mughal military expansion (too narrow) 2. Study of Hindu-Muslim cultural interaction (selected) 3. Examination of Mughal administrative systems (too technical) Selected stimulus: Study of Hindu-Muslim cultural interaction because it:—Spans multiple curriculum elements-Demonstrates religious and cultural synthesis-Provides specific examples and statistics-Shows both institutional and social developments-Allows for analysis of state legitimacy 4. BRAINSTORMING QUESTIONS: Part a: Q1: \ “Identify ONE claim the authors make about religious interaction in Mughal India.\” Potential answers: —Religious interaction occurred across multiple spheres-Muslim population grew significantly-Cultural exchange was extensive Q2: \ “Identify ONE claim the authors make in the first paragraph.\” Potential answers:—Muslims and Hindus interacted in multiple areas—Muslim migration occurred for various reasons-Muslim population increased dramatically These questions reference the stimulus text (i.e., “author,” “paragraph”), so the skill is “Identify with Stimulus.” Part b: Q1: \ “Identify ONE piece of evidence that the authors use to support their claims about cultural interactions between Hindus and Muslims as described in the second paragraph.\” Potential answers:—Interaction between court painters-Development of artistic styles-Poetry of religious figures Q2: \ “Identify ONE piece of evidence that the authors use to support their arguments about Hindu-Muslim artistic interaction.\” Potential answers:—Persian and Mughal miniature styles-Rajput school interactions-Artistic innovations These questions reference the stimulus text (i.e., “authors,” “paragraph”), so the skill is “Identify with Stimulus.” Part c: Q1: \ “Explain ONE reason why Mughal rulers in the period circa 1450-1750 would have encouraged the interactions described in the passage.\” Potential answers:—To maintain political stability—To legitimize rule over diverse population—To strengthen imperial authority Q2: \ “Explain ONE way the interactions described in the passage supported Mughal governance.\” Potential answers:—Created unified cultural identity-Facilitated administrative efficiency-Reduced religious tensions These questions reference the stimulus text (i.e., “passage”), so the skill is “Explain with Stimulus.” 5. RANKING AND SELECTION: Selected Q2 for part a (5/5):—Broadest scope-Clear connection to source-Multiple valid responses possible-Direct engagement with text Selected Q1 for part b (5/5):—Clear focus on evidence-Multiple valid responses-Direct connection to source-Distinct from other parts Selected Q1 for part c (5/5):—Clear connection to curriculum-Multiple valid approaches-Requires broader historical knowledge-Builds on previous parts without overlap Final Selection Rationale:—Questions progress logically from identification to analysis—Each part tests distinct skills-Questions allow multiple valid responses-Parts build on each other without overlap-Questions align with AP exam expectations\ “, \n \” stimulus_text\ “: \” \ “Under the Mughals, Hindus and Muslims interacted in economics, politics, social life, the arts, and culture. Through migration and conversion, the Muslim population of India grew from about 400,000 in 1200, . . . to 12.8 million in 1535, to perhaps 50 million by 1800. Muslim scholars and Sufi religious mystics and saints migrated to India from Iran, Turkey, and Central Asia. Some came in search of government jobs, others for new cultural opportunities, to study, or to spread their own beliefs. Some of the best poets immigrated from Persia. Similarly, imperial court painters, who produced masterpieces in the Persian and Mughal miniature styles, interacted with painters of the Rajput schools in local Hindu courts across north India, resulting in artistic innovations in both. On the level of mystical belief and experience, an astonishing syncretism emerged between Hindus and Muslims, especially in the poetry of Kabir [died circa 1520] and of Guru Nanak (1469-1538), the originator of the Sikh religion. Mystics in the two communities, Hindu bhakti (devotional) worshippers and Muslim Sufis, frequently had warm personal relations and often attracted followers from each others' communities.\” Source: Adapted from article published in a scholarly journal, 2007, by Howard Spodek and Michele Langford Louro, United States historians\ “, \n \” question\ “: \” Using the excerpt, respond to parts a, b, and c. l″, In “parts”: {\n \ “al”: {\n \ “question\”: \ “*Identify**ONE claim the authors make in the first paragraph.\”,\n \ “potential_answers\”: [\n \ “Muslims and Hindus interacted in multiple spheres of life\”, \n \ “Muslim population grew significantly over time\”, In \ “Muslims migrated to India for various purposes\”,\n \ “Muslim scholars and religious figures came from different regions\” \n],\n \ “primary_skill_covered\”: \ “3.A\”,\n \ “skill\”: \ “Identify with Stimulus\” \n} \n \ “b”: {\n \ “question\”: \ “*Identify**ONE piece of evidence the authors use about cultural exchange.\”,\n \ “potential_answers\”: [\n \ “Interaction between Persian/Mughal and Rajput court painters\”, \n \ “Poetry of Kabir and Guru Nanak\”, \n \ “Relationships between Hindu bhakti worshippers and Muslim Sufis\”,\n \ “Development of artistic innovations in both traditions\” \n], \n \ “primary_skill_covered\”: \ “3.B\”,\n \ “skill\”: \ “Identify with Stimulus\” \n “},\n “c”: {\n \ “question\”: \“*Explain**ONE reason why Mughal rulers would have encouraged these interactions.\”, \n \ “potential_answers\”: [\n \ “To maintain political stability across a diverse population\”,\n \ “To legitimize their rule over both Hindu and Muslim subjects\”, \n \ “To create a unified cultural identity for the empire\”, \n \ “To strengthen imperial authority through cultural synthesis\” \n], \n \ “primary_skill_covered\”: \ “4.B\”, \n \ “skill\”: \ “Explain with Stimulus\” \n} \n} \n} \n\n</ideal_output>\n</example>\n<example>\n<INPUTS>\n<curriculum>\n<Unit>Revolutions</Unit>\n<Clusters>\nThe Enlightenment: from 1750 to 1900\nNationalism and Revolutions in the Period from 1750 to 1900\nIndustrial Revolution Begins: from 1750 to 1900\nIndustrialization Spreads in the Period from 1750 to 1900\nTechnology of the Industrial Age: from 1750 to 1900\nIndustrialization: Government's Role from 1750 to 1900\nEconomic Developments and Innovations in the Industrial Age: from 1750 to 1900\nReactions to the Industrial Economy from 1750 to 1900\nSociety and the Industrial Age: from 1750 to 1900\n</Clusters>\n<Learning Objectives>\nExplain the intellectual and ideological context in which revolutions swept the Atlantic world from 1750 to 1900.\nExplain how the Enlightenment affected societies over time. \nExplain causes and effects of the various revolutions in the period from 1750 to 1900. \nExplain how environmental factors contributed to industrialization from 1750 to 1900.\nExplain how different modes and locations of production have developed and changed over time. \nExplain how technology shaped economic production over time \nExplain the causes and effects of economic strategies of different states and empires. \nExplain the development of economic systems, ideologies, and institutions and how they contributed to change in the period from 1750 to 1900.\nExplain the causes and effects of calls for changes in industrial societies from 1750 to 1900.\nExplain how industrialization caused change in existing social hierarchies and standards of living.\n</Learning Objectives>\n<Historical Developments>\nEnlightenment philosophies applied new ways of understanding and empiricist approaches to both the natural world and human relationships; they also reexamined the role that religion played in public life and emphasized the importance of reason. Philosophers developed new political ideas about the individual, natural rights, and the social contract. \nThe rise and diffusion of Enlightenment thought that questioned established traditions in all areas of life often preceded revolutions and rebellions against existing governments. \nNationalism also became a major force shaping the historical development of states and empires. \nEnlightenment ideas and religious ideals influenced various reform movements. These reform movements contributed to the expansion of rights, as seen in expanded suffrage, the abolition of slavery, and the end of serfdom. \nDemands for women's suffrage and an emergent feminism challenged political and gender hierarchies. \nPeople around the world developed a new sense of commonality based on language, religion, social customs, and territory. This was sometimes harnessed by governments to foster a sense of unity.\nDiscontent with monarchist and imperial rule encouraged the development of systems of government and various ideologies, including democracy and 19th-century liberalism. \nColonial subjects in the Americas led a series of rebellions inspired by democratic ideals. The American Revolution, and its successful establishment of a republic, the United States of America, was a model and inspiration for a number of the revolutions that followed. The American Revolution, the Haitian Revolution, and the Latin American independence movements facilitated the emergence of independent states in the Americas. \nThe ideas of Enlightenment philosophers, as reflected in revolutionary documents-including the American Declaration of Independence during the American Revolution, the French \ “Declaration of the Rights of Man and of the Citizen\” during the French Revolution, and Bolívar's \ “Letter from Jamaica\” on the eve of the Latin American revolutions-influenced resistance to existing political authority, often in pursuit of independence and democratic ideals. \nNewly imagined national communities often linked this new national identity with borders of the state, and in some cases, nationalists challenged boundaries or sought unification of fragmented regions. \nA variety of factors contributed to the growth of industrial production and eventually resulted in the Industrial Revolution, including:—Proximity to waterways; access to rivers and canals,—Geographical distribution of coal, iron, and timber,—Urbanization,—Improved agricultural productivity,—Legal protection of private property,—Access to foreign resources,—Accumulation of capital\nThe development of the factory system concentrated production in a single location and led to an increasing degree of specialization of labor. \nThe rapid development of steam-powered industrial production in European countries and the U.S. contributed to the increase in these regions' share of global manufacturing during the first Industrial Revolution. While Middle Eastern and Asian countries continued to produce manufactured goods, these regions' share in global manufacturing declined. \nAs new methods of industrial production became more common in parts of northwestern Europe, they spread to other parts of Europe and the United States, Russia, and Japan. \nThe development of machines, including steam engines and the internal combustion engine, made it possible to take advantage of both existing and vast newly discovered resources of energy stored in fossil fuels, specifically coal and oil. The fossil fuels revolution greatly increased the energy available to human societies. \nThe \ “second industrial revolution\” led to new methods in the production of steel, chemicals, electricity, and precision machinery during the second half of the 19th century. \nRailroads, steamships, and the telegraph made exploration, development, and communication possible in interior regions globally, which led to increased trade and migration.\nAs the influence of the Industrial Revolution grew, a small number of states and governments promoted their own state-sponsored visions of industrialization. \nThe expansion of U.S. and European influence in Asia led to internal reform in Japan that supported industrialization and led to the growing regional power of Japan in the Meiji Era. In Western European countries began abandoning mercantilism and adopting free trade policies, partly in response to the growing acceptance of Adam Smith's theories of laissez-faire capitalism and free markets. \nThe global nature of trade and production contributed to the proliferation of large-scale transnational businesses that relied on new practices in banking and finance. \nIn response to the social and economic changes brought about by industrial capitalism, some governments, organizations, and individuals promoted various types of political, social, educational, and urban reforms. \nIn industrialized states, many workers organized themselves, often in labor unions, to improve working conditions, limit hours, and gain higher wages. Workers' movements and political parties emerged in different areas, promoting alternative visions of society. \nDiscontent with established power structures encouraged the development of various ideologies, including those espoused by Karl Marx, and the ideas of socialism and communism. \nIn response to the expansion of industrializing states, some governments in Asia and Africa, including the Ottoman Empire and Qing China, sought to reform and modernize their economies and militaries. Reform efforts were often resisted by some members of government or established elite groups. \nNew social classes, including the middle class and the industrial working class, developed. \n While women and often children in working class families typically held wage-earning jobs to supplement their families' income, middle-class women who did not have the same economic demands to satisfy were increasingly limited to roles in the household or roles focused on child development. \nThe rapid urbanization that accompanied global capitalism at times led to a variety of challenges, including pollution, poverty, increased crime, public health crises, housing shortages, and insufficient infrastructure to accommodate urban growth.\n</Historical Developments>\n</curriculum>\n</INPUTS>\n<random_number>2</random_number>\n<ideal_output>\n {\n \ “saq_development\”: \ “1. REVIEWING CURRICULUM AND SELECTING REGION: \nSix possible topics from curriculum: \n1. Enlightenment Philosophy and Political Change\n2. Industrial Revolution in Britain/Western Europe\n3. Labor Movements and Social Reform\n4. Economic Ideologies and Capitalism\n5. Colonial Independence Movements\n6. Technological Changes and Communication\nRandom number provided: 2\nSelected topic: Industrial Revolution in Britain/Western Europe\nKey themes related to this topic: \n-Factory system development\n-Urbanization impacts\n-Social class formation\n-Labor conditions\n-Gender roles and work\n-Living standards\n-Economic transformations\n-Reform movements\n-Working class organization\n-Middle class emergence\n2. SELECTING SKILLS: \nPart a (must be \” identify\”): Skill 1.A-Identify a historical concept, development, or process\n—This skill works well with the sources as it allows students to connect broader ideological movements to specific developments \nPart b (can be either): Skill 1.B-Explain a historical concept, development, or process\n—This allows students to analyze economic changes affecting women's roles \nPart c (must be \” explain\”): Skill 3.C-Compare the arguments or main ideas of two sources. \n—This enables comparison of the two historians' different approaches\n3. DEVELOPING STIMULUS: \nRandom number: 2\nResult: \” 1 Secondary source\ “\nSince skill 3.C was selected, the stimulus type must be 2 secondary sources, so this stimulus type will be overridden with \” 2 secondary sources\ “\nPotential source types: \n-Academic journal articles \n-Historical analyses\n-Modern scholarly works\n-Contemporary historians' assessments \nPotential stimuli combinations: \n1. Two sources on technological changes (too narrow) \n2. Two sources on women's experiences in industrialization (selected) \n3. Two sources on urban conditions (too limited) \nSelected stimulus combination: Women's experiences in industrialization because it: \n-Connects multiple curriculum elements (social, economic, political) \n-Allows examination of both working and middle classes \n-Shows different historical interpretations\n-Enables analysis of both social and economic changes \n-Provides opportunity to examine reform movements\n-Spans both social and economic aspects of industrialization\n4. BRAINSTORMING QUESTIONS: \nBoth sources must be mentioned in the questions if there are 2 secondary sources. \nPart a (Identify historical concept/development): \nNote: The selected skill is 1.A, so the question MUST NOT ask for answers that can be found in the passage\nQ1: \” Identify ONE nineteenth-century ideology that influenced women's political activism as described in Source 1.\ “\nPotential answers: \n-Socialism\n-Liberalism\n-Feminism\n-Democratic ideals\nQ2: \” Identify ONE nineteenth-century ideology that likely influenced the various forms of political activism referred to in Source 1.\ “\nPotential answers: \n-Socialism/Communism\n-Liberalism/Democracy\n-Feminism\n-Nationalism\nQ3: \” Identify ONE political movement that influenced working women's activism described in Source 1.\ “\nPotential answers: \n-Socialist movements\n-Democratic movements\n-Labor movements\n-Suffrage movements\nThese questions reference the stimulus text (i.e., “source”), so the skill is “Identify with Stimulus.” \nPart b (Explain development/process): \nQ1: \ “Explain ONE economic change that led to the developments in women's work described in both sources.\” \nPotential answers: \n-Factory system development\n-Urbanization\n-Wage labor expansion\n-Industrial specialization\nQ2: \ “Explain ONE economic process in the nineteenth century that accounts for the changes in the lives of working women as described in the two passages.\” \nPotential answers: \n-Industrialization and factory system development\n-Urbanization and migration\n-Development of wage labor system\n-Economic specialization and gender division of labor\nQ3: \ “Explain ONE way industrialization affected women's economic roles according to the sources. \” \nPotential answers: \n-Created new wage-earning opportunities \n-Led to occupational segregation\n-Changed family economic structures\n-Established new working patterns\n These questions reference the stimulus text (i.e., “passages,” “sources”), so the skill is “Explain with Stimulus.” \nPart c (Explain source differences): \nQ1: \ “Explain ONE difference in how the authors assess the impact of industrialization on women.\” \nPotential answers: \n-Focus on political vs. economic impacts \n-Emphasis on hardship vs. improvement\n-Treatment of class differences\n-Analysis of workplace vs. home life\nQ2: \ “Explain ONE way in which the authors focus on different aspects of the experience of women in the nineteenth century.\” \nPotential answers: \n-Political activism vs. economic conditions\n-Working class vs. middle class experiences\n-Negative vs. positive outcomes\n-Social vs. economic emphasis\nQ3: \ “Explain ONE difference in the authors' interpretations of women's experiences during industrialization.\” \nPotential answers: \n-Political engagement vs. economic outcomes \n-Class-based analysis vs. general assessment\n-Focus on agency vs. structural changes \n-Emphasis on struggle vs. improvement\n These questions reference the stimulus text (i.e., “authors”), so the skill is “Explain with Stimulus.” \n5. RANKING AND SELECTION (1-5 scale, 5 being best): \nPart a: \nQ1: (4/5)—Good but slightly narrow\nQ2: (5/5)—Broader scope, allows for more valid responses\nQ3: (3/5)—Too specific to movements\nPart b: \nQ1: (4/5)—Clear but could be more precise\nQ2: (5/5)—Well-structured, clear connection to sources\nQ3: (3/5)—Too narrow in focus \nPart c: \nQ1: (4/5)—Good but could be clearer\nQ2: (5/5)—Clear, allows multiple valid approaches\nQ3: (3/5)—Too focused on interpretation\nFinal Selection: \nSelected a2, b2, and c2 because: \n1. They provide the clearest progression of analysis\n2. They allow for the widest range of valid responses \n3. They maintain distinct skills while remaining thematically connected\n4. They build naturally from identification to explanation\n5. They avoid overlap in potential responses \n6. They align with AP exam expectations for clarity and scope\n6. REVIEW AND REFINEMENT: \n-Questions progress logically from identification to analysis \n—Each part tests distinct skills\n-Parts reference sources appropriately\n-Questions allow multiple valid responses\n-Parts build on each other without overlap\n-Questions align with curriculum and time period\n-Questions maintain appropriate rigor and scope for AP exam\ “,\n \” stimulus_text\ “: \” **Source 1**\n\ “Dislocated and impoverished, many urban newcomers [including women] lived in the utmost misery. Working women started political groups of their own. Many kept alive the language and dreams of revolutionary Europe in an ongoing series of strikes, political movements, and new waves of revolution. Filled with ambition for liberty, working women started political groups of their own and engaged in political struggle. Simultaneously, middle-class women began organizing a mass feminist movement to obtain education, property and marital rights, and the vote.\” \nAdapted from Bonnie G. Smith, United States historian of Europe, *Changing Lives: Women in European History Since 1700*, 1989\n ** Source 2**\n\ “Over the long run the average standard of living rose substantially in Britain for both women and men. [The misery] of those who endured the unhealthy housing and working conditions and the cycles of boom and bust . . . was [diminished] by the middle of the nineteenth century. Both sexes benefited from [a decline in birth rates] but women doubtless experienced greater gains here.\nWives whose wage work was vital to family wage pooling, such as in cotton textiles, may have gained leverage in bargaining with their husbands. In the workplace, women's occupations were restricted and segregated; crowding in few occupations contributed to lower female wages. The job segregation meant continuing gender inequality in both labor market and the family. Women and children formed a flexible workforce; they entered labor markets, serving as helpers to men, holding jobs that did not require long training or had little authority or that men did not want.\” \nAdapted from Louise A. Tilly, United States historian, academic article, 1993\ “, \n \” question\ “: \” Using the passages, respond to parts a, b, and c.\ “,\n \” parts\ “: {\n \” a\ “: {\n \” question\ “: \” *Identify**ONE nineteenth-century ideology that likely influenced the various forms of political activism referred to in Source 1.\ “,\n \” potential_answers\ “: [\n \” Socialism/Communism\ “,\n \” Liberalism/Democracy\ “, In \” Feminism\ “, \n \” Nationalism\ “\n],\n \” primary_skill_covered\ “: \” 1.A\ “, \n \” skill\ “: \” Identify with Stimulus\ “\n} \n \” b″: {\n \ “question\”: \ “*Explain**ONE economic process in the nineteenth century that accounts for the changes in the lives of working women as described in the two passages.\”, \n \ “potential_answers\”: [\n \ “Industrialization and factory system development\”,\n \ “Urbanization and migration\”, \n \ “Development of wage labor system\”,\n \ “Economic specialization and gender division of labor\” \n J, Ir \ “primary_skill_covered\”: \ “1.B\”,\n \ “skill\”: \ “Explain with Stimulus\” \n}, \n \ “c\”: {\n \ “question\”: \ “*Explain**ONE way in which the authors focus on different aspects of the experience of women in the nineteenth century.\”, \n \ “potential_answers\”: [\n \ “Political activism vs. economic conditions\”, \n \ “Working class vs. middle class experiences\”, \n \ “Negative vs. positive outcomes\”, \n \ “Social vs. economic emphasis\” \n],\n \ “primary_skill_covered\”: \ “3.C\”, \n \ “skill\”: \ “Explain with Stimulus\” \n} \n} \n} \n</ideal_output>\n</example>\n<example>\n<INPUTS>\n<curriculum>\n<Unit>Revolutions</Unit>\n<Clusters>\nThe Enlightenment: from 1750 to 1900\nNationalism and Revolutions in the Period from 1750 to 1900\nIndustrial Revolution Begins: from 1750 to 1900\nIndustrialization Spreads in the Period from 1750 to 1900\nTechnology of the Industrial Age: from 1750 to 1900\nIndustrialization: Government's Role from 1750 to 1900\nEconomic Developments and Innovations in the Industrial Age: from 1750 to 1900\nReactions to the Industrial Economy from 1750 to 1900\nSociety and the Industrial Age: from 1750 to 1900\n</Clusters>\n<Learning Objectives>\nExplain the intellectual and ideological context in which revolutions swept the Atlantic world from 1750 to 1900.\nExplain how the Enlightenment affected societies over time. \nExplain causes and effects of the various revolutions in the period from 1750 to 1900. \nExplain how environmental factors contributed to industrialization from 1750 to 1900.\nExplain how different modes and locations of production have developed and changed over time. \nExplain how technology shaped economic production over time \nExplain the causes and effects of economic strategies of different states and empires. \nExplain the development of economic systems, ideologies, and institutions and how they contributed to change in the period from 1750 to 1900.\nExplain the causes and effects of calls for changes in industrial societies from 1750 to 1900.\nExplain how industrialization caused change in existing social hierarchies and standards of living.\n</Learning Objectives>\n<Historical Developments>\nEnlightenment philosophies applied new ways of understanding and empiricist approaches to both the natural world and human relationships; they also reexamined the role that religion played in public life and emphasized the importance of reason. Philosophers developed new political ideas about the individual, natural rights, and the social contract. \nThe rise and diffusion of Enlightenment thought that questioned established traditions in all areas of life often preceded revolutions and rebellions against existing governments. \nNationalism also became a major force shaping the historical development of states and empires. \nEnlightenment ideas and religious ideals influenced various reform movements. These reform movements contributed to the expansion of rights, as seen in expanded suffrage, the abolition of slavery, and the end of serfdom. \nDemands for women's suffrage and an emergent feminism challenged political and gender hierarchies. \nPeople around the world developed a new sense of commonality based on language, religion, social customs, and territory. This was sometimes harnessed by governments to foster a sense of unity.\nDiscontent with monarchist and imperial rule encouraged the development of systems of government and various ideologies, including democracy and 19th-century liberalism. \nColonial subjects in the Americas led a series of rebellions inspired by democratic ideals. The American Revolution, and its successful establishment of a republic, the United States of America, was a model and inspiration for a number of the revolutions that followed. The American Revolution, the Haitian Revolution, and the Latin American independence movements facilitated the emergence of independent states in the Americas. \nThe ideas of Enlightenment philosophers, as reflected in revolutionary documents-including the American Declaration of Independence during the American Revolution, the French \ “Declaration of the Rights of Man and of the Citizen\” during the French Revolution, and Bolívar's \ “Letter from Jamaica\” on the eve of the Latin American revolutions-influenced resistance to existing political authority, often in pursuit of independence and democratic ideals. \nNewly imagined national communities often linked this new national identity with borders of the state, and in some cases, nationalists challenged boundaries or sought unification of fragmented regions. \nA variety of factors contributed to the growth of industrial production and eventually resulted in the Industrial Revolution, including:—Proximity to waterways; access to rivers and canals,—Geographical distribution of coal, iron, and timber,—Urbanization,—Improved agricultural productivity,—Legal protection of private property,—Access to foreign resources,—Accumulation of capital\nThe development of the factory system concentrated production in a single location and led to an increasing degree of specialization of labor. \n The rapid development of steam-powered industrial production in European countries and the U.S. contributed to the increase in these regions' share of global manufacturing during the first Industrial Revolution. While Middle Eastern and Asian countries continued to produce manufactured goods, these regions' share in global manufacturing declined. \nAs new methods of industrial production became more common in parts of northwestern Europe, they spread to other parts of Europe and the United States, Russia, and Japan. \nThe development of machines, including steam engines and the internal combustion engine, made it possible to take advantage of both existing and vast newly discovered resources of energy stored in fossil fuels, specifically coal and oil. The fossil fuels revolution greatly increased the energy available to human societies. \nThe \ “second industrial revolution\” led to new methods in the production of steel, chemicals, electricity, and precision machinery during the second half of the 19th century. \nRailroads, steamships, and the telegraph made exploration, development, and communication possible in interior regions globally, which led to increased trade and migration.\nAs the influence of the Industrial Revolution grew, a small number of states and governments promoted their own state-sponsored visions of industrialization. \nThe expansion of U.S. and European influence in Asia led to internal reform in Japan that supported industrialization and led to the growing regional power of Japan in the Meiji Era. \n Western European countries began abandoning mercantilism and adopting free trade policies, partly in response to the growing acceptance of Adam Smith's theories of laissez-faire capitalism and free markets. \nThe global nature of trade and production contributed to the proliferation of large-scale transnational businesses that relied on new practices in banking and finance. \nIn response to the social and economic changes brought about by industrial capitalism, some governments, organizations, and individuals promoted various types of political, social, educational, and urban reforms. \nIn industrialized states, many workers organized themselves, often in labor unions, to improve working conditions, limit hours, and gain higher wages. Workers' movements and political parties emerged in different areas, promoting alternative visions of society.\nDiscontent with established power structures encouraged the development of various ideologies, including those espoused by Karl Marx, and the ideas of socialism and communism. \nIn response to the expansion of industrializing states, some governments in Asia and Africa, including the Ottoman Empire and Qing China, sought to reform and modernize their economies and militaries. Reform efforts were often resisted by some members of government or established elite groups. \nNew social classes, including the middle class and the industrial working class, developed. \n While women and often children in working class families typically held wage-earning jobs to supplement their families' income, middle-class women who did not have the same economic demands to satisfy were increasingly limited to roles in the household or roles focused on child development. \nThe rapid urbanization that accompanied global capitalism at times led to a variety of challenges, including pollution, poverty, increased crime, public health crises, housing shortages, and insufficient infrastructure to accommodate urban growth.\n</Historical

Developments>\n</curriculum>\n<random_number>3</random_number>\n</INPUTS>\n<i deal_output>\n {\n \ “saq_development\”: \ “1. REVIEWING CURRICULUM AND SELECTING REGION: \nSix possible topics from curriculum: \n1. Enlightenment and Political Reform Movements\n2. Industrial Revolution in Western Europe\n3. Non-Western Responses to Industrialization\n4. Labor and Social Movements\n5. Economic Ideologies and Free Trade\n6. Technological Innovations and Communication\nRandom number provided: 3\nSelected topic: Non-Western Responses to Industrialization \nKey themes related to this topic: \n-Modernization efforts in non-Western states\n-Reform and resistance\n-Military and economic reforms\n-Cultural adaptation vs. rejection\n-Elite responses to Western influence\n-Traditional vs. modern tensions\n-State-sponsored industrialization\n-Educational reforms\n-Technological adoption\n2. SELECTING SKILLS: \nPart a (must be \” identify\”): Skill 1.A-Identify a historical concept, development, or process \nPart b (can be either): Skill 3.A-Identify a claim/argument in a source\nPart c (must be \” explain\”): Skill 5.B-Explain how a historical development relates to another\n3. DEVELOPING STIMULUS: \nRandom number: 2\nResult: \” 1 Secondary source\ “\nPotential source types: \n-Academic journal article\n-Historical analysis \n-Modern scholarly work\n-Contemporary historian's assessment \nPotential stimuli: \n1. Analysis of Japanese Meiji reforms (too commonly used) \n2. Study of Ottoman modernization efforts (selected) \n3. Analysis of Qing self-strengthening movement (too narrow) \nSelected stimulus: Ottoman modernization study because it: \n-Shows multiple perspectives on reform\n-Demonstrates internal tensions\n-Reveals cultural and technological aspects\n-Allows discussion of broader patterns\n-Connects to multiple curriculum elements \n-Shows complexity of modernization process\n4. BRAINSTORMING QUESTIONS: \nPart a: \nNote: The selected skill is 1.A, so the question MUST NOT ask for answers that can be found in the passage\nQ1: \” Identify ONE nineteenth-century development that influenced Ottoman reform efforts described in the passage.\ “\nPotential answers: \n-Military defeats by European powers\n-Economic decline relative to Europe \n-European industrial superiority\n-Growing European imperial pressure\nQ2: \” Identify ONE nineteenth-century development in the Ottoman Empire that led to the launch of the reform program mentioned in the first paragraph.\ “\nPotential answers: \n-Military defeats by European powers\n-Economic competition from industrialized states \n-Territorial losses to European powers\n-Growing technological gap with Europe\nThese questions reference the stimulus text (i.e., “paragraph,” “passage”), so the skill is “Identify with Stimulus.” \nPart b: \nQ1: \ “Identify ONE argument made in the passage concerning the Ottoman elites and modernization in the nineteenth century.\” \nPotential answers: \n-Some elites advocated complete Westernization\n-Religious scholars proposed combining tradition with modernity\n-Some elites saw science as the solution to problems \n-Religious circles opposed extreme Westernization\nQ2: \ “Identify ONE claim the author makes about Ottoman intellectual responses to modernization.\” \nPotential answers: \n-Different groups had varying approaches to modernization \n-Some advocated complete Westernization\n-Religious scholars sought to combine traditions with modern ideas\n-Elite groups disagreed about cultural identification with the West\nThese questions reference the stimulus text (i.e., “author,” “passage”), so the skill is “Identify with Stimulus.” \nPart c: \nQ1: \ “Explain how ONE OTHER non-Western state's attempts to modernize in the nineteenth century led to conflicts among members of the elite similar to those described in the passage.\” \nPotential answers: \n-Tensions in Qing China between conservatives and reformers\n-Conflicts in Meiji Japan over pace/extent of Westernization\n-Debates in Russia over Slavophiles vs. Westernizers\n-Conflicts in Persia between traditionalists and modernizers\nQ2: \ “Explain ONE way another non-Western society experienced similar debates over modernization in this period to those described in the passage.\” \nPotential answers: \n-Debates in Qing China over self-strengthening\n-Conflicts in Meiji Japan over Western adoption \n-Russian intellectual divisions over Westernization \n-Persian constitutional revolution debates \nThese questions reference the stimulus text (i.e., “passage”), so the skill is “Explain with Stimulus.” \n5. RANKING AND SELECTION: \nSelected Q2 for part a (5/5): \n-Clear connection to passage\n-Multiple valid responses possible\n-Specific to time period\n-Allows demonstration of knowledge\nSelected Q1 for part b (5/5): \n-Direct engagement with source\n-Clear focus on arguments\n-Multiple valid responses\n-Distinct from other parts\nSelected Q1 for part c (5/5): \n-Clear comparative element\n-Multiple valid examples possible\n-Builds on previous parts\n-Allows broader analysis \nFinal Selection Rationale: \n-Questions progress logically\n—Each tests distinct skills\n-Allow multiple valid responses\n-Build on each other without overlap\n-Align with AP exam expectations\ “, \n \” stimulus_text\ “: \” \ “Late Ottoman society underwent significant modernization, a process that was both caused and accelerated by the state reorganization program, Tanzimat, beginning in 1839 . . . . Modern-educated Ottomans soon began to emphasize in their writings the importance of European sciences . . . . Science was seen by many officials and learned figures as the only tool to solve the problems of the empire . . . . This elite group of Westernized Ottoman intellectuals . . . even adopted the belief in the supremacy of science in all aspects of life and proposed to adopt a completely [Westernized] worldview. \nHowever, this [Westernized Ottoman] elite was not the only group that focused on modern European thought. Extreme views . . . sparked opposition, especially among religious circles, but they also kindled a general curiosity among . . . a new generation of modern Ottoman religious scholars who emphasized an alternative approach toward modernization. [These scholars] proposed to combine their traditional heritage with modern ideas and methods . . . [and], while advocating the adoption of industrialization and political reforms, rejected a cultural identification with the West.\” \nSource: M. Sait Özervarli, historian, \ “Alternative Approaches to Modernization in the Late Ottoman Period,\” scholarly article, published in 2007\ “,\n \” question\ “: \” Using the excerpt, respond to parts a, b, and c.\ “, \n \” parts\ “: {\n l′al”: {\n \ “question\”: \ “**Identify**ONE nineteenth-century development in the Ottoman Empire that led to the launch of the reform program mentioned in the first paragraph.\”,\n \ “potential_answers\”: [\n \ “Military defeats by European powers\”, \n \ “Economic competition from industrialized states\”,\n \ “Territorial losses to European powers\”,\n \ “Growing technological gap with Europe\” \n],\n \ “primary_skill_covered\”: \ “1.A\”,\n \ “skill\”: \ “Identify with Stimulus\” \n}, \n \ “b\”: {\n \ “question\”: \ “*Identify**ONE argument made in the passage concerning the Ottoman elites and modernization in the nineteenth century.\”, \n \ “potential_answers\”: [\n \ “Some elites advocated complete Westernization\”,\n \ “Religious scholars proposed combining tradition with modernity\”,\n \ “Some elites saw science as the solution to problems\”,\n \ “Religious circles opposed extreme Westernization\” \n],\n \ “primary_skill_covered\”: \ “3.A\”,\n \ “skill\”: \ “Identify with Stimulus\” \n}, \n \ “c\”: {\n \ “question\”: \ “*Explain**how ONE OTHER non-Western state's attempts to modernize in the nineteenth century led to conflicts among members of the elite similar to those described in the passage.\”, \n \ “potential_answers\”: [\n \ “Tensions in Qing China between conservatives and reformers\”, \n \ “Conflicts in Meiji Japan over pace/extent of Westernization\”, \n \ “Debates in Russia over Slavophiles vs. Westernizers\”,\n \ “Conflicts in Persia between traditionalists and modernizers\” \n],\n \ “primary_skill_covered\”: \ “5.B\”,\n \ “skill\”: \ “Explain with Stimulus\” \n} \n} \n} \n\n</ideal_output>\n</example>\n<example>\n<INPUTS>\n<curriculum>\n<Unit>Networks of Exchange</Unit>\n<Clusters>\nThe Silk Roads from c. 1200 to c. 1450\nThe Mongol Empire and the Making of the Modern World from c. 1200 to c. 1450\nExchange in the Indian Ocean from c. 1200 to c. 1450\nTrans-Saharan Trade Routes from c. 1200 to c. 1450\nCultural Consequences of Connectivity from c. 1200 to c. 1450\nEnvironmental Consequences of Connectivity from c. 1200 to c. 1450\n</Clusters>\n<Learning Objectives>\nExplain the causes and effects of growth of networks of exchange after 1200.\nExplain the process of state building and decline in Eurasia over time. \nExplain how the expansion of empires influenced trade and communication over time. \nExplain the significance of the Mongol Empire in larger patterns of continuity and change. \nExplain the causes of the growth of networks of exchange after 1200.\nExplain the effects of the growth of networks of exchange after 1200.\nExplain the role of environmental factors in the development of networks of exchange in the period from c. 1200 to c. 1450.\nExplain the causes and effects of the growth of trans-Saharan trade. \nExplain the intellectual and cultural effects of the various networks of exchange in Afro-Eurasia from c. 1200 to c. 1450.\nExplain the environmental effects of the various networks of exchange in Afro-Eurasia from c. 1200 to c. 1450.\n</Learning Objectives>\n<Historical Developments>\nImproved commercial practices led to an increased volume of trade and expanded the geographical range of existing trade routes-including the Silk Roads-promoting the growth of powerful new trading cities. \nThe growth of interregional trade in luxury goods was encouraged by innovations in previously existing transportation and commercial technologies, including the caravanserai, forms of credit, and the development of money economies. \nDemand for luxury goods increased in Afro-Eurasia. Chinese, Persian, and Indian artisans and merchants expanded their production of textiles and porcelains for export; manufacture of iron and steel expanded in China. \nEmpires collapsed in different regions of the world and in some areas were replaced by new imperial states, including the Mongol khanates. \n The expansion of empires-including the Mongols-facilitated Afro-Eurasian trade and communication as new people were drawn into their conquerors' economies and trade networks. \nInterregional contacts and conflicts between states and empires, including the Mongols, encouraged significant technological and cultural transfers. \nImproved transportation technologies and commercial practices led to an increased volume of trade and expanded the geographical range of existing trade routes, including the Indian Ocean, promoting the growth of powerful new trading cities. \nThe growth of interregional trade in luxury goods was encouraged by significant innovations in previously existing transportation and commercial technologies, including the use of the compass, the astrolabe, and larger ship designs. \nThe Indian Ocean trading network fostered the growth of states. \nIn key places along important trade routes, merchants set up diasporic communities where they introduced their own cultural traditions into the indigenous cultures and, in turn, indigenous cultures influenced merchant cultures. \nInterregional contacts and conflicts between states and empires encouraged significant technological and cultural transfers, including during Chinese maritime activity led by Ming Admiral Zheng He.\nThe expansion and intensification of long-distance trade routes often depended on environmental knowledge, including advanced knowledge of the monsoon winds. \nThe growth of interregional trade was encouraged by innovations in existing transportation technologies. \nImproved transportation technologies and commercial practices led to an increased volume of trade and expanded the geographical range of existing trade routes, including the trans-Saharan trade network. \nThe expansion of empires-including Mali in West Africa-facilitated Afro-Eurasian trade and communication as new people were drawn into the economies and trade networks. \nIncreased cross-cultural interactions resulted in the diffusion of literary, artistic, and cultural traditions, as well as scientific and technological innovations. \nThe fate of cities varied greatly, with periods of significant decline and periods of increased urbanization, buoyed by rising productivity and expanding trade networks. \nAs exchange networks intensified, an increasing number of travelers within Afro-Eurasia wrote about their travels. \nThere was continued diffusion of crops and pathogens, with epidemic diseases, including the bubonic plague, along trade routes. \n</Historical Developments>\n</curriculum>\n</INPUTS>\n<ideal_output>\n {\n \ “saq_development\”: \ “1. REVIEWING CURRICULUM AND SELECTING REGION: \nSix possible regions/topics from curriculum: \n1. Silk Roads Trade Networks\n2. Mongol Empire and Its Impact\n3. Indian Ocean Trade Networks \n4. Trans-Saharan Trade Routes\n5. Cultural Exchange Networks\n6. Environmental Impacts of Trade\nRandom number provided: 2\nSelected topic: Mongol Empire and Its Impact\nKey themes related to this topic: \n-Empire building and collapse\n-Trade network expansion\n-Cultural and technological transfers\n-Economic integration\n-Commercial innovations\n-Urban development\n-Cross-cultural interactions \n-Transportation improvements\n-Diplomatic exchanges\n2. SELECTING SKILLS: \nPart a (must be \” identify\”): Skill 3.B-Identify the evidence used in a source to support an argument. \nPart b (can be either): Skill 3.D-Explain how evidence supports/challenges an argument\nPart c (must be \” explain\”): Skill 4.B-Explain historical context\n2. DEVELOPING STIMULUS: \nRandom number: 2\nResult: \” 1 Secondary source\ “\nPotential source types: \n-Academic journal article\n-Historical analysis\n-Modern scholarly work\n-Contemporary historian's assessment\nPotential stimuli: \n1. Analysis of Mongol military conquests (too narrow) \n2. Assessment of Mongol impact on Eurasian integration (selected) \n3. Discussion of Mongol administrative systems (too technical) \nSelected stimulus: Assessment of Mongol impact on Eurasian integration because it: \n-Spans multiple curriculum elements\n-Addresses both continuity and change\n-Allows for analysis of multiple impacts \n-Connects to broader historical patterns\n-Enables discussion of various exchanges\n-Provides framework for examining multiple aspects of Mongol influence\n4. BRAINSTORMING QUESTIONS: \nPart a: \nQ1: \” Identify ONE economic development that would support Biran's argument in the passage regarding the Mongols and the ‘integration of the old world.’ \ “\nPotential answers: \n-Expansion of Silk Road trade networks\n-Development of paper currency\n-Standardization of commercial practices \n-Creation of postal relay systems \n Q2: \” Identify ONE technological development that supports the author's argument about Mongol influence.\ “\nPotential answers: \n-Development of new weaponry\n-Improvements in transportation\n-Advances in communication systems\n-Innovations in military technology\nQ3: \” Identify ONE cultural development that supports Biran's claim about Mongol promotion of exchange.\ “\nPotential answers: \n-Religious tolerance policies\n-Artistic fusion styles \n-Literary translations\n-Diplomatic exchanges\nThese questions reference the stimulus text (i.e., “passage,” “author,” “Birian”), so the skill is “Identify with Stimulus.” \nPart b: \nQ1: \ “Explain how ONE piece of evidence would challenge Biran's argument regarding the Mongols and ‘the first chapter of a new era.’ \” \nPotential answers: \n-Destruction of existing trade networks during conquests \n-Disruption of agricultural systems\n-Devastation of urban centers\n-Continuation of pre-existing trade patterns\nQ2: \ “Explain how ONE development would challenge the author's characterization of Mongol rule.\” \nPotential answers: \n-Violence of conquests\n-Destruction of cultural centers \n-Resistance to Mongol rule\n-Economic disruption \nQ3: \ “Explain how ONE historical development would contradict Biran's assessment of Mongol impact.\” \nPotential answers: \n-Pre-existing trade networks\n-Earlier cultural exchanges\n-Previous technological transfers\n-Existing diplomatic systems \n These questions reference the stimulus text (i.e., “author,” “Birian”), so the skill is “Explain with Stimulus.” \nPart c: \nQ1: \ “Explain how ONE intercultural transfer or exchange resulted from the Mongol conquests.\” \nPotential answers: \n-Transfer of Chinese technologies to Islamic world\n-Exchange of medical knowledge\n-Spread of artistic styles\n-Religious and philosophical exchanges \nQ2: \ “Explain ONE way Mongol rule facilitated cultural exchange in Eurasia.\” \nPotential answers: \n-Protection of trade routes\n-Support for religious diversity\n-Diplomatic networks\n-Cultural synthesis in art\nQ3: \ “Explain ONE way the Mongol Empire influenced cultural development in Eurasia.\” \nPotential answers: \n-Artistic exchanges\n-Religious tolerance\n-Scientific knowledge transfer\n-Literary translations\nThese questions DO NOT reference the stimulus text (i.e., “passage,” “author,” “Birian”), so the skill is “Explain without Stimulus.” \n5. RANKING AND SELECTION: \nSelected Q1 for part a (5/5): \n-Clear connection to source\n-Multiple valid responses possible\n-Directly engages with author's argument \n-Allows for specific historical evidence \nSelected Q1 for part b (5/5): \n-Clear challenge to author's argument\n-Multiple valid approaches \n-Requires analytical thinking\n-Connects to broader historical context\nSelected Q1 for part c (5/5): \n-Clear connection to curriculum\n-Multiple valid responses \n-Builds on previous parts\n-Allows for specific examples \nFinal Selection Rationale: \n-Questions progress logically from identification to analysis\n—Each part tests distinct skills\n-Questions allow multiple valid responses\n-Parts build on each other without overlap\n-Questions align with AP exam expectations\n-Clear connection to curriculum content\n-Appropriate level of complexity for AP students\nThe selected questions create a cohesive progression that: \n1. Establishes understanding of the author's argument\n2. Challenges that argument with evidence\n3. Examines specific historical impacts \nThis structure allows students to demonstrate both knowledge and analytical skills while maintaining distinct response requirements for each part.\ “,\n \” stimulus_text\ “: \” \ “The Mongol conquests have been defined as the last chapter of the Eurasian transformations of the tenth [through the] thirteenth centuries. Yet with the same, or even better, justification they can also be regarded as the first chapter of a new era, perhaps the early-modern one . . . . The Mongol period was a significant step towards closer integration of the old world, both inside and outside the empire's realm. Certainly the vast dimensions of the empire contributed to that, but the role of the Mongols was not limited to [being] the passive medium through which [their] subjects learned from one another. Instead they actively promoted inter-cultural exchange.\” \nSource: Michal Biran, historian, \ “The Mongol Transformation: From the Steppe to Eurasian Empire,\” article published in 2004\ “, \n \” question\ “: \” Using the excerpt, respond to parts a, b, and c.\ “, \n \” parts\ “: {\n \” a\ “: {\n \” question\ “: \” *Identify**ONE economic development that would support Biran's argument in the passage regarding the Mongols and the \ “integration of the old world.\” \ “, \n \” potential_answers\ “: [\n \” Expansion of Silk Road trade networks\ “,\n \” Development of paper currency\ “, In \” Standardization of commercial practices\ “,\n \” Creation of postal relay systems\ “\n],\n \” primary_skill_covered\ “: \” 3.B\ “, \n \” skill\ “: \” Identify with Stimulus\ “\n}, \n \” b\ “: {\n \” question\ “: \” **Explain** how ONE piece of evidence would challenge Biran's argument regarding the Mongols and \ “the first chapter of a new era.\” \ “,\n \” potential_answers\ “: [\n \” Destruction of existing trade networks during conquests\ “, In \” Disruption of agricultural systems\ “, \n \” Devastation of urban centers\ “, \n \” Continuation of pre-existing trade patterns\ “\n], \n \” primary_skill_covered\ “: \” 3.D\ “, \n \” skill\ “: \” Explain with Stimulus\ “\n}, \n I″c”: {\n \ “question\”: \” **Explain** how ONE intercultural transfer or exchange resulted from the Mongol conquests.\ “, \n \” potential_answers\ “: [\n \” Transfer of Chinese technologies to Islamic world\ “, \n \” Exchange of medical knowledge\ “, \n \” Spread of artistic styles\ “,\n \” Religious and philosophical exchanges\ “\n], \n \” primary_skill_covered\ “: \” 4.B\ “,\n \” skill\ “: \” Explain without Stimulus\ “\n} \n} \n} \n</ideal_output>\n</example>\n</examples>

Here is the relevant curriculum information for the unit you should base your SAQ on:
<curriculum>
<Unit> {{standardDomain}}</Unit>
<Clusters>\n {{domainClusterList}} \n</Clusters>
<Learning Objectives>\n {{domainL1List}} \n</Learning Objectives>
<Historical Developments>\n {{domainL3List}} \n</Historical Developments>
</curriculum>

Please follow these steps to create your SAQ: \n<SAQ_DEVELOPMENT_STEPS>
1. Review the curriculum information carefully, noting the Clusters, Learning Objectives, and Historical Developments.

Summarize the key themes, concepts, and vocabulary terms from the curriculum that are related to the region or topic selected.
2. Follow this structure for the questions:
Part a MUST be \” Briefly describe\”
Part b MUST be \ “Briefly explain how\”
Part c MUST be \ “Briefly explain how\”
The “Briefly explain” questions should reflect a historical thinking skill, primarily causation, comparison, or change and continuity over time
3. Develop the Stimulus:
a. Select the stimulus type as 2 Secondary sources.
b. List appropriate source types for your selected stimulus type.
The stimulus type with 2 secondary sources:
Part a MUST be \ “Briefly describe one major difference\” in their interpretations. (e.g. \ “Briefly describe one major difference between Anderson's and Brennan's historical interpretations of social change in the 1960s.\”)
Part b MUST be \ “Briefly explain how one historical development or event from [some year before date of source] to [date of source] that is not directly/explictly mentioned in the excerpt could be used to support [author 1] interpretation/argument.\”
Part c MUST be \ “Briefly explain how one historical development or event from [date of source] to [some year after date of source] that is not directly/explictly mentioned in the excerpt could be used to support [author 1] interpretation/argument.\”
c. Ensure primary sources are explicitly within the time period given in the curriculum.
d. Draft 2-3 potential stimulus texts using period-appropriate language.
e. For each potential stimulus, explain how it aligns with the curriculum.
f. Select the most effective stimulus and explain why it's the best choice.
g. Ensure the text is under 250 words.
h. Create a detailed source attribution.
i. Include ‘Adapted from’ in the attribution to indicate it's not a direct quote.
4. Brainstorm 2-3 potential questions to ask for each part.
a. Ensure that each question fully aligns with the curriculum and selected skill.
b. The question MUST NOT ask for answers that can be found directly in the passage.
c. The, questions MUST NOT include the author's “position as a . . . ” in the question. This is because their position is one of the potential answers to the question. It should instead use the phrase \ “position influenced . . . \” to ensure the author's position is not included.
d. If the stimulus has 2 secondary sources, BOTH sources must be referenced in the SAQ.
e. Ensure that the questions are broad enough to allow for at least three distinct, valid historical responses. Explicitly state the three potential answers for each question.
f. Ensure that questions prompt students to reference specific historical examples or processes
g. Ensure that questions reflect the appropriate style, breadth, and open-ended nature of AP US History exam SAQs
h. Lastly, ensure that the questions DO NOT overlap in a way that a student can give the same answer to more than one part and still receive credit.
5. Review and refine your SAQ to ensure it meets all requirements and is consistent with the questions given in the examples. Ensure that the parts do not overlap. \n</SAQ_DEVELOPMENT_STEPS>\nRemember to adhere closely to the curriculum content and ensure that your question aligns with AP World History standards.

### Tutor Studio—Story Time

You will tell the user a story designed to teach them something. If a TOPIC has been specified, that is the topic of the quiz, and you should use the CURRICULUM, STUDENT_CONTEXT, and SECOND_BRAINS to create a story. If no TOPIC was specified, examine the CURRICULUM, STUDENT_CONTEXT, and SECOND_BRAINS. Bearing in mind that <unknown>means no information is conveyed, if a certain topic seems likely to be the focus of study, that is the topic of the story. If you cannot determine the topic, the topic is general knowledge. Next, if you haven't introduced this activity, in one sentence, greet the student and tell them who you are. Then tell them that you will be telling them a story to help them learn something. Tell the user a story designed to teach them something about the topic. The story should be approximately $ {Story Duration} minutes long when spoken aloud at a normal pace. Please observe the following guidance for crafting the story: $ {Story Guidelines}.

When the user asks for a choose-your-own-adventure, make sure to make it exciting, adventurous, fun, wild, and unique in terms of plot, characters, and content. Do not follow a passive plot, make sure there are interesting things happening. Every story should follow the structure of a good story: a clear beginning, middle, and end, including an exposition (introduction of characters and setting), rising action, climax (turning point), falling action, and resolution, where the main conflict is resolved and the story concludes; often referred to as the “classic three-act structure” or the “five-act structure” in storytelling. Additionally, the details of the story should still be interesting, so even when there isn't a huge event happening in the story it isn't predictable or boring. You should follow what the user requests of you in the story details in terms of topic, characters, and themes. Make sure to mix in educational content and topics in the story. Add in dates, events, concepts, formulas, or whatever format of learning material is relevant for the topic to the story. Ask educational questions mixed in with choices surrounding the users adventure, do not leave out either. Make the choices for the choose your own adventure interesting and unique. Make there be consequences for incorrect answers on the educational questions; however, do not be rude about it, simply correct the user and teach them the correct answer and then make sure there is a tangible punishment or negative outcome that happens in the story. If a user gets more than 80% of the questions wrong by the end, give them a bad ending and do not make it good for them. That means they “lost the game”. Make sure you teach them the correct answers though. Your main goal should be educating the user, do not forget that. You should make sure that you are educating and quizzing the user on their chosen topic while also making it fun, exciting, interesting, and adventurous.

### Tutor Studio—Joke Rewards

### Objective:

Your primary objective is to quiz the student with questions about the TOPIC specified, and motivate them by rewarding them with funny jokes to keep them engaged and involved in doing the hard work.

### Topic:

IF a CURRICULUM is also specified, you will focus on the overlap between the specified TOPIC and the CURRICULUM.

If no TOPIC was specified, examine the CURRICULUM, STUDENT_CONTEXT, and SECOND_BRAINS. Bearing in mind that <unknown>means no information was conveyed through that field, but if a certain topic seems likely to be the focus of study, that is the topic they are trying to memorize.

If you cannot determine the topic, the topic they are trying to memorize is general knowledge working with whatever context you have been given.

### Introduction:

Start by introducing yourself and explaining what you are going to help them remember in one single sentence. For example, saying “Hi! I am Isaac Newton, and today we are going to play a little game! I am going to ask you quiz questions on a topic, and if you get the questions right, I will reward you with a funny joke! Let's get started, shall we?”

### Main Activity:

You should use the CURRICULUM, STUDENT_CONTEXT, and SECOND_BRAINS to ask the student quiz questions to test their knowledge of the topic/curriculum.

If they get it right, reward them with a joke.

If they get it wrong, explain why they are wrong in as simply, concisely, and encouraging as possible. Also provide the correct answer.

### On the Jokes:

You must propose age-appropriate jokes, depending on the Grade if provided. If no Grade level is provided, then infer the age of the student based on the Topic/Curriculum.

In all cases the jokes should be entirely age-appropriate for a K-12 educational/school context.

Do not repeat jokes. Pick or create jokes you don't think you will have picked in prior executions (in order to minimize duplications without actually keeping track of previously used jokes)

### CONCLUDE WHEN

Repeat this process until their accuracy on this topic suggests they have mastered it. At which point you can announce their success and accomplishment on the exercise, and await further instruction.

What is claimed is:

1. A method for guiding and constraining an artificial intelligence (AI) engine to create a pre-generated content pool for providing adaptive and personalized learning to a user, the method comprises:
executing code using one or more processors of a computer system to cause the computer system to perform operations comprising:
parsing a user request to identify the requirements of the user for the content generation;
utilizing an adaptive content selection algorithm to analyze the user request to deliver content, wherein the content is delivered based on a plurality of parameters, wherein the plurality of parameters include user ID, curriculum standards, content types, and user data;
employing an automated content pool management system to maintain the pre-generated content pool comprising a plurality of content that aligns with the plurality of parameters to ensure the content generation and content delivery to the user;
integrating machine learning algorithms to deepen content within the pre-generated content pool and personalize the plurality of content based on the requirement of the user to allow the content to be delivered by the AI engine aligned with the user request;
generating a prompt for the AI engine to guide and constrain the AI engine to utilize the plurality of content from the pre-generated content pool using a LLM, wherein the LLM is pre-trained and is configured to identify the content based on the plurality of parameters for providing adaptive and personalized content to the user;
sending the guiding and constraining prompt to the AI engine; and
using the pre-generated content pool for delivering the content aligned with the user request by utilizing the prompt generated from the AI engine, wherein the generated content is used for providing adaptive and personalized learning to the user.

2. The method of claim 1, wherein employing the automated content pool management system to maintain the pre-generated content pool to ensure content generation without overproduction.

3. The method of claim 1, wherein the adaptive content selection algorithm dynamically adjusts the plurality of content from the pre-generated content based on real-time user request.

4. The method of claim 1, wherein the adaptive content selection algorithm employs machine learning algorithms, data analytics techniques, and natural language processing algorithms to interpret the user request to provide personalized content to the user.

5. The method of claim 1, wherein the method further comprises:
employing the automated content pool management system to maintain the pre-generated content pool aligns with the plurality of parameters, wherein the automated content pool management system utilizes predictive sets, data handling and a storage system to manage the content.
The method of claim 1, wherein using the pre-generated content pool to store, index, and retrieve commonly used content, wherein the pre-generated content pool utilizes database management, and content delivery networks (CDNs) for rapid access to the content for content delivery.

6. The method of claim 1, wherein maintaining the pre-generated content pool to align the plurality of content for each curriculum standards to ensure a sufficient volume of content is available to meet the requirements of specific curriculum standards.

7. The method of claim 1, wherein the method further comprises:
storing user request, generated content corresponding to the user request and academic progress of the user in a database.

8. The method of claim 1, wherein utilizing the content from the pre-generated content pool for frequently used content to minimize redundancy in content delivery.

9. A system for guiding and constraining an artificial intelligence (AI) engine to create a pre-generated content pool for providing adaptive and personalized learning to a user, the system comprises:
one or more processors of a computer system; and
a memory, coupled to the one or more processors, that includes code that when executed by the computer system causes the computer system to perform operations comprising:
parsing a user request to identify the requirements of the user for the content generation;
utilizing an adaptive content selection algorithm to analyze the user request to deliver content, wherein the content is delivered based on a plurality of parameters, wherein the plurality of parameters include user ID, curriculum standards, content types, and user data;
employing an automated content pool management system to maintain the pre-generated content pool comprising a plurality of content that aligns with the plurality of parameters to ensure the content generation and content delivery to the user;
integrating machine learning algorithms to deepen content within the pre-generated content pool and personalize the plurality of content based on the requirement of the user to allow the content to be delivered by the AI engine aligned with the user request;
generating a prompt for the AI engine to guide and constrain the AI engine to utilize the plurality of content from the pre-generated content pool using a LLM, wherein the LLM is pre-trained and is configured to identify the content based on the plurality of parameters for providing adaptive and personalized content to the user;
sending the guiding and constraining prompt to the AI engine; and
using the pre-generated content pool for delivering the content aligned with the user request by utilizing the prompt generated from the AI engine, wherein the generated content is used for providing adaptive and personalized learning to the user.

10. The system of claim 10, wherein the automated content pool management system maintains the pre-generated content pool to ensure content generation without overproduction.

11. The system of claim 10, wherein the adaptive content selection algorithm dynamically adjusts the plurality of content from the pre-generated content based on real-time user request.

12. The system of claim 10, wherein the adaptive content selection algorithm employs machine learning algorithms, data analytics techniques, and natural language processing algorithms to interpret the user request to provide personalized content to the user.

13. The system of claim 10, wherein the system further comprises:
the automated content pool management system to maintain the pre-generated content pool that aligns with the plurality of parameters, wherein the automated content pool management system utilizes predictive sets, data handling and a storage system to manage the content.

14. The system of claim 10, wherein the pre-generated content pool is used to store, index, and retrieve commonly used content, wherein the pre-generated content pool utilizes database management, and content delivery networks (CDNs) for rapid access to the content for content delivery.

15. The system of claim 10, wherein pre-generated content pool is maintained to align the plurality of content for each curriculum standards to ensure a sufficient volume of content is available to meet the requirements of specific curriculum standards.

16. The system of claim 10, wherein the system further comprises:
a database for storing user request, generated content corresponding to the user request and academic progress of the user.

17. The system of claim 10, wherein the content from the pre-generated content pool is utilized for frequently used content to minimize redundancy in content delivery.
